(19) United States
(12) Patent Application Publication
(10) Pub. No.: US 2009/0012918 A1
(43) Pub. Date: Jan. 8, 2009

(54) SYSTEM AND METHOD FOR CREATING A COST-EFFECTIVE AND EFFICIENT RETAIL ELECTRIC POWER EXCHANGE/ENERGY SERVICE PROVIDER LOAD OPTIMIZATION EXCHANGE AND NETWORK THEREFOR

(75) Inventors: Carl Robert Aron, Spokane, WA (US); John Andrew Smith, Raleigh, NC (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(73) Assignee: VINCERO, LLC, Raleigh, NC (US)

(21) Appl. No.: 12/147,210

(22) Filed: Jun. 26, 2008

Related U.S. Application Data
(62) Division of application No. 10/669,518, filed on Sep. 24, 2003.
Application No. 10/669,518 is a continuation of application No. 09/663,813, filed on Sep. 15, 2000, now abandoned.

(51) Int. Cl. G06F 17/00

(52) U.S. Cl. 705/412

(57) ABSTRACT

An electric power exchange network includes a series of computerized exchange nodes that provide communications between suppliers and purchasers or users of electric power. Search engines enable suppliers to obtain information, such as load characteristics, from users in the network to allow the supplier to effectively merge or combine its existing loads with those of certain users, whereby a more efficient trading of electric power among members of the exchange network can be achieved.

### RELATED APPLICATIONS

This application is a Divisional of U.S. application Ser. No. 10/669,518 filed Sep. 24, 2003, now pending, which a continuation application of U.S. application Ser. No. 09/663,813, filed Dec. 4, 2002, now abandoned, all of which are hereby incorporated by reference in their entirety.

### TECHNICAL FIELD OF THE INVENTION

The invention relates generally to systems and methods for buying and selling electric power. More specifically, this invention relates to systems and methods for the making of supply agreements between providers of electric power and consumers thereof, and, yet more particularly, to (a) a retail electric power exchange/energy service provider load optimization exchange through which arrangements are made to (i) provide electric power to consumers in a more cost-effective and efficient manner, (ii) aggregate customers' electric loads to improve electric usage efficiency, and (iii) optimize the supply obligations of energy service providers and (b) exchanges performing these functions which can also be linked in a network of such exchanges to facilitate (i) the making of electric power supply arrangements for consumers with multiple geographically dispersed consumption sites, (ii) the making of aggregation arrangements for such customers, and (iii) the optimization of the supply obligations of energy service providers covering wide geographic scope.

### BACKGROUND OF THE INVENTION

Until recently, essentially all consumers of electric power in the United States were compelled to purchase their electric power requirements from a single supplier or utility. Under this arrangement, the generation and distribution of electric power and energy were regulated by state public utilities commissions that established or approved the rates at which an electric utility could charge its customers, usually based on the customer's requirements for electric power. The interstate transmission of electric power is generally federally regulated. The utilities have thus operated as “natural monopolies,” which maintained the exclusive right to generate and deliver electric power to all consumers of electric power within the utilities' franchised territories.

In recent years, the natural monopoly status of electric utilities with respect to electric power generation has been challenged, and certain states, such as California, Massachusetts, New York, and Pennsylvania, have deregulated the supply of electric power to allow consumers in those states to choose from among competing suppliers of electric power (“energy service providers” or “ESPs”) to meet their requirements for electric power and to permit ESPs to compete with one another with respect to the supply of electric power. (The physical distribution function of the incumbent utilities has not generally been altered.)

The partial deregulation of the electric utility industry has provided some consumers of electric power a choice with regard to their sources of electric power supply. Those consumers can make their choices in this respect in a number of ways: in response to direct solicitations, through Internet-based sites, and, most relevant here, through the use of retail power exchanges.

Retail electric power exchanges are generally electronic marketplaces where consumers of electric power make their requirements known and where ESPs make known their willingness to satisfy those consumers' requirements. The partial deregulation of the electric utility industry has lead to the development and commercialization of a number of retail electric power exchanges (some of which also deal in natural gas). These first generation electric power exchanges appear rather primitive, particularly in terms of their analytical capabilities, and are generally Internet-based electronic commerce sites. Examples include Enermetrix (www.enermetrix.com), the Utility Xchange (www.utilityxchange.com). Energy Quote (www.energyquote.co.uk), AMDAX (www.amdax.com), and World Energy Exchange (www.worldenergyexchange.com).

Certain of these exchanges claim to examine and/or combine consumer loads with a view to matching buyers and sellers of electric power more efficiently. Other exchanges utilize a less automated request for proposal approach. However, none of these exchanges has thus far made any significant impact on the retail electric power market, and, as of this date, no significant retail electric power exchange has emerged, and no network of such exchanges has been developed.

The failure to date of existing retail electric power exchanges to capture a significant share of the total market for electric power supply appears to derive from the partial state of deregulation, certain transitional rules adapted in the deregulation process, and, most relevant here, the inability of those exchanges, due to technical limitations, to address comprehensively and effectively certain central problems attendant to the efficient making of arrangements for the supply of electric power under conditions of deregulation.

The four central problems arising in the retail supply of electric energy may be summarized as follows: (i) how to match the supply of electric energy available to an ESP at wholesale with the demand for energy that the ESP has contracted to satisfy at retail (the “ESP matching problem”); (ii) how to improve the attractiveness to ESPs of a customer load measured in terms of an appropriate indicator of efficiency in energy usage (the “customer load efficiency problem”); (iii) how to address in the retail trading process the requirements of customers that consume energy at more than one site (the “multiple site problem”); and (iv) how to maximize the information about trading activity available to exchange users (the “price information problem”).

### The ESP Matching Problem

ESPs typically have electric power available to them either through their own generation sources or through purchase at wholesale rates from unaffiliated generation sources. Wholesale electric power is commonly generated or traded in large blocks of substantially constant capacity for discrete periods of time. The loads of customers, however, do not typically involve a constant demand for electric power over time. Rather, customer demand for electric power typically varies, often substantially, at different times of the day or during different days of the week, as well as with economic conditions, weather, and seasonal changes. Thus, ESPs that seek to match their available capacity to their customers' demands must deal with the facts that the customer loads may have peak demand levels that differ substantially from average demand levels and that the electric power purchased by an ESP at wholesale to satisfy the consumer peak demand levels will not be fully utilized since those peak levels are temporary and are not maintained throughout the day or day to day.

For those reasons, an ESP is often compelled to purchase or otherwise acquire a supply of electric power that is greater than the total actual demand for power it has contracted to supply to its customers. To deal with this economically disadvantageous situation, the ESP may do one or more of the following: (i) seek to recover its costs for the unused capacity from its customers by increasing its rates; (ii) absorb those costs and thereby operate at a reduced profit margin in order to be competitive; (iii) seek to find customers who have loads that can be satisfied through the use of some otherwise unused capacity; or (iv) seek to shift the obligation to supply the peak demand levels, in whole or in part, to one or more other ESPs.

The first two of these alternatives are undesirable from an economic point of view both to ESPs and their customers and are also inefficient in that electric power is generated or purchased without a use therefor. The cost of this unused and thus wasted electric power is either absorbed by the ESP, which was unable to sell it, or imposed upon the consumers, which did not use it. The electric power that is required to satisfy the ESP load with its demand peaks in excess of average demand, if not modified, cannot be efficiently secured from wholesale sources which typically offer electric power in blocks of constant capacity. The ESP matching problem is created, in part, by the increase on the number of ESPs as a result of deregulation. Prior to deregulation, there was only one ESP, the incumbent electric utility. That utility dealt with the ESP matching problem once for all consumers of electric power in its territory. With multiple ESPs, the ESP Matching problem is greatly increased because each ESP must seek to address that problem for its own customers. Multiple ESPs serving multiple, different customers cannot achieve (on weighted average) better matching results than a single ESP (utility) serving all customers. In other words, deregulation creates an inefficiency of its own. This observation may be stated in more technical terms as follows: For any given group of customers loads, the load factor (ratio of average demand to peak demand) of a single ESP (utility) serving all those loads must be equal to or more likely greater than the average weighted load factors of multiple ESPs serving segments of these loads.)

### The Customer Load Efficiency Problem

Under circumstances in which customer loads vary significantly between average and peak demands for electric power, the customer has the following alternatives available to it: (i) accept higher prices for electric power caused by attempts by the ESP to charge it for the unused portion of the electric power obtained by the ESP to meet the customer's peak demand requirements; (ii) adopt energy efficiency measures to decrease its peak demands for electric power; (iii) seek to combine its own load with the loads of other customers to create a more uniform, attractive load shape and/or a large load; or (iv) find an ESP which would view the customer's load, or segments thereof including the peak demand segments, as attractive to it when considered in the context of the overall load shape of the ESP load.

Since alternative (i) is unattractive to the customer for obvious reasons, it is desirable to modify the customer load that is presented to the ESP by combination or division to make that load more attractive to the ESP, to adopt measures that result in a greater efficiency in energy usage, or to find an ESP for which the existing customer load shape is attractive.

### The Multiple Site Problem:

Many customers, particularly corporate organizations, consume electricity at a plurality of sites. Such customers may wish to satisfy all their energy requirements in one transaction or in a number of transactions fewer than the total number of consumption sites.

For ESPs and customers, the problem is how to make ESPs aware, in an efficient and effective manner, of a customer's multi-site consumption, the customer loads at each site, and the customer's conditions for receiving offers to satisfy its loads in one or several separate transactions.

### The Price Information Problem

There is also a need for ESPs and their customers to have access to pricing and other information relating to comparable transactions between ESPs and customers as well as between ESPs in order to enable them to make better-informed decisions relating to their sale and purchases of electric power. Active markets with many participants and with transparency of transactions provide the greatest assurance to buyers and sellers that they are trading at “market prices” and on “market terms and conditions.”

### OBJECTS OF THE INVENTION

It is accordingly a primary object of the invention to provide systems and methods for making arrangements for the supply of electric power and for concluding contracts based upon those arrangements in which greater efficiency is achieved.

It is yet a further object of the invention to provide systems and methods in which relevant information regarding retail customers' load characteristics is obtained by or brought to the attention of energy service providers to enable energy service providers to choose customers to which the energy service provider can sell electric power with the greatest efficiency in its energy usage and/or at the lowest possible prices.

It is a further object of the invention to provide systems and methods which increase the efficiency of utilization of electric power that an energy service provider generates or buys by more effectively matching the electric loads of customers with the energy service provider's capacity.

It is a further object of the invention to provide systems and methods which increase the efficiency of utilization of electric power that energy service providers generate or buy by enabling load-shifting between energy service providers.

It is yet a further object of this invention to provide systems and methods for the carrying out of instructions given by energy service providers and customers in connection with the trading of electric power at retail.

It is still another object of the invention to provide systems and methods which enable buyers and sellers of electric energy to obtain relevant retail trading activity and pricing information that will further enable them to make better-informed economic decisions.

It is yet a further object of the invention to provide systems and methods which enable customers and aggregators to combine and/or to divide their loads so as to enable them to present load alternatives to energy service providers that may permit the customers to achieve the lowest possible costs to satisfy their requirements for electric power.

It is yet a further object of this invention to provide systems and methods which enable energy service providers to shift segments of their loads between them so as to facilitate load optimization.

It is yet a further object of this invention to provide systems and methods which enable energy service providers to obtain information relating to load-shifting transactions that will further enable them to make better-informed economic decisions.

It is yet another object of the present invention to provide systems and methods which enable more effective trading of retail electric power for customers with multiple consumption sites.

It is yet another object of the present invention to provide systems and methods for linking retail electric power exchanges/energy service provider load optimization exchanges with one another and with other such exchanges in an exchange network in a manner that enables a more comprehensive marketplace to be created.

Is it yet a further object of the invention to provide tools, including search engines, trading energies, and database structures, that enable new methods of load analysis, new methods of transaction analysis, and new methods of executing transactions with respect to the retail supply of electric power and to load optimization by energy service providers.

### SUMMARY OF THE INVENTION

The invention provides means to: enable analysis of customers' electric usage and of energy service providers' electricity supply obligations; determine the impact effect in terms of efficiency in electricity usage of potential transactions involving the retail supply of electrical power, the aggregation of customer loads, or the shifting of electricity supply obligations between energy service providers upon the parties to these potential transactions; provide access to, search for, and analysis of historical transactions involving the retail supply of electric power or the shifting of electricity supply obligations between energy service providers; and arrange transactions involving the retail supply of electric power, the aggregation of customer loads, or the shifting of electricity supply obligations between energy service providers.

The invention provides for the incorporation of all of those capabilities in a retail electric power exchange/energy service provider, load optimization exchange and contempletes that a plurality of such exchanges could be connected in a network.

The work of the exchange is performed by search engines that provide analysis of potential and historical transactions and trading engines that support actual transaction activity. Communications links tie exchange users to exchanges, tie exchanges to associated database servers, and where a network is involved, tie exchanges to one another.

### DETAILED DESCRIPTION OF THE INVENTION

### I. Definitions

The following definitions of terms used in this disclosure are in addition to definitions of terms provided elsewhere in the text.

Account information—Either or both of customer account information and ESP account information.

Aggregate load—A load made up of the customer loads of individual customers (or segments thereof) that have joined together as a buying group or engaged a common representative to act for them in joint purchases of electric energy. (A customer with more than one customer load should be viewed as an aggregator with respect to its own customer loads if the customer issues instructions to do so.)

Aggregation transaction—A transaction involving the combination of customer loads (or segments thereof) as when customers join together as a buying group or engage a common representative to act for them in joint purchases of electric energy; and either or both of a local aggregation transaction and a network aggregation transaction.

Aggregator—A party that has organized customers into a buying group or has been engaged by customers to act as their common representative in joint purchases of electric energy. (A broker is an aggregator as defined. A customer may be an aggregator under certain circumstances.)

Amount available capacity can be exceeded—An impact criterion reflecting the extent of the willingness of an ESP to take on customer loads that would increase the demand that the ESP would have to serve above the present level of capacity available to that ESP.

Appropriate indicator of efficiency in energy usage—Load factor, integral multiple factor, unutilized capacity purchased, or other measure of efficiency in energy usage adopted by an exchange user.

Architectural alternatives—The possible different logical relationships among nodes in a communications network, including hierarchies, rings, buses, and stars.

Associated loads—Customer loads of the same or affiliated customers that are required to be dealt with in the same transaction as a result of associated load instructions.

Associated load instructions—Instructions of a customer to the effect that all or certain loads of that customer or affiliated customers are required to be dealt with in the same transaction.

Association ID—An indicator associated with a group of customer loads that reflects a requirement that those loads be dealt with collectively.

Autonomous load search—A load search that proceeds using the default load search criteria set by the exchange node operator; and either or both of an autonomous local load search and an autonomous network load search; and either or both of an autonomous retail load search and an autonomous optimization load search.

Autonomous optimization load search mode—The mode of operation of the optimization load search engine in effect when the load search criteria are set by the operator of the exchange node in the absence of settings by the ESP/exchange user initiating the optimization load search at the time of that search.

Autonomous optimization price search mode—the mode of operation or the optimization price search engine in effect when the price search criteria are set by the operator of the exchange node in the absence of settings by the ESP/exchange user initiating the optimization price search at the time of that search.

Autonomous price search—A price search that proceeds using the default price search criteria set by the exchange node operator; and either or both of an autonomous local price search and an autonomous network price search; and either or both of an autonomous retail price search and an autonomous optimization price search.

Autonomous retail load search mode—The mode of operation of the retail load search engine in effect when the load search criteria are set by the operator of the exchange node in the absence of settings by the exchange user initiating the retail load search at the time of that search.

Autonomous retail price search mode—The mode of operation of the retail price search engine in effect when the price search criteria are set by the operator of the exchange node in the absence of settings by the exchange user initiating the retail price search at the time of that search.

Autonomous search instructions—Either or both of customer autonomous search instructions and ESP autonomous search instructions.

Autonomous search modes—Any and all of autonomous optimization load search mode, autonomous optimization price search mode, autonomous retail load search mode, and autonomous retail price search mode; and either or both of autonomous local search mode and autonomous network search mode.

Autonomous searches—Either or both of autonomous load searches or autonomous price searches; and either or both of autonomous local searches and autonomous network searches.

Available capacity—For any time period, the amount of energy that an ESP has available to satisfy the demand of customers or other ESPs.

Commitments—Firm commitments of customers pursuant to binding agreements to receive their electric power requirements from a particular ESP for a specified period of time.

Communications interfaces (inter-nodal)—The software interfaces that facilitate communications between exchange nodes.

Contracts administration manager—Either or both of the contracts administration manager (customers) and the contracts administration manager (ESPs).

Contracts administration manager (customers)—An application included each generic exchange node (and, in a hierarchical exchange network, in the RPX, the RNX, and the NatX) capable of assisting in the process concluding contracts between customers and ESPs and between customers through an exchange node or over an exchange network. Standard contract forms are to be used as a starting place, and, to facilitate the revision process, an application is provided that communicates suggested revisions, indicates changes through blacklining, etc. In addition to complete forms, clauses containing the language to address commonly occurring problems are to be provided and will enable those clauses to be imported into the form under negotiation. Such clauses will offer solutions to issues including interruptible power, curtailable power, etc. In addition, the contracts administration manager will support searches for relevant alternative contract clauses and will enable Exchange users to add contract forms and clauses to the database of the contracts administration manager. The final form of the contract will be stored in the system and used as a precedent on an anonymous basis. As a part of the subscription process (through the customer subscription manager), the customer will be able to indicate its preferred form of trading contract (fixed price for all requirements, cap, collar, etc.) and its preferred form of aggregation contract and whether those preferences are to be strictly applied. That preference information will be available to ESPs when they search for customer loads. The contracts administration manager works in coordination with the message handler.

Contracts administration manager (ESPs)—An application included in each generic exchange node (and, in a hierarchical exchange network, the RPX, RNX, and the NatX) similar to the contracts administration manager (customers) capable of assisting in the process of concluding contracts between or among ESPs through an exchange node or over an exchange network. As a part of the subscription process (through the ESP subscription manager), the ESP will be able to indicate its preferred form of optimization contract. That p reference information will be available to other ESPs with whom they engage in negotiations with a view to optimization trading. The contracts administration manager works in coordination with the message handler.

Custom load search—A load search that proceeds using the load search criteria set by the exchange user initiating the load search at the time of the search; either or both of a custom local load search and a custom network load search; and either or both of a custom retail load search and a custom optimization load search.

Custom optimization load search mode—The mode of operation of the optimization load search engine in effect when the load search criteria are set by the ESP/exchange user initiating the optimization load search at the time of the search.

Custom optimization price search mode—The mode of operation of the optimization price search engine in effect when the optimization price search criteria are set by the ESP/exchange user initiating the optimization price search at the time of the search.

Custom price search—A price search that proceeds using the price search criteria set by the exchange user initiating the price search at the time of the search; either or both of a custom local price search and a custom network price search; and either or both of a custom retail price search and a custom optimization price search.

Custom retail load search mode—The mode of operation of the retail load search engine in effect when the retail load search criteria are set by the exchange user initiating the retail load search at the time of the search.

Custom retail price search mode—The mode of operation of the retail price search engine in effect when the retail price search criteria are set by the exchange user initiating the retail price search at the time of the search.

Custom searches—Either or both of custom load searches and custom price searches; either or both of custom local searches and custom network searches; and either or both of custom optimization searches and custom retail searches.

Custom search modes—Any and all of custom optimization load search mode, custom optimization price search mode, custom retail local search mode, and custom retail price search mode; and either or both of custom local search mode and custom network search mode.

Customer—An end-user of electric power.

Customer account information—The information entered by a customer concerning its account with the exchange node operator that is entered as a part of the subscription process.

Customer ID—A unique identifier for each separate customer.

Customer information—Each and all of customer account information, customer load information, and commitments.

Customer instructions—Each and all of aggregation transaction instructions, associated load instructions, customer autonomous search instructions, division trading instructions, load aggregation instructions, long position instructions, customer ID instructions, and trading contract instructions.

Customer load—The load of a customer and segments thereof expressed as demand for electric energy as a function of time. Generally, a customer load is associated with one physical revenue meter and has, therefore, a geographic dimension. A customer may, of course, have more than one customer load, and those customer loads may be geographically concentrated or dispersed.

Customer load information—Each and all of customer load characteristic information, customer load identification information, and customer interval load data.

Customer load ID—The unique identifier of a particular customer load.

Customer subscription manager—An application included in each exchange node and capable of managing all administrative details that must be dealt with before a customer load can be reflected in an exchange database and listed in an exchange node. These matters include (i) execution and delivery of an agreement between the customer and the operator of the exchange node at which one or more loads of that customer are to be registered, (ii) completion of all locally required filings, authorizations, etc., to enable a customer to exercise freedom of choice in relation to electric energy suppliers, (iii) provision of all required customer account information, customer load information, and commitments, and (iv) provision of aggregation transaction instructions, associated load instructions, customer autonomous search instructions, load aggregation instructions, division trading instructions, customer ID instructions, long position instructions, and trading contract instructions.

Database interface—The software interface between the applications on the exchange node and the exchange database associated with that exchange node.

Database structure—The mode of data organization in exchange databases.

Demand—For a time or period, the amount of energy required to satisfy a customer load, i.e., the rate at which energy is consumed.

Divided load—Each and all of functionally-divided loads, practically-divided loads, and unit-divided loads.

Divided load trading—Exchange trading with respect to divided loads.

ESP account information—The information entered by an ESP concerning its account with the exchange node operator that is entered as a part of the subscription process.

ESP ID—The unique identifier of an ESP that is an exchange user.

ESP information—Each and all of ESP account information, ESP load information, and capacity information.

ESP instructions—Each and all of ESP autonomous search instructions, optimization trading instructions, impact disclosure instructions, ESP ID instructions, and optimization contract instructions.

ESP load—The load that an ESP has committed to serve, i.e., the sum of the customer loads of customers that have contracted with that ESP to secure electric energy. As used herein, an ESP load is made up of customer loads that can be practically served from the same sources of generation. The constituent customer loads may be spread across more than one territory. An ESP may have multiple ESP loads differentiated geographically.

ESP load ID—The unique identifier of a particular ESP load.

ESP load information—Each and all of ESP load characteristic information, ESP load identification information, and ESP interval load data.

ESP load optimization—The process of shifting supply obligations between ESPs carried out to improve an appropriate indicator of efficiency in energy usage with respect to the load of either or both ESPs involved in the process.

ESP subscription manager—An application included in exchange nodes capable of managing all administrative details that must be dealt with before an ESP may become an exchange user. These matters include (i) execution and delivery of an agreement between the ESP and the operator of the exchange node, (ii) completion of all locally required filings and authorizations necessary to enable an ESP to offer electric energy in the relevant jurisdiction, (iii) provision of ESP account information, capacity information and ESP load information, and (iv) provision of ESP autonomous search instructions, optimization trading instructions, impact disclosure instructions, optimization contract instructions, and ESP ID instructions.

Exchange database—The database associated with a particular exchange node.

Exchange network—A network, including two or more exchange nodes, capable of dealing with customer loads and ESP loads in more than one territory.

Exchange node systems—Each and all of the load search systems, the price search systems, and the trading systems; and each and both of the retail systems and the optimization systems.

Exchange trades—Either or both of retail trades and optimization trades; and either or both of local trades or network trades.

Exchange trading—Either or both of retail trading and optimization trading; and either or both of whole load trading and divided load trading; and either or both of local trading and network trading.

Exchange user—A customer, aggregator, ESP, or other user of an exchange node or an exchange network.

External communications capability—The capability of an exchange node to communicate with exchange users either through dial-up connections, the Internet, or through another public or private communications network.

External communications handler—The physical device that incorporates the external communications capability.

Functionally-divided loads—Loads that have been subjected to functional division.

GDS—generic database server.

IMF—Integral multiple factor.

Integral multiple factor—For an ESP, average of the ratios of average demand to available capacity for each of 24 hours (or for a peak or off-peak period or other time periods) where available capacity includes purchased capacity and capacity from self-generation. Ordinarily, available capacity, particularly purchased capacity, would be measured in integral multiples of one megawatt, hence “integral multiple” factor. Load factor and IMF are both indicators of efficiency of energy usage, and which of those is the more appropriate measure for an ESP depends upon how the ESP acquires energy. IMF would appear to be of concern to an ESP to the extent that the ESP purchases its requirements at wholesale for each hour independently. Load factor would appear to be of concern to owners of generation, including certain ESPs, and other ESPs to the extent that they purchase their requirements at wholesale under contracts for a certain fixed level of capacity for the whole 24-hour period (or for a peak or off-peak period).

Information—Any and all of account information, capacity information, commitments, load information, and trade information.

Inter-nodal communications capability—The capability of any exchange node and any exchange database to communicate with one another when deployed in an exchange network.

Inter-nodal communications handler—The physical device that incorporates the inter-nodal communications capability.

Interval—A period of time over which energy consumption is measured.

Interval demand (hourly)—The consumption during an interval times the number of such intervals per hour.

Interval load data—Either or both of customer interval load data and ESP interval load data.

Intervals per hour—Sixty minutes divided by the number of minutes in an interval of defined duration.

Instructions—Either or both of customer instructions and ESP instructions.

LDS—Local database server.

Lists—Each and all of the associated load lists, qualified load lists, and qualified trade lists.

Load—An electric load.

Load factor—For any load, the ratio of average demand over a period of time to the peak demand during that period.

Load characteristic criteria—Discrete criteria used for comparison to load characteristic information stored in an exchange database (or exchange databases).

Load characteristic information—Either or both of customer load characteristic information and ESP load characteristic information.

Load division—Either or both of dynamic load division and static load division; and each and all of functional division, practical division, and unit division.

Load ID—Either or both of customer load ID and ESP load ID.

Load identification criteria—Discrete criteria used for comparison to load identification information stored in an exchange database (or exchange databases).

Load identification information—Either or both of customer load identification information and ESP load identification information.

Load information—Either or both of customer load information and ESP load information; and either or both of load characteristic information and load identification information.

Load search—Either or both of a retail load search and an optimization load search; and either or both of a local load search and a network local search.

Load search criteria—Either or both of retail load search criteria and optimization load search criteria.

Load search request—Either or both of a retail load search request and an optimization load search request; and either or both of a local load search request and a network load search request.

Load search results—Either or both of retail load search results and optimization load search results; and either or both of local load search results and network load search results.

Load search systems—Either or both of the retail load search engine and the optimization load search engine.

Load shape—The curve obtained by plotting a customer's demand (conventionally on the y-axis) against time (conventionally on the x-axis).

Local aggregation transaction—A transaction involving the aggregation of customer loads where those loads are registered on the same exchange node.

Local load—With reference to a particular exchange node, a load that is registered thereon.

Local load search—Either or both of a local retail load search and a local optimization load search.

Local load search request—Either or both of a local retail load search request and a local optimization load search request.

Local load search results—Either or both of local retail load search results and local optimization load search results.

Local optimization load search—A search for an ESP load registered on the exchange node to which the exchange user making the search is connected.

Local optimization load search request—A request by an exchange user for a local optimization load search.

Local optimization load search results—The ESP load information obtained as a result of a local optimization load search; and the ESP load information provided by the optimization load search engine in response to a local optimization load search request.

Local optimization price search—A search for optimization trade information with respect to exchange trading of ESP loads registered on the exchange node to which the ESP exchange user making the search is connected.

Local optimization price search request—A request by an ESP exchange user for a local optimization price search.

Local optimization price search results—The optimization trade information obtained as a result of a local optimization price search; and the optimization trade information provided by the optimization price search engine in response to a local optimization price search request.

Local optimization trading—Effectuation of transactions involving load-shifting between ESPs that have registered their loads on the same exchange node.

Local price search—Either or both of a local retail price search and a local optimization price search.

Local price search request—Either or both of a local retail price search request and a local optimization price search.

Local price search results—Either or both of local retail price search results and local optimization price search results.

Local retail customer load search—A search for customer load information limited to the loads registered on the exchange node to which the exchange user making the search is connected.

Local retail customer load search request—A request for a local retail customer load search.

Local retail customer load search results—The customer load information obtained as a result of a local retail customer load search; and the customer load information provided by the retail load search engine in response to a local retail customer load search request.

Local retail ESP load search—A search for ESP load information by a customer/exchange user limited to the loads registered on the exchange node to which the customer/exchange user is connected.

Local retail ESP load search request—A request for a local retail ESP load search.

Local retail ESP load search results—The ESP load information obtained as a result of a local retail ESP load search; and the ESP load information provided by the retail load search engine in response to a local retail ESP load search request.

Local retail load search—Either or both of a local retail customer load search and a local retail ESP load search.

Local retail load search request—Either or both of a local retail customer load search request and a local retail ESP load search request.

Local retail load search results—Either or both of local retail customer load search results and local retail ESP load search results.

Local retail price search—A search for retail trade information with request to exchange trading of customer loads registered on the exchange node to which the exchange user making the search is connected.

Local retail price search request—A request for a local retail price search.

Local retail price search results—The retail a trade information obtained as a result of a local retail price search; and the retail trade information provided by the retail price search engine in response to a local retail price search request.

Local retail trading—Effectuation of transactions between an ESP and a customer providing for the supply of electric power by the ESP to the customer to satisfy customer loads limited to customer loads registered at the same exchange node at which the ESP load is also registered.

Local search—Either or both of a local load search and a local price search.

Local search request—A request for a local search.

Local search results—The information obtained as a result of a local search.

Local trading—Either or both of local optimization trading and local retail trading.

Man-machine graphical user interface—The software interface between the terminal of the exchange user and the applications of the exchange node.

Message handler—The capability of an exchange node to facilitate the passing of messages between exchange users and, where appropriate, to maintain the anonymity of the exchange users. Message handling capability would be used to support dialogs relating both to trading activity (between ESPs and customers and between ESPs) and to load aggregation activity (between customers, between customers and aggregators, and between aggregators).

Multiple load flag—An indicator used to aid searches based upon association IDs that reflects whether it is necessary to search more than one exchange node.

NatX—National exchange.

NDS—Network database server.

Network aggregation transaction—A transaction involving the aggregation of customer loads where those loads are not registered on the same exchange node.

Network load—With reference to a particular exchange node, a load that is registered on another exchange node.

Network load search—Either or both of a network retail load search and a network optimization load search.

Network load search request—Either or both of a network retail load search request and a network optimization load search request.

Network load search results—Either or both of network retail load search results and network optimization load search results.

Network optimization load search—A search for ESP loads registered on exchange nodes other than the exchange node to which the ESP/exchange user making the search is connected.

Network optimization load search request—A request by an ESP/exchange user for a network optimization load search.

Network optimization load search results—The ESP load information obtained as a result of a network optimization load search; and the ESP load information provided by the optimization load search engine in response to a network optimization load search request.

Network optimization price search—A search for optimization trade information with respect to exchange trading of ESP loads registered on exchange nodes other than the exchange node to which the ESP/exchange user making the search is connected.

Network optimization price search request—A request by an ESP/exchange user for a network optimization price search.

Network optimization price search results—The optimization trade information obtained as a result of a network optimization price search; and the optimization trade information provided by the optimization price search engine in response to a network optimization price search request.

Network optimization trading—Effectuation of transactions involving load-shifting between ESPs that have registered their loads at different exchange nodes.

Network price search—Either or both of a network retail price search or a network optimization price search.

Network price search request—Either or both of a network retail price search request and a network optimization price search request.

Network price research results—Either or both of a network retail price search results and network optimization price search results.

Network retail customer load search—A search for customer load information limited to loads registered on exchange nodes other than the exchange node to which the customer/exchange user making the search is connected.

Network retail ESP load search—A search for ESP load information by a customer/exchange user limited to loads registered on exchange nodes other than the exchange node to which the customer/exchange user making the search is connected.

Network retail load search—Either or both of a network retail customer load search and a network retail ESP load search.

Network retail customer load search request—A request for a network retail customer load search.

Network retail ESP load search request—A request for a network retail ESP load search.

Network retail customer load search request—Either or both of a network retail customer load search request and a network retail ESP load search request.

Network retail customer load search results—The customer load information obtained as a result of a network retail customer load search; and the customer load information provided by the retail load search engine in response to a network retail customer load search request.

Network retail ESP load search results—The ESP load information obtained as a result of a network retail ESP load search; and the ESP load information provided by the retail load search engine in response to a network retail ESP load search request.

Network retail load search results—Either or both of network retail customer load search results and network retail ESP load search results.

Network retail price search—A search for retail trade information with respect to exchange trading of customer loads registered on exchange nodes other than the exchange node to which the exchange user making the search is connected.

Network retail price search request—A request for a network retail price search.

Network retail price search results—The retail trade information obtained as a result of a network retail price search; and the retail trade information provided by the retail price search engine in response to a network retail price search request.

Network retail trading—Effectuation of transactions between an ESP and a customer providing for the supply of electric power by the ESP to the customer to satisfy customer loads limited to customer loads registered at an exchange node other than the exchange node at which the ESP load is registered.

Network search—Either or both of a network load search and a network price search.

Network search request—A request for a network search.

Network search results—The information obtained as a result of a network search.

Network trading—Either or both of local optimization trading and local retail trading.

Optimization engines—The optimization load search engine, the optimization trading engine, and the optimization price search engine.

Optimization load search—Either or both of a local optimization load search and a network optimization load search.

Optimization load search request—Either or both of a local optimization load search request and a network optimization load search request.

Optimization load search results—Either or both of local optimization load search results and network optimization load search results.

Optimization price search—Either or both of a local retail price search and a network retail price search.

Optimization price search request—Either or both of a local optimization price search request and a network optimization price search request.

Optimization price search results—Either or both of local optimization price search results and network optimization price search results.

Optimization search—Either or both of an optimization load search and an optimization price search; and either or both of a local optimization search and network optimization search.

Optimization search request—Either or both of an optimization load search request and an optimization price search request; and either or both of a local optimization search request and a network optimization search request.

Optimization search results—Either or both of optimization load search results and optimization price search results; and either or both of local optimization search results and network optimization search results.

Optimization trade—Either or both of a local optimization trade and a network optimization trade.

Power factor—For any load, the ratio of real power consumed (Watts) to the power apparently provided (volt-amperes or VARs), i.e., the ratio of real power to the sum of real power and reactive power.

Practically-divided loads—Loads that have been subjected to practical division.

Price search—Either or both of a retail price search and an optimization price search; and either or both of local price search and a network price search.

Price search criteria—Either or both of retail price search criteria and optimization price search criteria.

Price search request—Either or both of a retail price search request and an optimization price search request; and either or both of a local price search request and a network price search request.

Price search results—Either or both of retail price search results or optimization price search results; and either or both of local price search results and network price search results.

Price search systems—Either or both of the retail price search engine and the optimization price search engine.

Purchased capacity—The capacity available to an ESP from whatsoever source derived.

Qualified load lists—Each and all of the qualified retail customer load list, the qualified optimization load list, and the qualified retail ESP load list.

Qualified optimization load list—The list of ESP loads created as a result of an optimization load search.

Qualified retail customer load list—The list of customer loads created as a result of a retail load search by an ESP.

Qualified retail ESP load list—The list of ESP loads created as a result of a retail ESP load search by a customer.

Qualified trade list—Either or both of the qualified retail trade list and the qualified optimization trade list.

Qualified retail trade list—The list of retail trades created as a result of a retail price search.

Qualified optimization trade list—The list of optimization trades created as a result of an optimization price search.

RDS—Regional database server.

Retail customer load search—A retail load search for a customer load using the retail load search engine; and either or both of a local retail customer load search and a network retail customer load search.

Retail customer load search request—Either or both of a local retail customer load search request and a network retail customer load search request.

Retail customer load search results—Either or both of local retail customer load search results and network retail customer load search results.

Retail engines—The retail load search engine, the retail trading engine, and the retail price search engine.

Retail ESP load search—A retail load search by a customer or aggregator for an ESP load using the retail load search engine; and either or both of a local retail ESP load search and a network retail ESP load search.

Retail ESP load search request—Either or both of a local retail ESP load search request and a network ESP load search request.

Retail ESP load search results—Either or both of local retail ESP load search results and network ESP load search results.

Retail load search—Either or both of a retail customer load search and a retail ESP load search; and either or both of a local retail load search and a network retail load search.

Retail load search request—Either or both of a retail customer load search request and a retail ESP load search request; and either or both of a local retail load search request and a network retail load search request.

Retail load search results—Either or both of retail customer load search results and retail ESP load search results.

Retail price search—Either or both of a local retail price search and a network retail price search.

Retail price search request—Either or both of a local retail price search request and a network retail price search request.

Retail price search results—Either or both of local retail price search results and network retail price search results.

Retail search—Either or both of a retail load search and a retail price search; and either of both of a local retail search and a network retail search.

Retail search request—Either or both of a retail load search request and a retail price search request; and either of both of a local retail search request and a network retail search request.

Retail search results—Either or both of retail load search results and retail price search results; and either of both of local retail search results and network retail search results.

Retail trade—A transaction between an ESP and a customer providing for the supply of electric power by the ESP to the customer.

Retail trading—Any and all of whole load trading, functional division trading, practical division trading, and unit division trading involving customer loads and long position trading.

RPX—Retail power exchange.

RXN—Regional exchange node.

Search criteria—All bases for price searches and load searches, including both discrete criteria and impact criteria.

Search engine—Any and all of the retail load search engine, the retail price search engine, the optimization load search engine, and the optimization price search engine.

Search request—Either or both of a load search request or a price search request; and either or both of a local search request and a network search request; and either or both of an optimization search and a retail search.

Search results—Either or both of load search results and price search results; and either or both of local search results and network search results; and either or both of optimization search results and retail search results.

Searches—Either or both of load searches and price searches; either or both of retail searches and optimization searches; and either or both of local searches and network searches.

Search system-Either or both of the load search system and the price search system.

Service area—The geographic area associated with an exchange node where that association may not be unique.

Service type—The nature of the service provided to a customer described in terms of the voltage provided and the physical wiring topology.

SIC Code—Standard industrial classification code.

Territory—The geographic area associated with an exchange node where that association is unique.

Time period of load search—The period specified in a load search over which the discrete criteria and impact criteria for that load search are to be applied.

Time period of price search—The period specified in a price search over which the discrete criteria and impact criteria for that price search are to be applied.

Time period of search—Either or both of time period of load search and time period of price search.

Trading systems—Either or both of the retail trading engine and the optimization trading engine.

Trading terms—The material terms of an exchange trade.

Transmission geography—The area to which a particular generation source can practically and cost-effectively transmit its power.

UCP—Unutilized capacity purchased.

Unutilized capacity purchased—Generally for an ESP, the sum for each of 24 hours (or for peak or off-peak hours or any other period) of the differences between the available capacity (or purchased capacity) of the ESP and the capacity committed by that ESP through agreements with customers. UCP is an appropriate indicator of efficiency in energy usage which operates in absolute terms (megawatt hours) rather than as a ratio like load factor and IMF.

Unit-divided load—A load that has been subjected to unit division.

Unit or unit of measure—The quantity dimensions used to describe a load, e.g., kilowatt hours, kilovoltampere hours, or kilovoltampere reactive hours.

Unit Size—The dimensions (energy and time) of a unit.

Whole load—A load that has not been subjected to any form of load division.

Whole load trading—Exchange trading with respect to whole loads.

### II. Detailed Description

The systems and methods of the invention are based upon an exchange node and its associated exchange database. (A particular exchange node/exchange database combination is sometimes referred to in this disclosure as “local facilities” when discussing an exchange network.) The exchange nodes (and associated exchange databases) may be combined to form an exchange network that is local, regional, or national in scope.

Each exchange node (and associated exchange database) includes computerized load search engines, trading engines, and price search engines and data storage capability, including:
(i) a search engine capable of identifying and analyzing both (a) customer loads and aggregate loads and (b) the impact of adding a customer load or an aggregate load to an ESP load, another customer load, or another aggregate load measured in terms of an appropriate indicator of efficiency in energy usage (the “retail load search engine”);
(ii) a trading engine capable of administering, facilitating, executing, and recording (a) purchase and sale transactions between ESPs and customers in relation to electric energy to satisfy the requirements of a customer load or an aggregate load and (b) aggregation transactions between customers, between aggregators, or between customers and aggregators (the “retail trading engine”);
(iii) a search engine capable of identifying trading information about both completed purchase and sale transactions and bids based upon the characteristics of the customer loads involved and otherwise (the “retail price search engine”);
(iv) a search engine capable of identifying and analyzing ESP loads to determine how those ESP loads might be shifted between ESPs to increase energy efficiency measured in terms of an appropriate indicator of efficiency in energy usage (the “optimization load search engine”);
(v) a trading engine capable of administering, facilitating, executing, and recording load-shifting transactions between or among ESPs (the “optimization trading engine”); and
(vi) a search engine capable of identifying trading information concerning load-shifting transactions between ESPs based upon the effects of those transactions on the parties thereto and otherwise (the “optimization price search engine”).

Each of the exchange databases associated with exchange nodes makes use of a database structure that enables search and trading activities to take place to meet the requirements of:
(i). Customers, including aggregators, that consume electric energy at one or more sites that are listed on a single exchange node;
(ii) Customers, including aggregators, that consume electric energy at sites that are listed on two or more exchange nodes;
(iii) ESPs for optimization of ESP loads by load-shifting between ESPs where their ESP loads are listed on a single exchange node; and
(iv) ESPs for optimization of ESP loads by load-shifting between ESPs where their ESP loads are listed on two or more exchange nodes.

Each of the exchange nodes has the communications capability to enable communications with exchange users to carry out search and trading activities on that node. Each of the exchange nodes also has the communications capability and intelligence to operate in an exchange network in a coordinated manner that supports:
(i) search and trading activities across the exchange network;
(ii) the use of any of a number of architectures to create an exchange network; and
(iii) the adjustment of the functionality of exchange nodes depending upon the particular architecture utilized to create an exchange network.

Accordingly, the exchange nodes include data communications capability utilizing known technology to enable communications between exchange users and exchange nodes, among exchange nodes, between exchange nodes and other retail electric power exchanges, and between exchange nodes and their exchange databases (which themselves require corresponding data communications capability).

The exchange nodes could, for example, consist of mainframe computers with terminals, pc-based application servers, file servers with processing workstations, or a combination of such known technologies so long as each exchange node has the ability to exchange load information, price information, and other information with the other exchange nodes in the exchange network.

### A. Exchange Nodes

Each Exchange node may include a retail load search engine, a retail trading engine, a retail price search engine, an optimization load search engine, an optimization trading engine, and an optimization price search engine.

1. The Retail Load Search Engine

The retail load search engine is used to search for, identify, and analyze customer loads that meet established search criteria. Search criteria are of two types—“discrete criteria” and “impact criteria.” The retail load search engine is also used to search for, identify, and analyze ESP loads to determine the effect thereupon of the addition of particular customer loads.

Discrete criteria are characteristics of a load or the holder thereof considered in isolation and include, in the case of customer loads, load shape, load factor, and power factor as well as the size and location of the customer load and the SIC code of the customer. (Aggregate loads can also be described by discrete criteria, but some of those criteria may, in certain circumstances, not be applicable to a particular aggregate load.) Using discrete criteria, an ESP, a customer, or an aggregator may specify a generic customer load and search for a similar actual customer loads, as for example, when a supply contract representing part of an ESP load is to terminate, and the ESP wants to replace that portion of its total ESP load with a similar customer load. Similarity will need to be carefully defined by the exchange user in terms of permitted tolerances from specified discrete criteria.

Impact criteria include (a) the effects of adding a particular customer load (or one or more segments thereof) or an aggregate load (or one or more segments thereof) to an ESP load, a customer load, or another aggregate load where those effects are measured in terms of an appropriate indicator of efficiency in energy usage of the resulting load and (b) the effects of removing one or more segments from a particular customer load where those effects are measured in terms of appropriate indicator of efficiency in energy usage of the residual load.

Based upon the discrete criteria and impact criteria specified by the exchange user, the retail load search engine will search whole customer loads and divided customer loads resulting from functional division, practical division, and unit division.

Functional division is the segmentation of a whole load on a functional basis (base load, one or more hourly schedules, etc.).

Practical division is the segmentation of whole load on a practical basis without regard to the functional considerations of functional division or the extreme granularity of unit division. Practical division would be appropriate where an ESP made an offer to supply a seemingly arbitrary segment of a customer load or where a customer was considering measures to alter its customer load.

Customers can seek to lower their costs of electric energy not only by seeking the lowest cost of ESP, but also by utilizing energy management or energy efficiency techniques (e.g., upgrading to more energy efficient equipment). Customers considering the taking of energy efficiency measures would find it useful to be able to post not only their actual present customer loads, but also their customer loads as they would be giving effect to the energy efficiency measures under consideration. Customers would then be able to compare the responses of ESPs to the two different load shapes. Such information would be the basis for modeling to determine the financial wisdom of taking the proposed energy efficiency measures. The retail load search engine enables a customer to post a modification of its actual customer load (a “hypothetical load”). The customer could then make that hypothetical load (together with the actual customer load) available for consideration by ESPs through the retail load search engine. The creation of a hypothetical load may be viewed as a special case of practical division.

Hypothetical loads are also useful to consider the effect of introduction by a customer of distributed generation, i.e., the placement of a generation unit, generally a small one, at the customer's facility. The effect of introducing such a unit could be subjected to financial analysis if the customer were able to post both its actual customer load and a hypothetical load, i.e., the actual customer load adjusted by the effect on the customer load of the distributed generation unit. Then, assuming the distributed generation unit did not supply all of the customer's electric power requirements, the customer could then obtain the response of ESPs to supplying both loads. Those responses would provide critical information needed by the customer in its determination of the financial wisdom of proceeding or not with the implementation of the distributed generation unit.

When a customer has its own cogeneration capability, the retail load search engine will deal with the customer both as buyer and as seller of energy. The retail load search engine will give access to information concerning the net availability of power (“long position information”) as a contra load shape, i.e., a capacity shape, associated with the customer's consumption load shape for purchased power.)

Hypothetical loads are also useful to ESPs when they consider whether to renew or seek to renew supply arrangements with particular customers. The ESP could create a hypothetical load to reflect the loss of that customer and use the hypothetical load for the purposes of load searches using impact criteria.

Unit division is the segmentation of whole customer loads into uniform units of two dimensions: time (a particular hour of a particular day or part thereof) and demand (a kilowatt, kilovoltampere, kilovoltampere reactive, or multiples thereof) (“units”).

The retail load search engine can be utilized in two different modes: custom retail load search mode; and autonomous retail load search mode. In custom retail load search mode, the exchange user (customer, ESP, or aggregator) specifies the applicable discrete criteria and the impact criteria at the time of the search. The retail load search engine is sufficiently flexible to allow for these exchange user defined search criteria. It is also sufficiently flexible to allow for use of impact criteria both from the ESP's or aggregator's standpoint and from the customer's standpoint. This capability is critical in relation to customer loads that have been or have been proposed to be divided through functional division, practical division, or unit division. In autonomous retail load search mode, the operator of the exchange node establishes default search criteria in accordance with ESP (or customer) autonomous search instructions.

In summary, the retail load search engine (a) enables exchange users to search for loads that have certain intrinsic characteristics or are the loads of customers that have certain intrinsic characteristics; (b) enables an ESP to search for customer loads (or segments thereof) which, if added to the existing ESP load, would improve the ESP'S load factor or other appropriate indicator of efficiency in energy usage; (c) enables customers to identify those ESP loads, which, if the customer load were added thereto, would improve an appropriate indicator of efficiency in energy usage with respect to those ESP loads; and (d) enables a customer (or aggregator) to identify other customer loads or aggregate loads, which, if added to its own customer load or aggregate load, would create an aggregate load with an improved appropriate indicator of efficiency in energy usage as compared to those of the individual constituent loads.

### 2. The Retail Trading Engine

The retail trading engine has as its central tasks effecting (i) trading to satisfy customer loads, including whole loads (“whole load trading”), functionally-divided loads (“function division trading”), practically-divided loads (“practical division trading”), and unit-dividend loads (“unit-division trading”), (ii) trading of excess power created by a customer's cogeneration facilities (“long position trading”), and (iii) aggregation transactions.

The retail trading engine:
(a) facilitates functional division, practical division, and unit division by incorporating customers' and/or aggregators' instructions with respect to how to divide the customer load or aggregate load and listing the customer-defined and aggregator-defined segments of the customer load or aggregate load in the exchange database;
(b) facilitates functional division, practical division, and unit division by offering, at a customer's and/or an aggregator's request, suggestions for the division of the customer load or aggregate load on a functional, practical, or unit basis;
(c) facilitates functional division, practical division, and unit division by enabling ESPs, aggregators, and customers to suggest to customers and aggregators how their loads might be segmented using functional division, practical division, or unit division, but leaving to the customer the determination of whether or not to list its load in that manner;
(d) executes transactions involving (i) exchange trading, including whole load trading, functional division trading, practical division trading, unit division trading, (ii) long position trading, and (iii) aggregation;
(e) facilitates exchange trading and aggregation transactions by customers and/or aggregators, including customers and aggregators that consume energy at multiple sites, by rejecting trading bids from ESPs and aggregation proposals by customers or aggregators that do not conform to trading or aggregation requirements of customers recorded in the concerned exchange database;
(f) facilitates exchange trading and aggregation transactions through a customer subscription manager, a contracts administration manager (customer), and a message handler; and
(g) provides exchange users with information conveying the impact of proposed or actual exchange trading transactions involving functional division, practical division, or unit division or proposed or actual aggregation transactions upon a customer or an aggregator or an ESP where the ESP indicates its willingness to share that information.

The retail trading engine is responsible for carrying out of customer instructions that are entered by the customer through the customer subscription manager: The instructions include:
(a) instructions of customers with more than one customer load as to whether bids will be entertained for each customer load individually, for specified combinations of customer loads, or only for all customer loads of that customer (“associated load instructions”);
(b) instructions of customers or aggregators as to whether they would entertain proposals from other customers or aggregators for combination or aggregation of customer loads aggregate loads (“load aggregation instructions”);
(c) instructions of customers or aggregators as to whether they would engage in functional division trading, practical division trading, or unit division trading and, if so, customer instructions for the functional division, practical division, or unit division of the customer loads, including hypothetical customer loads (“division trading instructions”);
(d) instructions of customers with respect to long position trading, if applicable (“long position instructions”).
(e) instructions of customers with respect to their preferred form of retail exchange trading contract from among the contract forms available from the contracts administration manager (customers) (“trading contract instructions”);
(f) instructions of customers with respect to their preferred form of aggregation agreement (“aggregation transaction instructions”);
(g) instructions of customer respecting whether customer IDs and customer load IDs will be available to other exchange users (“customer ID instructions”); and
(h) instructions of customers concerning default criteria to be used in autonomous searches (“customer autonomous search instructions”).
(Not all instructions need be implemented by the operator of the exchange node.)

### 3. The Retail Price Search Engine

The retail price search engine enables exchange users to search for information concerning trading activity based upon geography, size of load, load factor, SIC Code, impact, etc. The price search engine would then find all trading activity (bids and completed transactions) that meet the search criteria and would also identify related loads.

The retail price search engine can be utilized in two different modes: custom exchange users retail price search mode; and autonomous retail price search mode. In custom retail price search mode, exchange users (customers, ESPs, or aggregators) specify the applicable discrete criteria and impact criteria and tolerances therefrom at the time of the search. In autonomous retail price search mode, the operator of the exchange node sets default search criteria in accordance with customer or ESP autonomous search instructions depending on the nature of the exchange user that requests the search.

### 4. The Optimization Load Search Engine

The optimization load search engine is able to search for, identify, and analyze ESP loads to determine how segments of those loads might be shifted between ESPs to increase an appropriate indicator of efficiency in energy usage.

The optimization load search engine generally assumes the unit division and, possibly, the practical division or functional division of ESP loads. The optimization search engine seeks to identify segments or units of ESP loads that can be shifted from one ESP to another to meet impact criteria specified by an ESP, e.g., shift units in such a way that an appropriate indicator of efficiency on energy usage of one or both ESPs involved in the shifting of units is improved.

The optimization load search engine is able to act in autonomous optimization load search mode in which, without instructions from an ESP at the time of the search, the optimization load search engine operates using default search criteria set by the operator of the exchange node in accordance with ESP autonomous search instructions. The optimization load search engine deals with ESP loads for one territory or service area. By the utilization of the exchange network, an exchange user can extend its optimization load search to all territories and service areas that, given transmission constraints, can undertake the load-shifting obligations.

### 5. The Optimization Trading Engine

The optimization trading engine facilitates, executes, and records load-shifting transactions between ESPs. The optimization trading engine:
(a) facilitates exchange trading of unit-divided loads, and, where possible, practically-divided and/or functionally-divided loads;
(b) facilitates exchange trading by allowing ESPs to modify the optimization trades suggested by the optimization trading engine and to reflect those modifications in bids;
(c) provides ESPs with information conveying the impact of proposed exchange trades on the ESPs as a pricing aid where the ESPs indicate their willingness to share that information; and
(d) engine includes a contracts administration manager (ESPs), an ESP subscription manager, and a message handler;
(e) engine is responsible for carrying out ESP instructions that are entered by the ESP through the ESP subscription manager:
   (i) ESP instructions as to whether it will entertain proposals for optimization trading (“optimization trading instructions”);
   (ii) ESP instructions as to whether it will permit disclosure of the impact of past exchange trading or current trading proposals upon an appropriate indicator of efficiency in energy usage with respect to that ESP load (“impact disclosure instructions”);
(iii) ESP instructions as to their preferred form of optimization trading contract from among the contract forms available from the contracts administration manager (“optimization contract instructions”);
(iv) ESP instructions as to whether ESP ID and ESP load ID will be available to other exchange users (“ESP ID instructions”); and
(v) ESP instructions concerning default criteria to be used in autonomous searches (“ESP autonomous search instructions”).
(Not all instructions need be implemented by the operator of the exchange node.)

### 6. The Optimization Price Search Engine

The optimization price search engine enables ESPs to search for trade data based upon discrete criteria and impact criteria. In custom optimization price search mode, the search criteria are set by the ESP undertaking the search at the time of the search. In autonomous optimization price search mode, the search criteria are set at defaults by the operator of the exchange node in accordance with ESP autonomous search instructions.

### B. Exchange Databases

Exchange databases support the search, aggregation, and exchange trading activities described above. Each of the exchange databases utilizes a database structure to organize the data required to support the work of exchange nodes and the exchange network (local searches, network searches, local aggregation, network aggregation, local trading, network trading).

The database structure enables searches and exchange trading to take place to satisfy customer loads for customers that consume electric energy at one or more sites that are listed on a single exchange node or two or more exchange nodes connected in an exchange network. A site in this context refers to a single point at which revenue metering takes place. The database structure also enables searches and exchange trading to take place to effect ESP load optimization wherever the ESP loads may be located.

The database structure includes:
1. account information:
   (a) customer account information; and
   (b) ESP account information;
2. load information:
   (a) customer load information:
      (i) customer load identification information (including, but not limited to, customer ID, customer load ID, association ID, multiple load flag, SIC code, service type, service area/territory, generation service area, unit of measure, and intervals per hour);
      (ii) customer load characteristic information;
      (iii) customer interval load data; and
      (iv) customer normalized data (calculated);
   (b) ESP load information
      (i) ESP load identification information (including, but not limited to, ESP ID, ESP load ID, service area/territory, unit of measure, and intervals per hour);
      (ii) ESP load characteristic information;
      (iii) ESP interval load data; and
      (iv) ESP normalized data (calculated);
3. trade history tables:
   (a) trade and pricing information;
   (b) load characteristic information; and
   (c) load impact values;
4. interval capacity information;
5. instructions:
   (a) customer instructions:
      (i) associated load instructions;
      (ii) division trading instructions;
      (iii) load aggregation instructions;
      (iv) long position instructions;
      (v) trading contract instructions;
      (vi) customer ID instructions; and
      (vii) autonomous search instructions;
   (b) ESP instructions:
      (i) impact disclosure instructions;
      (ii) optimization contract instructions;
      (iii) optimization trading instructions;
      (iv) ESP ID instructions; and
      (v) autonomous search instructions;
6. lists:
   (a) qualified trade lists:
      (i) qualified retail trade list; and
      (ii) qualified optimization trade list;
   (b) qualified load lists:
      (i) qualified retail customer load list;
      (ii) qualified retail ESP load list; and
      (iii) qualified optimization load list;
7. commitments; and
8. long position information.

### C. Hierarchical Networks.

In a hierarchical exchange network, generic exchange nodes and generic exchange databases take on particular characteristics, there being three of each kind. The six resulting components are comprised of three pairs of exchanges nodes and related exchange databases. The elements of functionality discussed above are distributed among the six components such that exchange nodes (RPX, RNX, and NatX) have similar functionality, exchange database components (LDS, RDS, and NDS) have similar functionality, and differences among exchange node components and among exchange database components derive from the degree of geographic diversity of the customer loads involved. All six components have inter-nodal communications capability.

1. The Retail Power Exchange

The retail power exchange (RPX) includes the retail load search engine, the retail trading engine, and the retail price search engine, the optimization load search engine, the optimization trading engine, and the optimization price search engine. The RPX handles the search and transaction activity with respect to customer loads of local accounts, i.e., the accounts of customers with loads in only one territory. The RPX handles search and transaction activity with respect to ESP loads to the extent those ESP loads are comprised of customer loads of local accounts. The RPX is connected to its LDS. In an exchange network, the RPX is connected to either an RNX or directly to the NatX. The RPX has inter-nodal communications capability and external communications capability.

2. The Local Database Server

The local database server (LDS) includes the local database, the content of which depends upon the particular architectural alternative utilized for a particular LDS. The LDS is always connected to its own RPX. The LDS has inter-nodal communications capability.

3. The National Exchange

The national exchange (NatX) includes the retail load search engine, the retail trading engine, the retail price search engine, the optimization load search engine, the optimization trading engine, and the optimization price search engine.

The NatX handles search and transaction activity with respect to customer loads of national accounts, i.e., the accounts of customers with loads in two or more territories except that, when one or more RNXs are present in the exchange network, customer loads of national accounts that are within the territories of RPXs connected to one RNX are served by that RNX. The NatX handles search and exchange trading with respect to ESP loads to the extent that ESP loads include customer loads of national accounts, except that, when one or more RNXs are present in the exchange network, ESP loads that include customer loads of national accounts that are within the territories of RPXs connected to one RNX are served by that RNX.

The NatX will generally supervise the exchange network and, in particular, national accounts even when activities are handled primarily by RNXs or RPXs. The NatX will also enable searches for customer loads and ESP loads to be extended beyond the territory of a particular RPX, except when one or more RNXs are present in the exchange network. In that event, such searches for customer loads and ESP loads that are within the territories of RPXs connected to one RNX, are handled by that RNX. The NatX is connected to one or more RNXs and/or to one or more RPXs. The NatX has inter-nodal communications capability and external communications capability.

4. The Network Database Server

The network database server (NDS) includes the network database, the content of which depends upon the architectural alternative utilized. The NDS is always connected to the NatX. The NDS has inter-nodal communications capability.

5. The Regional Network Exchange

The regional network exchange (RNX) includes the retail load search engine, the retail trading engine, retail price search engine, optimization load search engine, optimization trading engine, and the optimization price search engine. When included in the exchange network, an RNX handles search and exchange trading with respect to the customer loads of national accounts that are within the territories of the RPXs connected to that RNX.

When included in the exchange network, an RNX handles search and transaction activity with respect to the ESP loads to the extent that the ESP loads include customer loads of national accounts that are within the territories of RPXs connected to that RNX.

The RNX will generally supervise the RPXs to which it is connected in the exchange network and, in particular, national accounts that are within the territories of RPXs connected to that RPX even when those activities are handled primarily by those RPXs.

The RNX will also enable searches for customer loads and ESP loads to be extended beyond the territory of a particular RPX, except that load searches for loads beyond the territories of the RPXs connected to one RNX are handled by the NatX. The RNX will be connected to two or more RPXs and to the NatX. The RNX has inter-nodal communications capability and external communications capability.

6. The Regional Database Server

The regional database server (RDS) includes the regional database, the content of which depends upon the architectural alternative utilized. The RDS is always connected to its own RNX. The RDS has inter-nodal communications capability.

### III. Further System Details

In this Section III, further details are provided concerning the system as follows:
System Architecture (Section III.A);
Search criteria (Section III.B);
Load search system (Section III.C);
Price search system (Section III.D); and
Trading System (Section III.E).

Section III.A (System Architecture) explains the architecture of exchange modes, exchange databases, and exchange networks.

Section III.B (Search Criteria) explains how discrete criteria and impact criteria are used to frame load searches and price searches.

Section III.C (Load Search System) explains how the load search system applies discrete criteria and impact criteria to loads to carry out load searches.

Section III.D (Price Search System) explains how the price search system applies discrete criteria and impact criteria to exchange trades to carry out price searches.

Section III.E (Trading System) explains how the trading system facilitates the making of exchange trades and aggregation transactions.

A. System Architecture

This section provides greater detail concerning the system architecture including:
stand-alone operation of exchange nodes and operation of exchange nodes in an exchange network;
means of connecting exchange nodes in an exchange network;
independence of exchange network operation from the particular communications technology used to connect exchange nodes;
independence of exchange nodes from the particular hardware utilized;
generic nature of exchange nodes from the standpoint of functionality;
ability to create an exchange network utilizing alternative network architectures;
development of national or regional exchange networks;
relationship between exchange network development and geography;
load searching locally and in an exchange network;
exchange trading locally and in an exchange network;
price searching locally and in an exchange network; and
inter-nodal communications.

The system may, in operational form, comprise either a single exchange node or two or more exchange nodes Each exchange node consists of a computer system or local area network of computer systems. When the system includes a single exchange node, operation on a stand-alone basis is contemplated, and each exchange node, without alteration or addition, has the capability to operate on a stand-alone basis. When an exchange node operates on its own, it does not utilize all of its capabilities, e.g., inter-nodal communications capability.

When the system utilizes two or more exchange nodes, an exchange network is created, and the exchange nodes, which may be distant from one another, may be connected to one another using public communications technologies such as the internet private telecommunications technologies, such as a value-added networks, or a combination thereof. The ability of exchange nodes to function in an exchange network is not dependent on the technology used to connect those exchange nodes so long as each exchange node has the ability to communicate with all other exchange nodes by exchanging messages within the exchange network. The exchange of messages between or among exchange nodes is the function of the inter-nodal communications handler and the message handler.

The architecture of exchange nodes within an exchange network is also not restricted. Exchange nodes could consist of mainframes with terminals, pc-based application servers, fileservers with processing workstations, or a combination of such technologies. The requirement is only that each exchange node and its associated exchange database be able to handle the database structure, the load search systems, the price search systems, the trading systems, and the inter-nodal communications required to support exchange network operations.

From an applications functionality standpoint, all exchange nodes, whether operating stand-alone or in an exchange network are identical and are, until their database servers are loaded with data, and the exchange nodes interconnected with other exchange nodes, programmed, and placed in operation, generic exchange nodes capable of performing as exchange nodes in the manner required by the database structure employed and architectural alternative utilized.

Thus, if the architectural alternative chosen is a hierarchical network, generic exchange nodes would be connected in a hierarchical fashion and would, through programming and the database structure employed, become two or more RPXs, one or more RNXs, and a NatEx. If the architectural alternative chosen is a ring, bus, or star network configuration, generic exchange nodes would not be functionally differentiated based upon a hierarchy among exchange nodes, but would, rather, remain essentially generic from the standpoint of functionality.

No matter which architectural alternative is utilized, the essential functionality of exchange nodes is not altered. Each exchange node, whether stand-alone or in an exchange network and whatever architectural alternative is employed includes the load search systems, the price search systems, and trading systems. It is the interplay among database structure, geography, and the particular architectural alternative employed, that determines on which customer loads and ESP loads those exchange node systems operate.

In the sense detailed above, the system is exchange node-based, i.e., the functionality of a generic exchange node is intrinsic in every exchange node however that exchange node may be programmed and utilized, and exchange nodes are exchange network-cooperative, i.e., the functionality of exchange nodes supports their operation in an exchange network and does not limit architectural alternatives.

Since the exchange node functionality is available on a stand-alone basis or in an exchange network, the development of a national system for retail power trading and ESP load optimization by means of a single exchange node or exchange nodes organized by regions or otherwise can be determined by the market and not by the technology or restrictions intrinsic in the systems of the invention. Also, other parties' retail power trading systems could incorporate the systems of the invention and be able to join an exchange network as an exchange node and participate fully in the exchange network.

The functional operation of an exchange node is thus designed to be independent of the logical and physical network topology, i.e., independent of architectural alternatives and of communications network technologies. Even though each exchange node is capable of full generic exchange node functionality, it must be able to forward transaction proposals and confirmations, load search requests, and price search requests to the other exchange nodes participating in the exchange network when utilizing its load search systems, price search systems, and trading systems. As previously noted, the functional differentiation of exchange nodes operating in an exchange network derives less from the architectural alternative employed in organizing the exchange network and more from (i) the relationship between the exchange nodes and the geography (exclusive or overlapping) of the loads registered on the exchange nodes and (ii) the database structure that enables distribution of data while facilitating searches, including load searches and price searches that are either local searches or network searches, and exchange trading, including local and network retail trading and local and network optimization trading.

In one embodiment of a national exchange network, individual exchange nodes can handle all data for each common generation service area or each territory. If a customer has loads in multiple common generation areas or territories, then that customer's loads would be registered severally at multiple exchange nodes. In another embodiment, each exchange node could register customer loads no matter where those loads were located. This approach would mean that an exchange node would have loads from multiple common generation areas within its own exchange database. Therefore, to operate in the exchange network with this flexibility, an exchange node must be able to have access to the load search systems, price search systems, and trading systems of the other exchange nodes. It is likely that both embodiments will exist, to some extent, within the exchange network as the market develops.

The combination of (i) maintenance of generic exchange node functionality at each exchange node, (ii) the database structure and the distribution of data among exchange nodes and their associated exchange databases, and (iii) the inter-nodal communications capability of exchange nodes makes possible effective load searches, including local load searches and network load searches, exchange trading, including local trading and network trading, and price searches, including local price searches and network price searches, in the context of an exchange network.

Exchange trading transactions are recorded at the exchange node at which the load concerned is registered. When multiple customer loads are involved in an exchange trade, the details of that exchange trade are recorded at each exchange node at which one or more of the loads involved is registered. The actual exchange trade itself is initiated at the exchange node of the exchange user making the offer, but, when the exchange trade is completed, the details of that exchange trade are recorded in the trade tables maintained in the exchange databases of the exchange nodes at which the loads are registered. The details of exchange trading must be maintained in the exchange databases of all concerned exchange nodes and be available to all exchange nodes within the exchange network for support of the price search systems.

When a price search request is made by an exchange user that includes local price search request and a network price search request, the exchange database of the exchange node to which the exchange user making the price search request is connected is searched, and a network price search request is made to the other exchange nodes of the exchange network to activate their price search systems. Network price search results will be returned to the exchange node from which the requesting exchange user is operating for consolidation, sorting, and display together with local price search results.

Similarly, when a load search request is made by an exchange user that includes a local load search request and a network load search request, the exchange database of the exchange node to which the exchange user making the load search request is connected is searched, and a network load search request is sent to the other exchange nodes of the exchange network to activate their load search systems. Network load search results will be returned to the exchange node from which the requesting exchange user is operating for consolidation, sorting, and display together with local load search results.

With the distribution of both functionality and data between or among the exchange nodes and exchange databases of the exchange network, the inter-nodal communications capability is required to facilitate network exchange trading, network aggregation transactions, and the communication of network search requests, including network load search requests and network price search requests, and network search results, including network load search results and network price search results, between exchange nodes.

There are established techniques and technologies currently utilized to perform inter-nodal (or computer to computer) network communications. Those include, but are not limited to, protocol independent techniques such as publish and subscribe, broadcast, routing tables, and name services. Protocol-dependent techniques such as COM, CORBA, and HTTP also be used. Any of these techniques may be appropriate and sufficient to be used in building exchange nodes and exchange networks provided the implementation supports the data, timeliness, and reliability required by the exchange users. The actual data making up the network search requests sent and network search results received through the inter-nodal communications handler should use appropriate data formats established by the industry. The utility and information technology groups working within the electric power industry have established various standard data exchange formats which include EDI, CMEP, MDEF, and XML.

B. Search Criteria

This section provides greater detail concerning the search criteria used to frame search requests. The system provides for two basic kinds of searches: load searches and price searches. This section first considers load search criteria (Section III.B.1) and then considers price search criteria (Section III.B.2).

Section III.B.1 (Load Search Criteria) deals with load search criteria as applied to whole loads, functionally-divided loads, and practically-divided loads (III.B.1(a)) and deals separately with load search criteria as applied to unit-divided loads (III.B.1(b)).

Similarly, Section III.B.2 (Price Search Criteria) deals with price search criteria as applied to exchange trades involving whole loads, functionally-divided loads, and practically-divided loads (III.B.2.(a)) and deals separately with exchange trades involving unit-divided loads (III.B.2(b)).

The load search systems and the price search systems use discrete criteria and impact criteria in performing searches. The list of search criteria may evolve and grow from that described without compromising the concepts and comparison techniques described. An exchange user formulating a load search request or price search request specifies the search criteria and the time period of search. The discrete criteria and impact criteria used and the source of the data for comparison and analysis vary depending on whether a load search request or a price search request is made and whether a local search request or a network search request is made.

The autonomous search modes allow the operator of an exchange node to set default discrete criteria and impact criteria for the search, i.e., search criteria to be used in the absence of a current specification of search criteria by an exchange user. The exchange node and its exchange database enable the operator to establish and store default search criteria in the exchange database on an exchange user by exchange user basis. Therefore, when an exchange user logs on to an exchange node and makes a load search request or price search request, the discrete criteria and impact criteria are defaulted to criteria established in accordance with the exchange user's current autonomous search instructions.

There follows a detailed explanation of the framing of load search requests using load search criteria appropriate to the nature of the loads being searched (III.B.1) and of the framing of price search requests using price search criteria appropriate to the nature of the loads involved in the exchange trades being searched (III.B.2).

### 1. Load Search Criteria

(a) Whole Loads. Functionally-Divided Loads, and Practically-Divided Loads

This section provides greater detail concerning load search criteria as applied to whole loads, functionally-divided loads, and practically-divided loads.

This section includes four subparts as follows:
III.B.1(a)(i)—Discrete Criteria;
III.B.1(a)(ii)—Impact Criteria;
III.B.1(a)(iii)—Divided Loads; and
III.B.1(a)(iv)—Multiple Loads.

The subparts concerning discrete criteria and impact criteria are the most detailed and contain a number of subparts that have been separately titled to aid reading.

(i) Discrete Criteria

This section provides greater detail concerning discrete criteria as applied to whole loads, functionally-divided loads, and practically-divided loads for the purpose of load searches.

This section includes two subparts as follows:
III.B.1(a)(i)(A)—Load Identification Criteria; and
III.B.1(a)(i)(B)—Load Characteristic Criteria.

Load searches that specify discrete criteria may utilize discrete criteria of each of two subclasses: load identification criteria and load characteristic criteria.

Load identification criteria are used for comparison to the load identification information stored in an exchange database for each customer load and each ESP load. Load characteristic criteria are used for comparison to load characteristic information stored in an exchange database for each customer load and each ESP load. Some load characteristic information needed for comparison is already available in the exchange databases and is referred to as “normalized data,” and, therefore, is available for immediate comparison. The remaining load characteristic information required for the comparison must be calculated from the interval load data for the time period of search.

When the interval load data for a particular load is initially stored in the appropriate exchange database, the normalized data is calculated on a daily basis and stored in another set of tables within the exchange database. The preparation of normalized data is carried out ahead of time in order to provide a time-efficient way to process the load search. Since the load identification information and normalized data are directly accessible, only loads that match the load identification criteria and the load characteristic criteria that operate on comparisons to normalized data need to have their interval load data processed interval by interval to calculate the “discrete load values” needed for comparison to the remaining load characteristic criteria.

Since the normalized data are stored on a daily basis, comparisons can be made to load characteristic criteria specified by day of week. The exchange node operator can specify a scheme of classification of days. One such scheme is described below. Pursuant to that scheme, the exchange user has the ability, during the specification of load characteristic criteria, to provide five (5) day types representing Sunday, Monday, Tuesday-Thursday, Friday, and Saturday (“day types”) for the load characteristic criteria being compared to normalized data.

The following is a list of the normalized data (discrete load values) calculated from the interval load data and stored in the appropriate exchange database on a daily basis:
Maximum interval demand (peak interval energy value multiplied by the number of intervals per hour);
Maximum demand (peak energy usage in an hour);
Total daily usage (total energy usage in a day);
Intervals per hour (number of time periods of data stored in exchange database per hour); and
Load duration values (% of maximum demand for 20, 40, 60, and 80% of time).

As described above, the discrete criteria applicable to load searches are divided into two subclasses: load identification criteria and load characteristic criteria. The load identification criteria are compared to the load identification information in the appropriate exchange database. Load characteristic criteria can be specified on a daily basis and for the entire time period selected (“time period of search”). When specified on a daily basis, the load criteria for the day types are compared to the normalized data stored in the appropriate exchange database or databases. The load characteristic criteria applied to a time period of search must then use the discrete load values calculated from the interval load data for that time period. Following is an initial list of the discrete criteria by category.

(A) Load Identification Criteria
Customer ID;
Load ID;
Service Area;
SIC Codes;
Service Types; and
Time Period of Search.

(B) Load Characteristic Criteria
Minimum Load Factor, the smallest load factor acceptable for each of the five day types and for the time period of search;

| | |
|---|---|
| Daily | 5 day type values; and |
| For time period of search | 1 value |

Maximum Hourly Demand Range (the highest and lowest acceptable hourly demands energy usage for an [hour] for each of the five day types and for the time period of search):

| | | |
|---|---|---|
| Daily | high | 5 day type values; and |
| | low | 5 day type values; and |
| For time period of search | high | 1 value; and |
| | low | 1 value; |

Average Hourly Demand Range (the highest and lowest acceptable hourly average demand for each of the five day types and for the time period of search where average demand is the sum of all hourly demands divided by the number of hourly demands used in the sum):

| | | |
|---|---|---|
| Daily | high | 5 day type values; and |
| | low | 5 day type values; and |
| For time period of search | high | 1 value; and |
| | low | 1 value; |

Maximum Interval Demand Range (the highest and lowest acceptable interval demands for each of the five day types and for the time period of search):

| | | |
|---|---|---|
| Daily | high | 5 any type values; and |
| | low | 5 day type values; and |
| For time period of search | high | 1 value; and |
| | low | 1 value; |

Minimum Load Duration Values (% of maximum demand) (smallest load duration values acceptable for each of the five day types and for the time period of search where load duration values represent the percent of time, in this case 20%, 40%, 60%, and 80%, that the load is at a percentage of the maximum demand):

| | |
|---|---|
| Daily | 20% of time - 5 day type values; |
| | 40% of time - 5 day type values; |
| | 60% of time - 5 day type values; and |
| | 80% of time - 5 day type values; and |
| For time period of search | 20% of time - 1 value; |
| | 40% of time - 1 value; |
| | 60% of time - 1 value; and |
| | 80% of time - 1 value. |

(Power factor and other measures could also be used as load characteristic criteria where appropriate data is available.)

(ii) Impact Criteria

This section provides further detail concerning impact criteria as applied to whole-loads, functionally-divided loads, and practically-divided loads for the purpose of load searches.

This section includes two subparts as follows:

III.B.1(a)(ii)(A)—Impact Criteria utilizing the Resulting Interval Load Data only; and

III.B.1(a)(ii)(B)—Impact Criteria utilizing the Resulting Interval Load Data and Interval Available Capacity Data.

Impact criteria are used to evaluate the resulting load after a particular load has been combined with the load of an ESP load or an aggregate load. Calculations must be performed on the resulting interval load data in order to generate the “load impact values” needed for comparison to all the impact criteria specified by the exchange user. The exchange user has the ability to set impact criteria that apply for the entire time period specified and daily impact criteria that are applied based on the day of week. All daily impact criteria are specified with the day-types.

Certain impact criteria only apply when considering an ESP's available capacity. This limitation is derived from the fact that those impact criteria specify the effect of the resulting ESP load on the ESP's available capacity. The ESP's interval load data and the ESP's interval available capacity data (representing the ESP's available capacity for each interval) are stored in the appropriate exchange databases. Having both the interval load data and the interval available capacity data enables analysis of the utilization of available capacity as different loads are combined with the ESP load.

The following is a list of the impact criteria. All impact criteria require that load impact values be calculated for comparison from the interval load data of the load resulting from the combination of the ESP load and the load proposed to be combined therewith for the time period of the search. Some of the impact criteria also require that interval available capacity data be utilized to calculate load impact values for comparison.

(A) Impact Criteria Utilizing the Resulting Interval Load Data Only:
Maximum Hourly Demand (highest hourly demand found during the time period of search):

| | |
|---|---|
| For time period of search | 1 value; |

Maximum Load Factor Decrease (largest decline in load factor acceptable for each of the five day types and for the time period of search):

| | |
|---|---|
| Daily | 5 day type values (%) |
| For time period of search | 1 value (%); |

Maximum Load Duration Value Decrease (largest decline in load duration values acceptable for each of the five day types and for the time period of search at 20%, 40% 60%, and 80% of that time period):

| | |
|---|---|
| Daily | 20% of time - 5 day type values; |
| | 40% of time - 5 day type values; |
| | 60% of time - 5 day type values; and |
| | 80% of Time - 5 day type values; and |
| For time period of search | 20% of time - 1 value; |
| | 40% of time - 1 value; |
| | 60% of time - 1 value; and |
| | 80% of time - 1 value. |

(B) Impact Criteria Utilizing the Resulting Interval Load Data and Interval Available Capacity Data:
Amount Available Capacity can be Exceeded (the maximum percentages of the available capacity that the resulting load can reach and still be acceptable for the time period of search):

| | |
|---|---|
| For time period of search | 1 value (%); |

Minimum Integral Multiple Factor Increase (where available capacity is not exceeded, smallest amount of improvement in the integral multiple factor that is acceptable for each of the five day types and for the time period of search):

| | |
|---|---|
| Daily | 5 day type values (%); and |
| For time period of search | 1 value (%); and |

Maximum Integral Multiple Factor Decrease (where available capacity is exceeded, largest decline in the integral multiple factor that is acceptable for each of the five day types and for the time period of search):

| | |
|---|---|
| Daily | 5 day type values (%); and |
| For time period of search | 1 value (%). |

(iii) Divided Loads

Customers, ESPs, and aggregators can have their loads divided by means of the trading systems so as to make them more desirable for retail trading, aggregation transactions, or optimization trading, as applicable. This load division would itself create new interval load data, which would be stored in the exchange database together with the interval load data for whole loads. With the divided loads stored along with the whole loads, the search engines would find both whole loads and divided loads so long as the discrete criteria and impact criteria are satisfied. However, even though loads may be divided and stored as static profiles for the implementation of functional load division and practical load division in this embodiment of the invention (“static load division”), other implementations of load division are possible. Load division could be performed dynamically just before or during the load search process based on rules defined by the operator of the exchange node or industry regulations. Under “dynamic load division,” the load may or may not be stored in the appropriate exchange database. An example of dynamic load division is detailed below in the description of the implementation of unit load division.

(iv) Multiple Loads

Customers may have multiple loads registered in a single territory or service area or loads located in multiple territories or service areas and may require that all loads or a subset of loads be traded together. Customers could also require that all loads be traded together nationally.

To handle the case of multiple loads of a single customer or aggregation in the same territory or service area, the trading engine of the concerned exchange node would aggregate the loads that are to be traded together in the territory or service area. The associated load ID, if applicable, load identification information, and load characteristic information concerning the associated local loads will be included in the load search results. The interval load data and the normalized data for the aggregate loads would be stored in the exchange database of the exchange node for the territory or service area. Aggregating the loads dynamically where appropriate for evaluation during the load search is also possible, but the advantage of utilizing normalized data to speed the load search would be lost. As was the case with load division, even though the preferred embodiment of the invention provides that loads that are in the same common generation service area and that are to be traded together are to be aggregated in advance, other implementations, including dynamic aggregation, would also be valid.

To handle the case of multiple loads in multiple territories or service areas (including nationwide), the trading engine will store an association ID with each load which will indicate a logical group for the set of multiple loads to be traded together. Each load will also have the multiple load flag which will indicate whether associated loads are all registered on one exchange node or multiple exchange nodes.

The load search results will indicate for all loads found whether other loads exist for the customer that must also be traded in the same transaction. The load search system enables a load search across the exchange network to find all loads for a customer by specifying the particular customer ID as the only discrete criteria and ignoring all impact criteria.

(b) Unit-Divided Loads

This section provides greater detail concerning load search criteria as applied to unit-divided loads for the purpose of load searches.

This section includes five subparts as follows:

III.B.1(b)(i)—Discrete Criteria;

III.B.1(b)(ii)—Impact Criteria;

III.B.1(b)(iii)—Unit Division Process Overview;

III.B.1(b)(iv)—Unit Division Process in Detail; and

III.B.1(b)(v)—Note on Interval Load Data

The subparts concerning discrete criteria, impact criteria, unit division process overview, and unit division process in detail are lengthy, deal with complex issues, and contain a number of subparts that have been separately titled to assist in following the development of the explanation of the system.

(i) Discrete Criteria

This section provides greater detail concerning discrete criteria as applied to unit-divided loads for the purpose of load searches.

This section includes two subparts as follows:

III.B.1(b)(i)(A)—Load Identification Criteria; and

III.B.1(b)(i)(B)—Load Characteristic Criteria

The discrete criteria for unit-divided load searches are composed of the same two subsclasses of discrete criteria applicable to whole load searches, functionally-divided load searches, and practically-divided load searches. The normalized data which is stored on a daily basis is also used in unit-divided load searches as are the five (5) day types.

(A) Load Identification Criteria

The load identification criteria for unit-divided loads are the same as for whole loads and for other types of divided loads.

(B) Load Characteristic Criteria

In unit-divided load searches, the interval load data are constructed dynamically during the load search process. Therefore, the load characteristic criteria utilized during load searches based on static load division are not applicable during load searches involving dynamic load division, including unit-divided load searches.

The following is a list of the load characteristic criteria available to the exchange user during the specification of search criteria for a unit-divided load search:
Maximum. Load Factor (%):

| | |
|---|---|
| Daily | 5 day type values (%); and |
| For time period of search | 1 value (%); and |

Maximum Load Duration Values (% of Maximum Demand):

| | |
|---|---|
| Daily | 20% of Time - 5 day type values; |
| | 40% of Time - 5 day type values; |
| | 60% of Time - 5 day type values; and |
| | 80% of Time - 5 day type values; and |
| For time period of search | 20% of Time - 1 value (%); |
| | 40% of Time - 1 value (%); |
| | 60% of Time - 1 value (%); and |
| | 80% of Time - 1 value (%). |

(ii) Impact Criteria

This section provides greater detail concerning impact criteria as applied to unit-divided loads for the purpose of load searches.

For the same reason as described above for the load characteristic criteria, the impact criteria specified above for searches involving static load division are not applicable during searches involving dynamic load division, including unit-divided load searches. Also, for unit-divided load searches, the impact criteria are applicable to the resulting loads of two ESPs or an ESP and a customer or aggregator.

For a retail load search, the ESP is considered the “prime load” and the customer or aggregate load is the “target load.” During an optimization load search, the “prime load” and “target load” are both ESP loads.

The following is a list of the impact criteria available for a request for a unit-divided load search:
Minimum Load Factor increase (%)

| | |
|---|---|
| Daily - prime load | 5 day type values; |
| Daily - target load | 5 day type values; and |
| For time period of search - prime load | 1 value; and |
| For time period of search - target load | 1 value; |

Minimum Integral Multiple Factor Increase (%):

| | |
|---|---|
| Daily - prime load | 5 day type values; |
| Daily - target load | 5 day type values; and |
| For time period of search - prime load | 1 value; and |
| For time period of search - target load | 1 value; |

Minimum Units Received (smallest acceptable number of units to be received by prime load and target load as a result of a proposed trade of a unit-divided load.)

| | |
|---|---|
| For prime load | 1 value; and |
| For target load | 1 value. |

(iii) Unit Division Process-Overview

This section provides an overview of the load search process as applied to unit-divided loads. That load search process involves finding loads that can be subjected to load-shifting in such a manner that the discrete and impact criteria established for the search are satisfied.

Five methods of load-shifting are defined in this section, one in each of five subparts as follows:

III.B.1(b)(iii)(A)—LF/LF Method;

III.B.1(b)(iii)(B)—IMF/LF Method;

III.B.1(b)(iii)(C)—LF/IMF Method;

III.B.1(b)(iii)(D)—LF Method; and

III.B.1(b)(iii)(E)—IMF Method.

Before the impact criteria can be applied, certain additional parameters must be set in order to enable unit-divided load searches. Those parameters determine the applicability and priority of the appropriate indicators of efficiency in energy usage.

A unit-divided load search involves manipulating the interval load data interval by interval for both the load of the exchange user requesting the search and the load being evaluated during the search. Since both loads are being modified during the load search process, this process is a form of dynamic load division. With the interval load data being modified dynamically, the impacts on both the prime load and target load need to be evaluated on the basis of whether the benefits of load shifting (“load impact benefits”) are to be shared or not. The significance of shared load impact benefits is greater for the implementation of an optimization load search since load can be moved to or from both the prime load and the target load. For a retail load search, there are load impact benefits to the prime (ESP) load, and there may be load impact benefits to the target (customer) load, but such benefits are achieved only by moving load from the target load of the customer to the prime load of the ESP. Therefore, since unit division can be implemented to the greatest extent during an optimization load search, the unit division techniques will be described from this perspective with the modifications necessary for a retail load search stated as exceptions.

Five methods of load-shifting applicable to unit-divided loads will be described. Three of those methods consider the sharing of load impact benefits. The other two methods assume that the load impact benefits are intentionally created only for the prime load.

The methods with shared load impact benefits are:

Load factor/load factor method (“LF/LF method”);

I.M.F/load factor method (“IMF/LF method”); and

Load factor/I.M.F. method (“LF/IMF method”).

The methods without shared load impact benefits are:

Load factor method (“LF method”); and

I.M.F method (“IMF method”).

(A) LF/LF Method: This method considers the load factors of the prime load and target load and makes no shifts in loads between the prime load and the target load unless the shifts improve the load factors of both the prime load and target load. Load shifts could go in either direction, except where a customer load is the target load. In such cases, the load shifts could only go from the target load (customer) to the prime load (ESP), since load can not be transferred to customers.

(B) IMF/LF Method: This method considers the integral multiple factor of the prime load and the load factor of the target load and makes no shifts in loads that do not improve both the integral multiple factor of the prime load and the load factor of the target load. Shifts in load will only be from the target load to the prime load.

(C) LF/IMF Method: This method considers the load factor of the prime load and the integral multiple factor of the target load and makes no shift in loads that do not improve the load factor of the prime load and the integral multiple factor of the target load. Shifts in load will only be from the prime load to the target load. The LF/IMF method is not valid for a retail load search since available capacity, the basis for integral multiple factor, is not applicable to customer loads.

(D) LF Method: This method considers the load factor of the prime load and makes all shifts in load that improve such load factor without regard to effect upon the target load. Where the target load is a customer load, the load shifts could only go from the target load (customer) to the prime load (ESP) since load can not be transferred to customers.

(E) IMF Method: This method considers the integral multiple factor of the prime load and makes all shifts in load that improve such integral multiple factor without regard of effect upon the target load. Shifts in load will only be from the target load to the prime load.

The sharing and non-sharing methods above are not the only possible ones. Shifting of less than all load consistent with impact criteria could be effected rather than shifting all load consistent with impact criteria as indicated in the methods above. Also, other appropriate indicators of efficiency in energy usage (or combinations thereof) could be used.

(iv) Unit Division Process in Detail

This section provides greater detail concerning the load search process as applied to unit-divided loads. In this section, the operation of the five methods of load-shifting is described.

This section includes five subparts, one for the operational descriptions of each of the five load-shifting methods, as follows:
III.B.1(b)(iv)(A)—LF/LF Method;
III.B.1(b)(iv)(B)—IMF/LF Method;
III.B.1(b)(iv)(C)—LF/IMF Method;
III.B.1(b)(iv)(D)—LF Method; and
III.B.1(b)(iv)(E)—IMF Method.

The steps for implementing each of the defined methods are detailed below.

(A) LF/LF Method
Step 1: Calculate average demand for each of the prime load and target load.
Step 2: For each interval, calculate the number of whole units (of demand) in excess of (“excess units”) or less than (“deficit units”) the average demand (in units) for each of the prime load and target loads.
Step 3: Utilize the following defined conditions in the steps that follow:
   Condition A: Deficit units in prime load and excess units in target load;
   Condition B: Excess units in prime load and deficit units in target load;
   Condition C: Deficit units in prime load and deficit units in target load;
   Condition D: Excess units in prime load and excess units in target load; and
   Condition E: No excess units or no deficit units in either or both of prime load or target load.
Step 4: For each interval, determine which of conditions A, B, C, D, or E apply.
Step 5: If any of conditions C, D, or E applies, take no action.
Step 6: If condition A applies, propose a shift of the number of whole units from the target load to the prime load equal to the lesser of (i) the number of deficit units in the prime load and (ii) the number of excess units in the target load.
Step 7: If condition B applies and the target load is a customer load, take no action,
Step 8: If condition B applies and the target load is an ESP load, propose a shift of the number of whole units from the prime load to the target load equal to the lesser of (i) the number of deficit units in the target load and (ii) the number of excess units in the prime load.

(B) IMF/LF Method
Step 1: Utilize the following defined conditions in the steps that follow:
   Condition A: Prime load is lower than the capacity available to serve that load by an amount equal to or greater then one unit;
   Condition B: Prime load is higher than or equal to the capacity available to serve that load or is lower than the capacity available to serve that load by an amount less than one unit.
   Condition C: Target load is greater than the average demand of that load by amount equal to or greater than one unit; and
   Condition D: Target load is equal to or less than the average demand of that load or is greater than the average demand of that load by less than one unit.
Step 2: Calculate the average demand for the target load.
Step 3: For each interval, determine which of conditions A, B, C, or D applies.
Step 4: For any interval for which either or both of conditions B or D applies, take no action.
Step 5: For any interval for which either condition A or C applies, but not both, take no action.
Step 6: For any interval for which both conditions A and C apply, propose a shift of the number of whole units from the target load to the prime load equal to the lesser of (i) the difference in number of units between the capacity available to serve the prime load and prime load and (ii) the difference in number of units between the target load and the average demand of the target load.

(C) LF/IMF Method

This method is not applicable where the target load is a customer load.
Step 1: Utilize the following defined conditions in the steps that follow:
   Condition A: Target load is lower than the capacity available to serve that load by an amount equal to or greater than one unit;
   Condition B: Target load is higher than or equal to the capacity available to serve that load or lower than the capacity available to serve that load by an amount less than one unit;
   Condition C: Prime load is greater than the average demand of that load by amount equal to or greater than one unit; and
   Condition D: Prime load is equal to or less than the average demand of that load or greater than average demand of that load by less than one unit
Step 2: Calculate the average demand for the prime load.
Step 3: For each interval, determine which of conditions A, B, C, or D applies.
Step 4: For each interval for which either or both of conditions B or D applies, take no action.
Step 5: For any interval for which either condition A or C applies, but not both, take no action.
Step 6: For any interval for which both conditions A and C apply, propose shift of the number of whole units from the prime load to the target load equal to the lesser of (i) the difference in number of energy units between the available capacity of the ESP with the target load and the target load and (ii) the difference in number of units between the prime load and the average demand of the prime load.

(D) LF Method
Step 1: Calculate the average demand for the prime load.
Step 2: Utilize the following defined conditions in the steps that follow:
   Condition A: Prime load is greater than the average demand of the prime load by an amount equal to or greater than one unit;
   Condition B: Prime load differs from the average demand of the prime load by less than one unit;
   Condition C: Prime load is less than the average demand of the prime load by an amount equal to or greater than one unit;
   Condition D: Target load is less than available capacity to the ESP with target load by an amount equal to or greater than one unit; and
   Condition E: Target load is equal to or greater than available capacity to the ESP with target load or less than available capacity to ESP with target load by an amount less than one unit.
Step 3: For each interval, determine which of conditions A, B, C, D, and E apply.
Step 4: For each interval in which condition E applies, take no action.
Step 5: For each interval in which condition B applies, take no action.
Step 6: For each interval for which both conditions A and D apply and the target load is a customer load, take no action.
Step 7: For each interval for which both conditions A and D apply and the target load is an ESP load, propose a shift of the number of whole units from the prime load to the target load equal to lesser of (i) the difference in number of units between the actual demand and the average demand of the prime load and (ii) the difference in number of units between the available capacity of the ESP with the target load and the actual target load.
Step 8: For any interval for which conditions C and D apply, propose a shift of the number of whole units from the target load to the prime load equal to the lesser of (i) the difference between the average demand and the actual demand of the prime load and (ii) the actual target load.

(E) IMF Method
Step 1: Utilize the following defined conditions in the steps that follow:
   Condition A: Prime load is lower than the available capacity of the ESP with the prime load by an amount equal to or greater than one unit; and
   Condition B: Prime load is equal or higher than the available capacity of the ESP with the prime load or is lower than available capacity of the ESP with the prime load by an amount less than one unit.
Step 2: For each interval, determine which of conditions A or B applies.
Step 3: For each interval for which condition B applies, take no action.
Step 4: For each interval for which condition A applies, propose a shift of the number of whole units from the target load to the prime load equal to the lesser of (i) the difference between the available capacity of the ESP with the prime load and actual demand of the prime load and (ii) the actual target load.
(Note: None of the five methods of load shifting ever suggests that a prime load or a target load ever receive units if the effect of such receipt would be to cause the prime load or target load to exceed the capacity available to serve those loads.)

(v) Note on Interval Load Data

In the discussion of unit-divided load searches above, there are numerous references to interval load data. The direct use of raw interval load data to create proposals for exchange trades involving unit-divided loads may be impractical. Such direct use of interval load data together with the methods for load shifting described above would propose exchange trade involving each interval (perhaps as small as 15 or even five minutes) of each day for the time period of search. Such a proposal would be commercially unfeasible.

The problem described may be solved as follows. By examining raw interval load data, it is possible to determine whether the underlying load varied materially month to month or season by season or, though unlikely, did not vary materially over the course of a year. The exchange user would then determine to create a form of “normalized” interval load data comprised, for example, of average daily interval load data for each month of the year, with an interval duration of one hour for a time period of search of one year's duration. The Load search engine would the operate on seven average day's (Sunday through Saturday) interval load data (perhaps, 24 or 48 intervals per day) for each of 12 months.

A proposed exchange trade would then take the form of a proposal for load-shifting for each of 24 or 48 intervals, for each of seven average days, for each of 12 months. A proposal in that form would be quite practical from a commercial standpoint. ESPs are dealing on a daily basis with loads expressed in hourly intervals or half-hourly intervals in the context of wholesale transactions, retail supply transactions, and load-balancing requirements. A further reduction of data could be achieved by using five average day types instead of seven average days and by relying upon four seasonal variations rather than twelve monthly variations.

The system could easily create average daily interval load data either by applying a simple averaging method or more sophisticated statistical techniques. Accordingly, the term “interval load data,” when used in reference to unit-divided load searches, unit-divided load trading, and price searches for exchange trades involving unit-divided loads, refers to normalized interval load data as discussed here.

2. Price Search Criteria

Price searches are performed by comparing the discrete criteria and impact criteria specified to information in the appropriate exchange database, including the data stored in the trade history tables and the load identification information. Price searches, whether based upon discrete criteria or impact criteria or both, do not utilize interval load data. A price search operates on load identification information and the trade history tables in the appropriate exchange database or exchange databases.

(a) Whole Loads. Functionally—Divided Loads, and Practically-Divided Loads

This section provides greater detail concerning price search criteria as applied to exchange trades involving whole loads, functionally-divided loans, and practically-divided loads for the purpose of price searches.

This section includes three subparts as follows:
III.B.2(a)(i)—Trade and Pricing Information;
III.B.2(a)(ii)—Discrete Criteria; and
III.B.2(a)(iii)—Impact Criteria.

Each of these subparts contains subparts that have been separately titled to aid reading.

(i) Trade History Tables

This section provides greater detail concerning the information about exchange trades involving whole loads, functionally-divided loads, or practically-divided loads stored by the system in the trade history tables for the purpose of enabling price searches.

This section includes three subparts as follows:
III.B.2(a)(i)(A)—Trade and Pricing Information;
III.B.2(a)(i)(B)—Load Characteristic Information; and
III.B.2(a)(i)(C)—Load Impact Values.

The trade history tables consist of (i) trade and pricing information, (ii) load characteristic information, and (iii) load impact values. All information is stored when the exchange trade is consummated.

(A) Trade and Pricing Information

The trade and pricing information stored in the trade history tables includes:
Date of the exchange trade;
Time period of search;
Prices and charges for the various standard energy billing quantities including, but not limited to, consumption, demand load factor, service type, and facilities;
Trading terms;
Customer instructions;
Customer interval load data;
ESP interval load data before and after the exchange trade; and
ESP capacity interval data.

(B) Load Characteristic Information

The load characteristic information is calculated for the time period of search for the search that preceded the exchange trade and was stored in the trade history tables. The load characteristic information includes:
Maximum Hourly Demand (maximum hourly usage time period of search);
Average Hourly Demand (sum of hourly usage values divided by number of hours, time period of search);
Maximum Interval Demand (maximum interval value multiplied by the intervals per hour, for time period of search); and
Load Duration Values (% of maximum demand for 20, 40, 60, and 80% of time, for time period of search).

(C) Load Impact Values

The load impact values are calculated for the original ESP load and for the load resulting from the merger of the interval load data for the ESP load with the interval load data of the acquired customer load. Each load impact value will have a before and after value calculated over the time period of search for the search that preceded the exchange trade. These before and after load impact values are stored in the trade history tables. Following is a list of the load impact values:
Load factor before and after (time period of search);
Integral multiple factor before and after (time period of search);
Maximum demand with date/time before and after (for time period of search); and
Load Duration Values before and after (% of maximum demand for 20, 40, 60, and 80% of time for time period of search).

(ii) Discrete Criteria

This section provides greater detail concerning discrete criteria as applied to exchange trades involving whole loads, functionally-divided loads, and practically-divided loads for the purpose of price searches.

This section includes two subparts as follows:
III.B.2(a)(ii)(A)—Load Identification Criteria; and
III.B.2(a)(ii)B)—Load Characteristic Criteria.

The discrete criteria are divided into two subclasses: load identification criteria and load characteristic criteria. The following is a list of the discrete criteria by category.

(A) Load Identification Criteria
Customer ID;
Load ID;
Service area;
SIC Code;
Energy charge ($/unit), high—1 value; and
low—1 value;
Demand charge ($/unit), high—1 value; and
low—1 value;
Service types; and
Time period of search; and

(B) Load Characteristic Criteria
Minimum load factor (%):
   For time period of search—1 value;
Maximum hourly demand range:
   For time period of search, high—1 value; and
   low—1 value;
Average hourly demand range:
   For time period of search, high—1 value; and
   low—1 value;
Maximum interval demand range:
   For time period of search, high—1 value; and
   low—1 value; and
Minimum load duration values (% of maximum demand):
   For time period of search 20% of time—1 value;
   40% of time—1 value;
   60% of time—1 value; and
   80% of time—1 value.

(iii) Impact Criteria

This section provides greater detail concerning impact criteria as applied to exchange trades involving whole loads, functionally-divided loads, and practically-divided loads for the purpose of price searches.

This section includes two subparts as follows:
III.B.2(a)(iii)(A)—Resulting Load Impact Values Increases; and
III.B.2(a)(iii)(B)—Resulting Load Impact Value Decreases.

The following is a list of the impact criteria. All impact criteria require that load impact value changes be calculated from the before and after load impact values stored in the trading history tables of the appropriate exchange database. Depending of whether the load impact values increase or decrease, the impact criteria need to be specified differently. Therefore, both a minimum increase and a maximum decrease will be accepted for each of the impact criteria in a price search request:

(A) Resulting Load Impact Value Increases

Minimum increases for:
load factor;
integral multiple factor; and
load duration values (% of maximum demand for 20, 40, 60, & 80% of time); and

(B) Resulting Load Impact Value Decreases

Maximum decreases for:
load factor;
integral multiple factor; and
load duration values (% of maximum demand for 20, 40, 60, & 80% of time).

(b) Unit-Divided Loads

This section provides greater detail concerning price search criteria as applied to exchange trades involving unit-divided loads for the purpose of price searches.

This section includes three subparts as follows:
III.B.2(b)(i)—Trade History Tables;
III.B.2(b)(ii)—Discrete Criteria; and
III.B.2(b)(iii)—Impact Criteria.

The first two of those subparts contain subparts that have been separately titled to aid reading.

(i) Trade History Tables

This section provides greater detail concerning the information about exchange trades involving unit-divided loads stored by the system in the trade history tables for the purpose of enabling price searches.

This section includes three subparts as follows:
III.B.2(b)(i)(A)—Trade and Pricing Information;
III.B.2(b)(i)(B)—Load Characteric Information; and
III.B.2(b)(i)(C)—Load Impact Values.

The trade history tables consist of the same types of information as described above in the earlier discussion of trade history tables.

(A) Trade and Pricing Information

In addition to the items listed above in relation to trade and pricing information for price searches for exchange trades involving whole loads, functionally-divided loads, and practically-divided loads, the following additional items will also be stored as trade and pricing information in the trade history tables:
Method of load-shifting applied to unit-divided loads; and
Unit size.

(B) Load Characteristic Information

The load characteristic information calculated and stored in the trade history tables is the same as was itemized above in relation to load identification criteria for price searches for exchange trades involving whole loads, functionally-divided loads, and practically-divided loads.

(C) Load Impact Values

The load impact values consist of the items listed above in relation to load impact values for price searches and also include the following items:
Unit Division Statistics (units transferred to prime load by interval; total units transferred to prime load; units transferred to target load by interval; and total units transferred to target load);
For the prime load:
   Load factor, before and after;
   Maximum demand with date/time, before and after;
   Load duration values, before and after; and
   Integral multiple factor, before and after; and
For the target load:
   Load factor, before and after;
   Maximum demand with date/time, before and after;
   Load duration values, before and after; and
   Integral multiple factor, before and after (if target load is an ESP load).

(ii) Discrete Criteria

This section provides greater detail concerning discrete criteria as applied to exchange trades involving unit-divided loads for the purpose of price searches.

This section includes two subparts as follows:
III.B.2(b)(ii)(A)—Load identification Criteria; and
III.B.2(b)(ii)(B)—Load Characteristic Criteria.

The same two subclasses of criteria previously referred to in relation to price searches for exchange trades involving whole loads, functionally-divided loads, and practically-divided loads apply to price searches for exchange trades involving unit-divided loads.

(A) Load Identification Criteria
The load identification criteria applicable to exchange trades involving unit-divided loads are the same as those described above in relation to load identification criteria for price searches for exchange trades involving whole loads, functionally-divided loads, and practically-divided loads.

(B) Load Characteristic Criteria
Maximum load factor (%):
   For time period of search—1 value; and
Maximum load duration values (% of maximum demand):
   For time period of search—20% of time—1 value;
   40% of time—1 value;
   60% of time—1 value; and
   80% of time—1 value.

(iii) Impact Criteria

The following is a list of the impact criteria applicable to price searches for exchange trades involving unit-divided loads. The impact criteria require that load impact value changes be calculated from the before and after load impact values stored in the trading history tables. The criteria are:
Minimum load factor increase (%):

| | |
|---|---|
| For time period of search | prime load - 1 value; and |
| For time period of search | target load - 1 value; |

Minimum integral multiple factor increase (%):

| | |
|---|---|
| For time period of search | prime load - 1 value; and |
| For time period of search | target load - 1 value; and |

Minimum units received

| | |
|---|---|
| For prime load | 1 value; and |
| For target load | 1 value. |

(Note: Target Load Value Applies is Only to Optimization Load Searches.)

C. Load Search System

This section provides greater detail concerning the operation of the load search system. The section describes how the load search system carries out the three types of load searches.

This section includes three subparts, one for each of the three types of load searches, as follows:
III.C.1—Retail Customer Load Searches;
III.C.2—Retail ESP Load Searches; and
III.C.3—Optimization Load Searches.

Each of the three subparts deals with the general case (load searches involving whole loads, functionally-divided loads, and practically-divided loads) and the special case (load searches involving unit-divided loads).

This section also considers:
autonomous load searches;
customer load searches;
local load searches;
network load searches;
retail load searches; and
optimization load searches.

The load search system of a particular exchange node is capable of receiving load search requests from exchange users. A load search begins with the exchange node's presenting the exchange user with data entry screens, load search request screens.

An autonomous search is assumed by the load search system, and, accordingly, the discrete criteria and impact criteria are set to the default criteria resident in the exchange database for the exchange user. The exchange node operator sets the default discrete criteria and default impact criteria in the exchange database on an exchange user by exchange user basis. If a custom load search is desired, then the exchange user can override any of the default discrete criteria and default impact criteria. The exchange user can specify that only the exchange database of the exchange node to which the exchange user is connected is to be searched (local search) or that the load search request is to be extended to the exchange databases of other exchange nodes (network search). Also, using the customer ID field, the exchange user has the option of specifying whether customer loads or ESP loads are to be searched. Individual customer IDs or ESP IDs can also be entered, if access thereto is provided.

The load search system can also handle load search requests from other exchange nodes received by means of the inter-nodal communications handler. These load search requests will include the load search criteria for the loads to be searched.

If the load search is also to be performed outside of the exchange database of the concerned exchange node, the complete load search request is sent to the inter-nodal communications handler for routing to the other exchange nodes.

If the exchange user is an ESP and an optimization load search request is made, then the optimization load search engine is invoked. The inputs to the optimization lead search engine are discrete criteria and impact criteria otherwise, the retail load search engine is used. The inputs to the retail load search engine are the discrete criteria and impact criteria along with a flag indicating whether a customer load search or an ESP load search is to be made. The load search system will wait for the appropriate load search engine to complete the search of the exchange database of the exchange node to which the exchange user is connected as well as receive any network load search results sent to the originating exchange node by other exchange nodes using the inter-nodal communications handler.

The load search results of the local load search and the network load search will be combined for return to the appropriate requesting exchange user. If the load search request originated from another exchange node, then the load search results are sent to the inter-nodal communications handler for transmission to the concerned exchange node. If an exchange user generated the load search request, then the load search results are returned to the man-machine interface for display to that exchange user. The load search system then waits for further load search requests.

A table display of the load search results is provided to the exchange user. The exchange user is provided with the ability to sort the table based on the various columns and scroll within the table in the case that there are more loads than can be displayed on a single screen. Printing of the information is also supported. The exchange user also has the option to request more detailed information on a load than is listed in the table. The exchange user can point and click on the load of interest, and a complete summary of the information on the load will then be provided along with graphing capabilities. The desired load as well as the before and after loads of the ESP can be graphed. Printing is also supported for the detailed display.

1. Retail Customer Load Searches

If a request is made for a customer load (retail customer load search), the retail load search engine is invoked.

(a) The General Case

For retail customer load searches, the following sequence of steps will be performed. Load identification information for a particular customer load will be retrieved from the exchange database, and a comparison of this load identification information is made to the load identification criteria specified in the retail customer load search request. If this comparison fails, the retail load search engine will then fetch the next customer load.

If the comparison passes, the normalized data for the customer load for the time period of search will be compared to the applicable load characteristic criteria specified in the discrete criteria. If this comparison fails, the retail load search engine will then fetch the next customer load.

If the comparison passes, the discrete load values for the customer load will be calculated from the interval load data for the customer load for the time period of search and compared to the load characteristic criteria specified in the load search request. If this comparison fails, the retail load search engine will then fetch the next customer load.

If the comparison passes, a check is made to determine whether a unit-divided load search is requested.

(b) The Special Case (Unit-Divided Loads)

If a unit-divided load search request is made, the variables necessary to perform a search of unit-divided loads and maintain the search results are initialized. The load of the exchange user (here, generally an ESP) requesting the search is considered the prime load and the customer loads searched are the target loads. The first interval of interval load data for the prime load and target load will be retrieved from the exchange database.

Based on the method of load-shifting specified for the prime load, the largest number of units that the ESP with the prime load could propose to obtain from the target (customer) load for the interval is calculated. If no units could be obtained, the next interval of interval load data for the prime load and target load is retrieved.

If the ESP with the prime load could obtain units from the target load for this interval, a calculation is performed on the interval load data for the target load based on the load-shifting method specified by the requesting ESP.

If the calculation on the target load results in units being available to the prime load, the exact number of units is determined. The unit division statistics and the resulting interval load data for the prime load and target load are updated. The next interval of interval load data for the prime load and target load will then be retrieved.

This process of retrieving intervals of interval load data will continue until all the intervals for the time period of search have been processed. After all the intervals have been processed, a check is made to verify that units are proposed to be transferred from the target load to the prime load and that the resulting prime load and target load meet the specified impact criteria. If the comparison fails, the retail load search engine will fetch the next target load.

If the comparison passes, customer ID information will be added to the qualified retail customer load list along with the load identification information, calculated discrete load values, unit division statistics, calculated load impact values, and interval load data for the target customer load. The retail load search engine will then fetch the next customer load. When all customer loads have been analyzed, the retail load search engine will return the qualified customer load list and exit.

(c) Return to the General Case

If a unit-divided load search request was not made, the interval load data for the customer load for the time period of search will be merged with the interval load data of the load of the requesting ESP. The resulting interval load data will be used to calculate the load impact values for comparison to the impact criteria specified in the load search request. If this comparison fails, the retail load search engine will then fetch the next customer load.

If the comparison passes, the customer ID will be added to the qualified retail customer load list along with the load identification information and, for the time period of search, the calculated discrete load values, calculated load impact values, and the interval load data for the customer load. The retail load search engine will then fetch the next customer load.

This process of fetching customer loads and performing comparisons will continue until all customer loads have been analyzed. When all customer loads have been analyzed, the retail load search engine will return the qualified retail customer load list and exit.

2. Retail ESP Load Searches

(a) The General Case

For a retail ESP load search by a customer, the following actions will be taken. First, the customer's interval load data, for the time period of search, will be used to calculate the discrete load values that are not available in the normalized data of the customer load.

Next, the following sequence of steps will be performed. An ESP load will be retrieved from the exchange database, and the discrete criteria and impact criteria will be set to the default criteria for that ESP set in the exchange database by the exchange node operator.

Then, the customer's load identification information will be compared to the ESP's load identification criteria. If this comparison fails, the retail load search engine will then fetch the next ESP load.

If the comparison passes, the normalized data of the customer load for the time period of search will be compared to the ESP's load characteristic criteria. If this comparison fails, the retail load search engine will then fetch the next ESP load.

If the comparison passes, the calculated discrete load values for the customer load will be compared to the ESP's load characteristic criteria. If this comparison fails, the retail load search engine will then fetch the next ESP load.

If the comparison passes, a check is made to determine whether a unit-divided load search is requested.

(b) The Special Case (Unit-Divided Loads)

If a unit-divided load search request is made, the variables necessary to perform a search of unit-divided loads and maintain the search results are initialized. The ESP loads being searched are considered prime loads and the customer load is considered the target load. The first interval of interval load data for the prime load and target load will be retrieved from the exchange database.

Based on the method of load-shifting specified for the prime load, the largest number of units that the prime load could obtain from the target load for the interval is calculated. If no units could be transferred to the prime load, the next interval of interval load data for the prime load and target load is retrieved.

If the prime load could obtain units from the target load for this interval, a calculation is performed on the interval load data of the target load based on the load-shifting method specified by the ESP.

If the calculation on the target load results in units being available to the prime load, the exact number of units is determined. The unit division statistics and the resulting interval load data for the prime load and the target load are updated. The next interval of interval load data for the prime load and target load will be retrieved.

This process of retrieving intervals of interval load data will continue until all the intervals for the time period of search have been processed. After all the intervals have been processed, a check is made to verify that units are proposed to be transferred from the target load to the prime load and that the resulting prime load and target load meet the ESP's impact criteria. If the comparison fails, the retail load search engine will fetch the next ESP load.

If the comparison passes, the ESP ID will be added to the qualified retail ESP load list along with the load identification information, calculated discrete load values, unit division statistics, calculated impact values, and interval load data for the retail ESP load. The retail load search engine will then fetch the next ESP load.

When all ESP loads have been analyzed, the retail load search engine will return the qualified retail ESP load list and exit.

(c) Return to the General Case

If a unit-divided load search request is not made, the interval load data for the customer load for the time period of the search will be merged with the interval load data of the ESP load. The resulting interval load data will be used to calculate the load impact values for comparison to the ESP's default impact criteria. If this comparison fails, the retail load search engine will then fetch the next ESP load.

If the comparison passes, the ESP ID will be added to the qualified retail ESP load list along with the load identification information and, for the time period of search, the calculated discrete load values, calculated load impact values, and the ESP interval load data. The retail load search engine will then fetch the next ESP load.

This process of fetching ESP loads and performing comparisons will continue until all ESP loads have been analyzed. When ESP loads have been analyzed, the retail load search engine will return the qualified retail ESP load list and exit.

3. Optimization Load Searches

(a) The General Case

If an optimization load search request is made (by an ESP), then the optimization load search engine is invoked. The inputs to the optimization load search engine are the discrete criteria and impact criteria specified by the ESP requesting the optimization load search.

For an optimization load search, the following sequence of steps will be performed. An ESP load will be retrieved from the exchange database. If the ESP that has the ESP load that was retrieved from the exchange database has indicated that that ESP load is not available for shifting to other ESPs or if the ESP load retrieved from the exchange database is the load of the ESP requesting the optimization load search, then the optimization load search engine will then fetch the next ESP load.

If the ESP load is available, the normalized data for the ESP load for the time period of search specified in the discrete criteria will be compared the applicable load characteristic criteria. If this comparison fails, the optimization load search engine will then fetch the next ESP load.

If the comparison passes, the calculated discrete load values for the ESP load will be calculated from the interval load data for the ESP load for the time period of search and compared to the applicable load characteristic criteria. If this comparison fails, the optimization load search engine will then fetch the next ESP load.

If the comparison passes, a check is made to determine whether an optimization unit-divided load search was requested.

(b) The Special Case (Unit-Divided Loads)

If an optimization unit-divided load search request was made, then the variables necessary to perform the load-shifting and maintain the unit-divided load search results are initialized. The ESP load of the ESP requesting the search is considered the prime load, and the ESP loads searched are the target loads. The first interval of interval load data for the prime load and target load will be retrieved from the exchange database.

Based on the method of load-shifting specified by the ESP with for the prime load, the largest number of units that the prime load could obtain from or give to the target load for the interval is calculated. If no units could be transferred in either direction, the next interval of interval load data for the prime load and target load is retrieved.

If units could be shifted to or from the prime load for this interval, a calculation is performed on the interval load data of the target load based on the load-shifting method specified.

If the calculation on the target load indicates that units could be transferred to or from the target load, with the exact number of units and the direction of transfer is determined. The unit division statistics and the resulting interval load data for the prime load and the target load are updated. The next interval of interval load data for the prime load and target load will be retrieved.

This process of retrieving intervals of interval load data will continue until all the intervals for the time period of search requested have been processed. After all the intervals have been processed, a check is made to verify that units are proposed to be exchanged and that the resulting prime load and target load meet the specified impact criteria. If the comparison fails, the optimization load search engine will fetch the next target load.

If the comparison passes, the ESP ID of the ESP with the target load will be added to the qualified optimization load list load list along with the load identification information, calculated discrete load values, unit division statistics, calculated load impact values, and interval load data for the target load. The optimization load search engine will then fetch the next target load.

When all ESP loads have been analyzed, the optimization load search engine will return the qualified optimization load list and exit.

(c) Return to the General Case

If an optimization unit-divided load search request was not made, the interval load data of the ESP load retrieved from the exchange database for the time period of search will be merged with the interval load data for the ESP load of the requesting ESP. The resulting interval load data will be used to calculate the load impact values for comparison to the impact criteria specified. If this comparison fails, the optimization load search engine will then fetch the next ESP load.

If the comparison passes, the ESP ID will be added to the qualified optimization load list along with the load identification information and, for the time period of search, the calculated discrete load values, calculated load impact values, and the interval load data for the ESP load. The optimization load search engine will then fetch the next ESP load.

This process of fetching ESP loads and performing comparisons will continue until all ESP loads have been analyzed. When all the ESP loads have been analyzed, the optimization load search engine will return the qualified optimization load list and exit.

D. Price Search Systems

This section provides greater detail concerning the price search systems and considers:
autonomous price searches;
a custom price searches;
local price searches;
network price searches;
retail price searches;
optimization price searches; and
the operation of the price search systems in carrying out the various types of price searches.

The price search systems are capable of receiving and responding to price search requests from exchange users. A price search begins with the price system's presenting the exchange user with a data entry screen.

An autonomous search is assumed by the price search system, and, therefore, the discrete criteria and impact criteria are set to the default search criteria resident in the exchange database of the exchange node to which the exchange user is connected. The exchange node operator sets the default discrete criteria and default impact criteria in the exchange database on an exchange user by exchange user basis. If a custom search is desired, then the exchange user can override any of the default discrete criteria and default impact criteria. The exchange user can specify whether only the exchange database of the exchange node to which the exchange user is connected is to be searched. Also, using the customer ID and ESP ID fields, the exchange user has the option to specify an individual customer or ESP of interest.

If the price search is also to be performed outside of the exchange database of the exchange node to which the exchange user is connected, the complete price search request is sent to the inter-nodal communications handler for routing to the other exchange nodes on the exchange network. The price search system can handle network price search requests received from other exchange nodes on the exchange network using the inter-nodal communication handler.

If an optimization price search has been requested, an optimization price search request, then the optimization pride search engine is invoked. Otherwise, trades between customers and ESPs are desired, and the retail price search engine is used. The exchange node will wait for the appropriate price search engine to complete the search of the exchange database as well as to receive any network price search results sent to the exchange node via the inter-nodal communications handler.

The local price search results and the network price search results will be combined for return to the appropriate requesting exchange user. If the price search request originated from an exchange user connected to another exchange node on the exchange network then the price search results are sent to the inter-nodal communications handler for transmission to the originating exchange node. If an exchange user made a local price search request then the local price search results are, returned to the man-machine interface for display to the exchange user. The price search system the waits for further price search requests.

A table display of information concerning exchange trades found during the price search is provided to the exchange users. The exchange user is provided with the ability to sort the table based on the various columns and scroll within the table in the case that there are more entries than can be displayed on a single screen. Printing of the information is also supported. The exchange user also has the option to request more detailed information on an entry than is listed in the table. The exchange user can point and click on the entry of interest and a complete summary of the information on the load will be provided along with graphing capabilities. The load involved in the exchange trade as well as the before and after loads of the participants in the exchange trade can be graphed if appropriate. Printing is also supported for the detail display.

If a retail price search request is made, then the retail price search engine is invoked. The inputs to the retail price search engine are the discrete criteria and impact criteria specified by the exchange user.

For retail price searches, the following sequence of steps will be performed. A retail trade will be retrieved from the trade history tables in the exchange database, and a comparison of the load identification information for the customer load involved in the retail trade stored in the trade history tables is made to the load identification criteria. Any exchange trades outside of the time period of search will be excluded. If the comparisons fail, the retail price search engine will then fetch the next retail trade.

If the comparison passes, the load characteristic information stored in the trade history tables is compared to the applicable load characteristic criteria. If this comparison fails, the retail price search engine will then fetch the next retail trade.

If the comparison passes, a check is made to see whether the retail price search request has specified impact criteria to be compared. If so and if the ESP involved in the retail trade has indicated in the relevant exchange database that load impact values are not to be disclosed, then the retail trade will be excluded from the price search. If the retail trade is to be excluded, the retail price search engine will then fetch the next retail trade.

If the retail trade can be considered, the load impact values for the ESP load stored in the trade history tables are compared to the impact criteria specified by the requesting exchange user. If this comparison fails, the retail price search engine will then fetch the next retail trade.

If the comparison passes, the customer ID will be added to the qualified retail trade list along with the following information: trade and pricing information, load identification information for the customer load, discrete load values for the customer load, load impact values with respect to the ESP load, and the interval load data for both the customer load and the ESP load. The retail price search engine will then fetch the next retail trade.

This process of fetching retail trades and performing comparisons will continue until there are no more retail trades to analyze. When there are no more retail trades to analyze, the retail price search engine will return the qualified retail trade list and exit.

If an optimization price search is requested, then the optimization price search engine is invoked. The inputs to the optimization price search engine are the discrete criteria and impact criteria specified by the requesting ESP.

For an optimization price search, the following sequence of steps will be performed. An optimization trade will be retrieved from the trade history tables in the exchange database. The load characteristic information stored in the trade history tables is compared to the applicable load characteristic criteria specified. If this comparison fails, the optimization price search engine will then fetch the next optimization trade.

If the comparison passes, a check is made to see whether the requesting ESP has specified that load impact values are to be compared to impact criteria. If so and if the ESP has indicated in the appropriate exchange database that load impact values are not to be disclosed, then the optimization trade will be excluded from the optimization price search. If the optimization trade is to be excluded, the optimization price search engine will then fetch the next optimization trade.

If the optimization trade can be considered, the load impact results stored in the trade history tables are compared to the impact criteria specified. If this comparison fails, the optimization price search engine will then fetch the next optimization trade.

If the comparison passes, the ESP ID will be added to the qualified optimization trade list along with the following information: trade and pricing information, offeror ESP's discrete load values, offeror-ESP's load impact values, and the offeror-ESP's and offeree ESP's interval load data. The optimization price search engine will then fetch the next optimization trade.

This process of fetching optimization trades and performing comparisons will continue until there are no more optimization trades to analyze. When there are no more optimization trades to analyze, the optimization price search engine will return the qualified optimization trade list and exit.

E. Trading Systems

This section provides greater detail concerning the trading systems and considers:
the operation of the trading systems;
the storage of information regarding exchange trades;
local trades;
network trades;
retail trades;
optimization trades; and
trading negotiation process.

Exchange trades can be proposed at any exchange node in the exchange network. The contracts administration manager of the exchange node receiving the proposed exchange trade handles the notification to the customer of the proposed exchange trade as well as the details of any resulting negotiations. When and if the proposed exchange trade is finalized, the exchange node(s) where the load(s) is (are) located will be notified of the exchange trade and provided with the trade and pricing information for the exchange trade. The trade and pricing information can then be stored in the trade tables of the exchange database of the exchange node where the load is registered.

When an exchange trade is proposed, the following sequence of steps will be performed. A determination is made of which loads involved in the exchange trade are local loads and which loads are registered on other exchange nodes of the exchange network (network loads).

For loads located on other exchange nodes, those exchange nodes are notified via the inter-nodal communications handler that an exchange trade is proposed. This notification will allow each exchange node to log the fact that an exchange trade is proposed for a load registered on that exchange node and to respond with a message acknowledging that the notification of the proposed exchange trade was received.

For local loads, the exchange node will log the proposed exchange trade in the trade history tables. Also, if a notification is received from another exchange node that an exchange trade is proposed for one of the local loads, the proposed exchange trade will be logged in the trade history tables. The remote exchange node is sent an acknowledgement indicating that the proposed exchange trade was recorded.

The exchange node receiving proposed exchange trade will then pass the request to the contracts administrations manager for presentation to the receiving exchange user. The proposing exchange user will then be notified that the proposed exchange trade is being processed.

The contracts administrations manager will wait for the customer's response and will forward the response to the proposing exchange user. If negotiations are required, the contracts administration manager will handle the negotiation process between the exchange users.

Upon completion of the exchange trade negotiations, a determination is made on which loads involved in the exchange trade are registered remotely and which loads are local loads. For the loads registered on other exchange nodes, each exchange node is notified as the whether the exchange trade was completed successfully. If the exchange trade was successful, the trade and pricing information for the exchange trade is also sent to the other exchange nodes. For the local loads, the trade history tables are updated to reflect the status of the exchange trade. If the exchange trade was not completed, the pending status is removed from the trade history tables. For a completed exchange trade, the trade history tables are updated with the trade and pricing information for the exchange trade.

### BRIEF DESCRIPTION OF THE DRAWINGS

FIG. 1 is a diagram of an electric power retail trading exchange network illustrating the basic arrangement of the present invention;

FIG. 2 is a more detailed diagram illustrating an exchange network in accordance with the embodiment of the invention;

FIG. 3 is a diagram illustrating one of the exchange nodes and databases of the system of FIG. 2;

FIGS. 4A-4C constitute a flow chart illustrating the operation of a load search operation performed in the exchange node of FIG. 3;

FIGS. 4D-4H illustrate the load search request screens for use in initiating a load search;

FIG. 4I illustrates a screen display of the result of a load search;

FIG. 4J is an illustration of a screen displaying in greater detail the information from the screen of FIG. 4I;

FIGS. 4K-4M illustrate the unit division load search request screens for use in initiating a unit division load search;

FIG. 4N is an illustration of a screen displaying unit division load search results;

FIG. 4O is an illustration of a screen displaying in greater detail the information from the screen of FIG. 4N;

FIGS. 5A-5F constitute a flow chart illustrating a retail load search as performed in the exchange node of FIG. 3;

FIGS. 6A-6D constitute a flow chart illustrating an optimization load search as performed in the exchange node of FIG. 3;

FIGS. 7A-7C constitute a flow chart illustrating a price search as performed in the exchange node of FIG. 3;

FIGS. 7D-7F illustrate the price search request screens for use in initiating a price search;

FIG. 7G illustrates a screen displaying the results of a price search results;

FIG. 7H is an illustration of a screen displaying in greater detail the information from the screen of FIG. 7G;

FIGS. 7I-7K illustrate the unit division price search request screens for use in initiating a unit division price search;

FIG. 7L is an illustration of a screen displaying unit division price search results;

FIG. 7M is an illustration of a screen displaying in greater detail the information from the screen of FIG. 7L;

FIGS. 8A-8B constitute a flow chart illustrating a retail price search as performed in the exchange node of FIG. 3;

FIGS. 9A-9B constitute a flow chart illustrating an optimization price search as performed in the exchange node of FIG. 3; and

FIGS. 10A and 10B constitute a flow chart illustrating the process for effecting local and network exchange trades.

### DESCRIPTION OF THE PREFERRED EMBODIMENTS

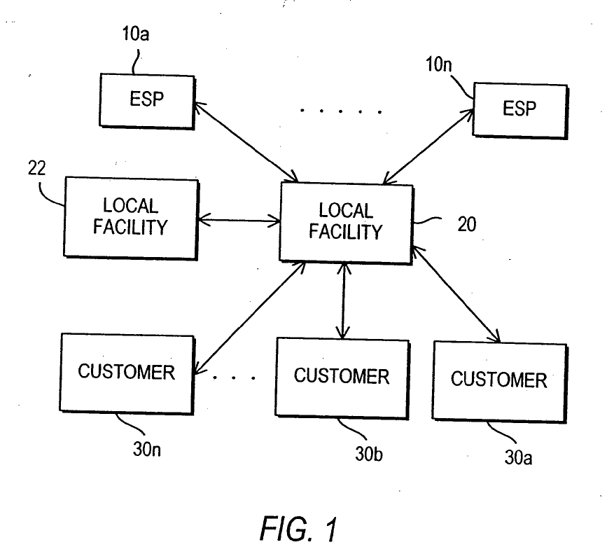

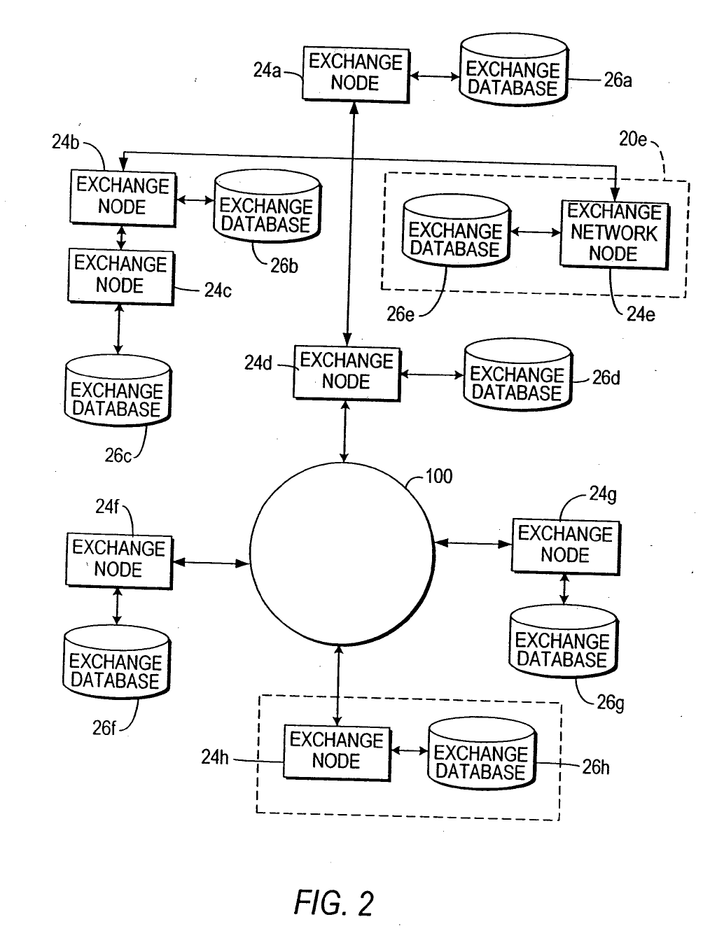

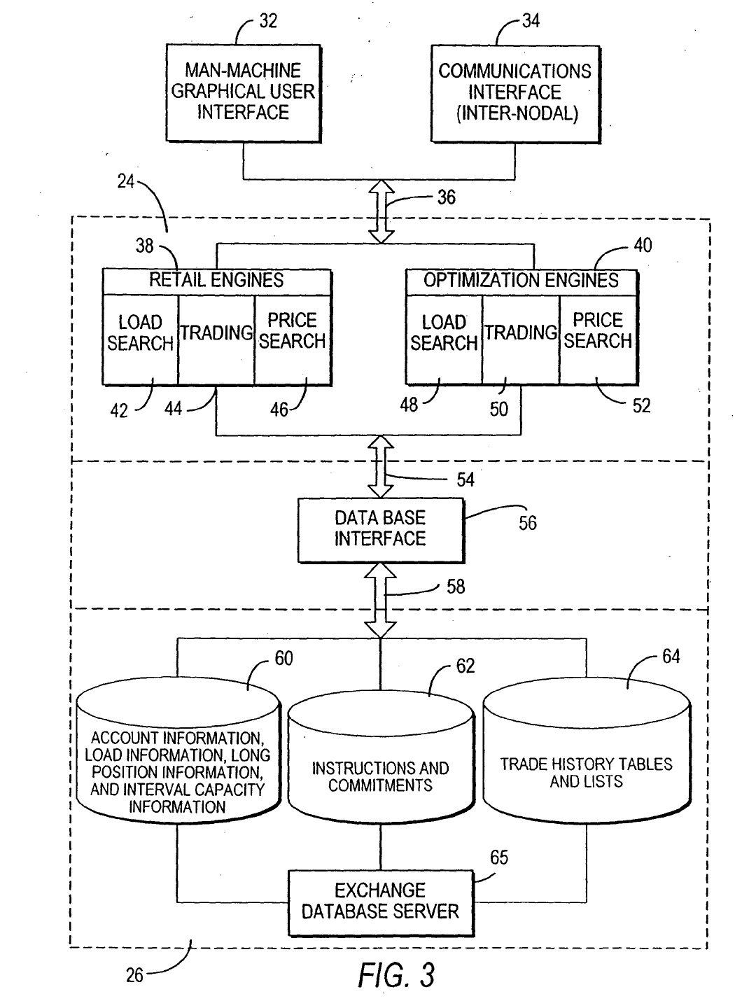

Referring now to the drawings, there is shown in FIG. 1 a schematic representation of a retail electric power exchange network illustrating the principles of the present invention. As therein shown, the network includes one or more ESPs 10a-10n, each of which is connected for two-way communication with one or more local facilities 20 that are described in greater detail below with particular reference to FIGS. 2 and 3. If desired, and as shown, local facility 20 may be distant from other local facilities and connected for two-way data communication with one or more other local facilities such as local facility 22. When two or more local facilities are thus utilized, an exchange network is created. Local facility 20 is also connected for two-way data communication with one or more users or Customers of electric power 30a-30n.

The exchange network illustrated in FIG. 2 includes eight exchange nodes, 24a-24h respectively, each connected to an exchange database 26a-26h. Local exchanges 24d and 24f-24h are connected in a network such as by a wide area network (WAN) 100 to communicate with one another along the network. The exchange nodes 24a-24h may alternatively be interconnected in any one of the conventional public or private communications facilities such as the Internet, value-added networks or a combination thereof. The exchange nodes 24 may, for example, consist of a mainframe computer, PC-based application server, file server with a processing workstation or a combination thereof. If desired, and as shown, one of the local exchanges, here local exchange 24b, may be connected to one or more other local exchanges, here shown as exchange 24c.

In order for the Exchange nodes 24 to function in an interconnected fashion to establish an exchange network, various architectural schemes, e.g., hierarchy, ring, star, bus or combinations thereof may be utilized to establish the necessary logical relationship of the Exchange nodes. Certain of these configurations, particularly the hierarchical ones, may affect the distribution of functionality and of information within the local facility 20. Four geographic areas are of relevance to a particular customer load. These include:

(i) the territory in which the customer load is located in the event geography is allocated to exchange nodes on an exclusive basis (“territory”);

(ii) in the absence of a territory, the service area of the exchange node at which the customer load is registered, in the event the service area is non-exclusive (“service area”);

(iii) the area encompassing the generation sources by which the customer load may be served (the “common generation service area”); and

(iv) the area encompassing the locations of all customer loads that can be served by the same generation sources as serve the particular customer load (the “common generation area”).

It should be understood that there is no necessary relationship between the territory and service area, on the one hand, and the geography of distribution or transmission systems on the other. Thus the foregoing four relevant geographic areas relate generally to network topology rather than to distribution or transmission topology.

An ESP load may include customer loads in more than one territory or service area that do not overlap, and customer loads within one territory or service area may be able to be served not only by generation sources within that territory or service area, but also by generation sources outside the territory or service area. An exchange user, ESP or customer, seeking additional customer loads is not limited to one territory, or service area, but can rather consider all customer loads within the same service generation service area. In the case in which two customer loads can be served by the same generation sources, but have different service generation service areas, the relevant area of search is defined by the exchange user.

When the service generation service area is the same as a territory or service area, the exchange user carries out searches and effects transactions associated with the territory or service area through one exchange node. When the service generation service area includes some or all of two or more territories or service areas, the exchange user carries out searches and effects transactions through more than one exchange node, or, in the case of a hierarchical network, a regional network exchange (RNX) or the national exchange (NatX).

The relevant customer loads and relevant generation sources are defined by the ESP separately with respect to each territory or service area as a part of the ESP subscription process and updated as circumstances change. It is here assumed that all customer loads in a given territory or service area are in each other's common generation service area. It is not, however, to be assumed that a territory or service area is coextensive with the common generation service of the customer load in that territory or service area.

Reference is now made to FIG. 3, which illustrates the configuration of one of the exchange nodes 24 in the exchange network illustrated in FIG. 2, it being understood that all of the exchange nodes in the exchange network are similarly configured. As therein illustrated, the exchange node 24 is connected via a two-way data communication link 36 to a graphical user interface or screen 32 and an internodal communications interface 34. Interface 32 may be, for example, a terminal of a PC or network of PCs or a workstation located with either an ESP or a customer at which load search criteria are entered.

The internodal communications interface 34 located at each exchange node allows each exchange node 24 to request a search of the data stored in the exchange databases 26 of the other exchange nodes in the exchange network. The exchange nodes 24, which handle search and transaction activities with respect to the loads respectively registered thereon, each include retail engines 38, which enable retail load and price searches to be carried out and retail trading to be effected between ESPs and customers as described below in greater detail, and optimization engines 40, which enable optimization load and price searches and optimization trading (between ESPs). The retail and optimization engines 38 and 40 respectively, each include one or more computers appropriately programmed to carry out the search functions described below. It is believed that the organization and programming of the search engine computers are both well within the ability of the average computer programmer so that no further description of the computers or programming software is provided herein.

Load Search Systems

Load Searches—Discrete Criteria

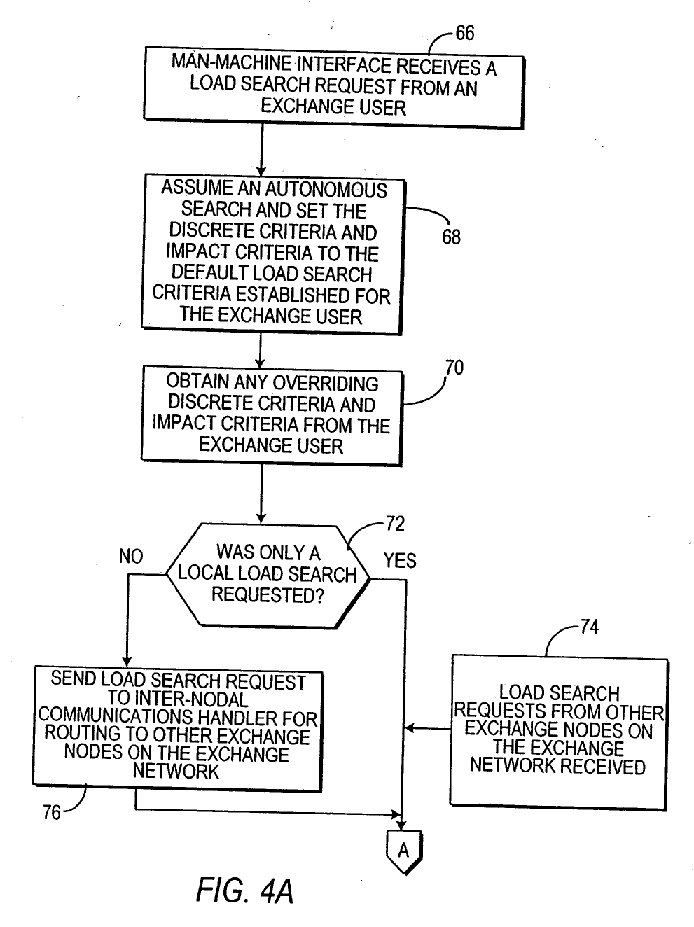

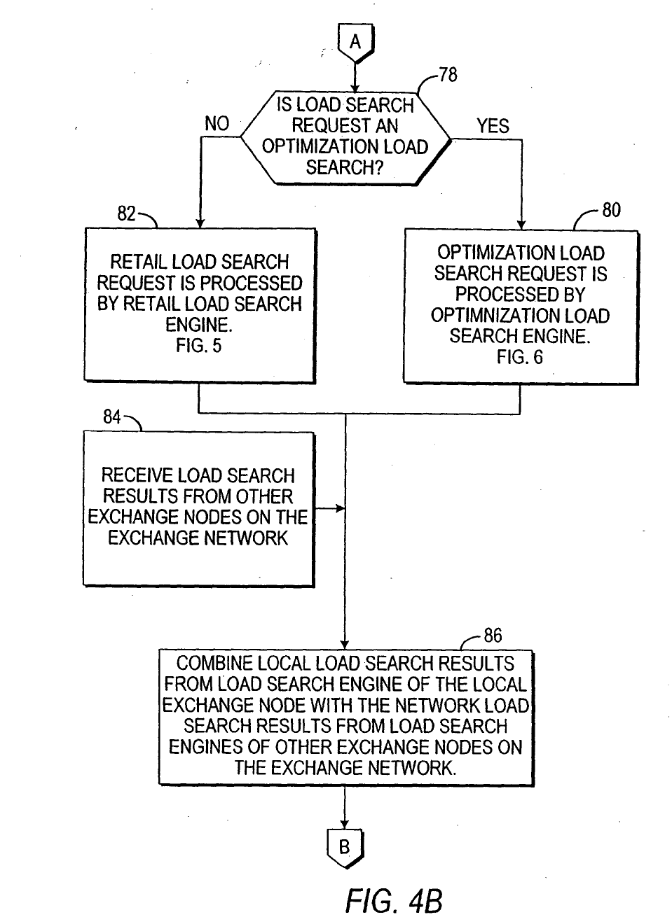

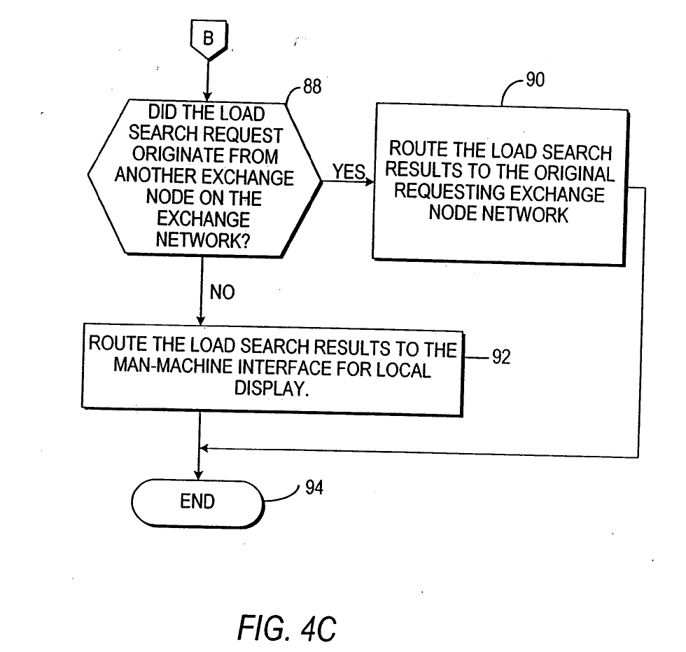

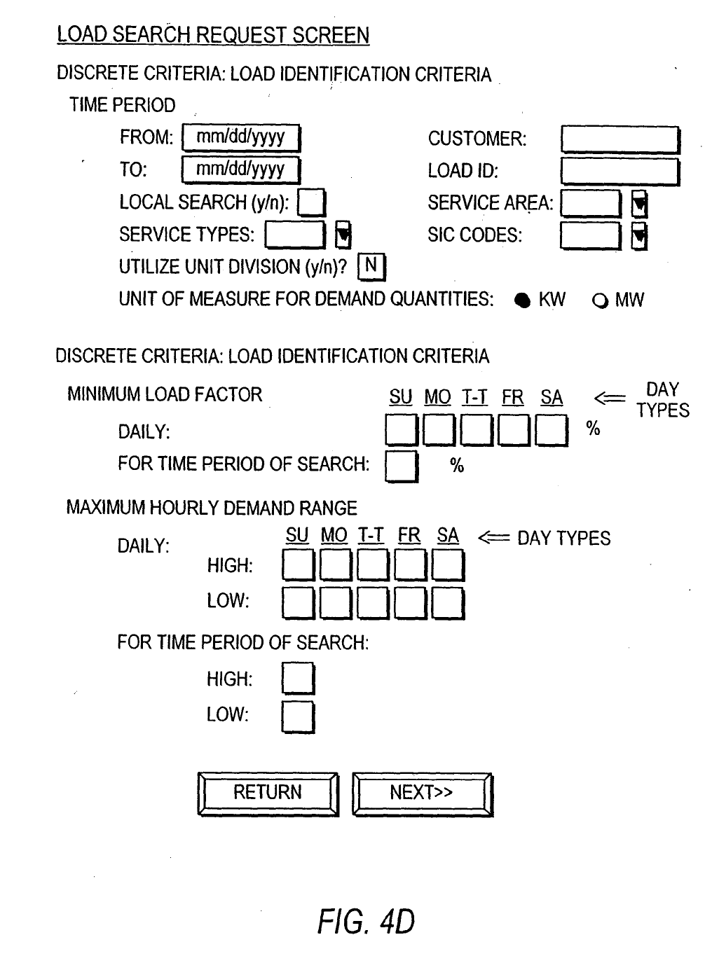

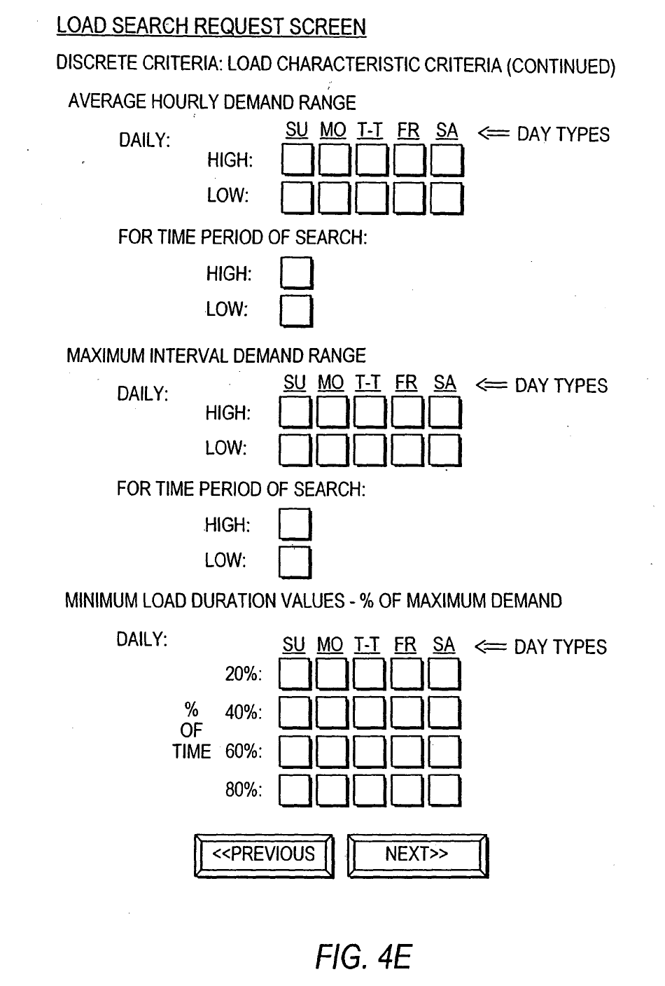

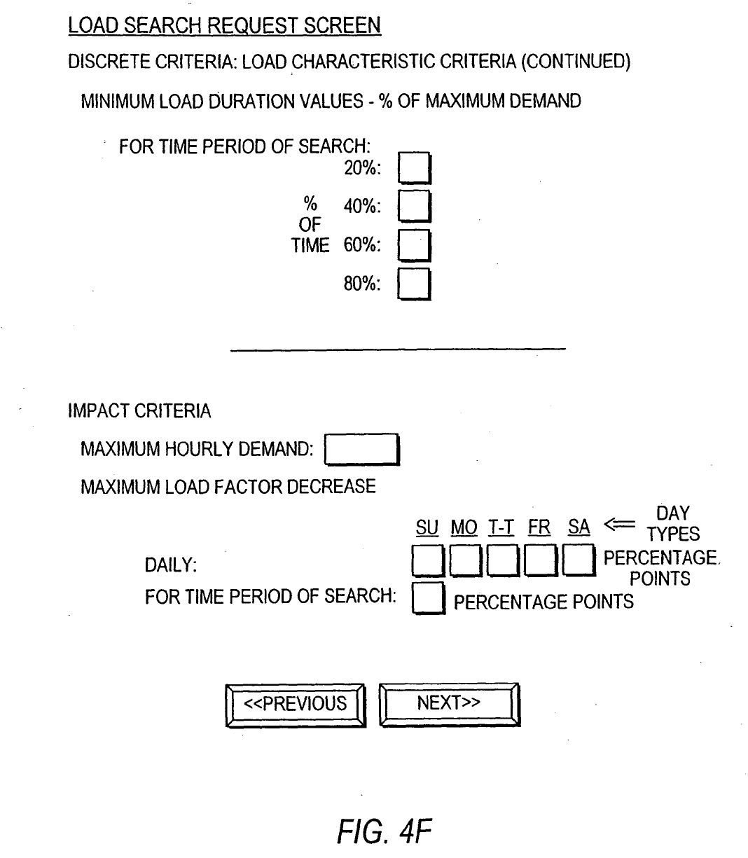

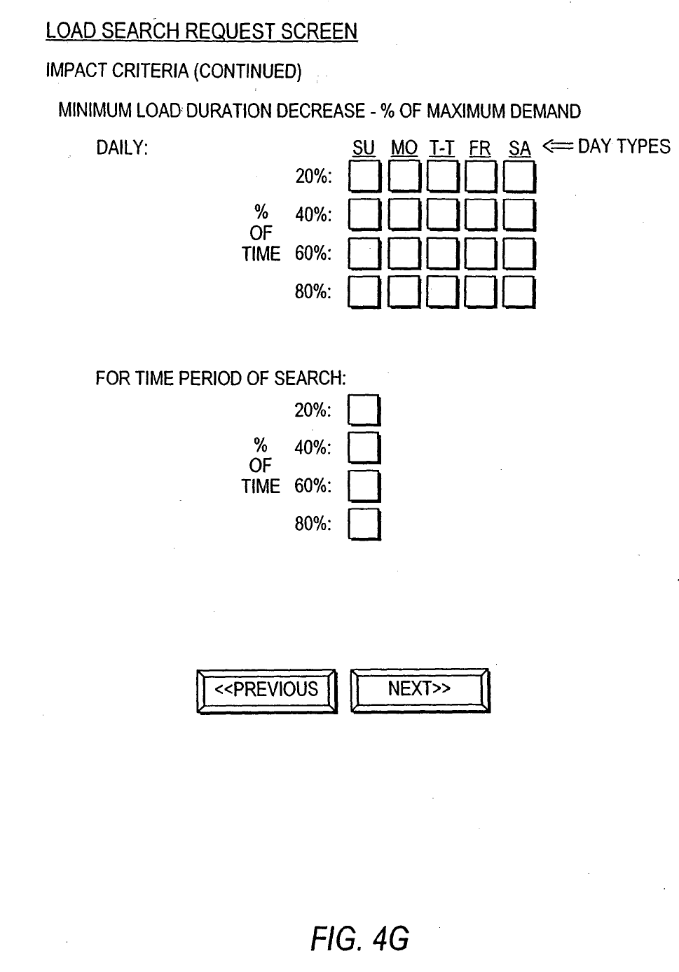

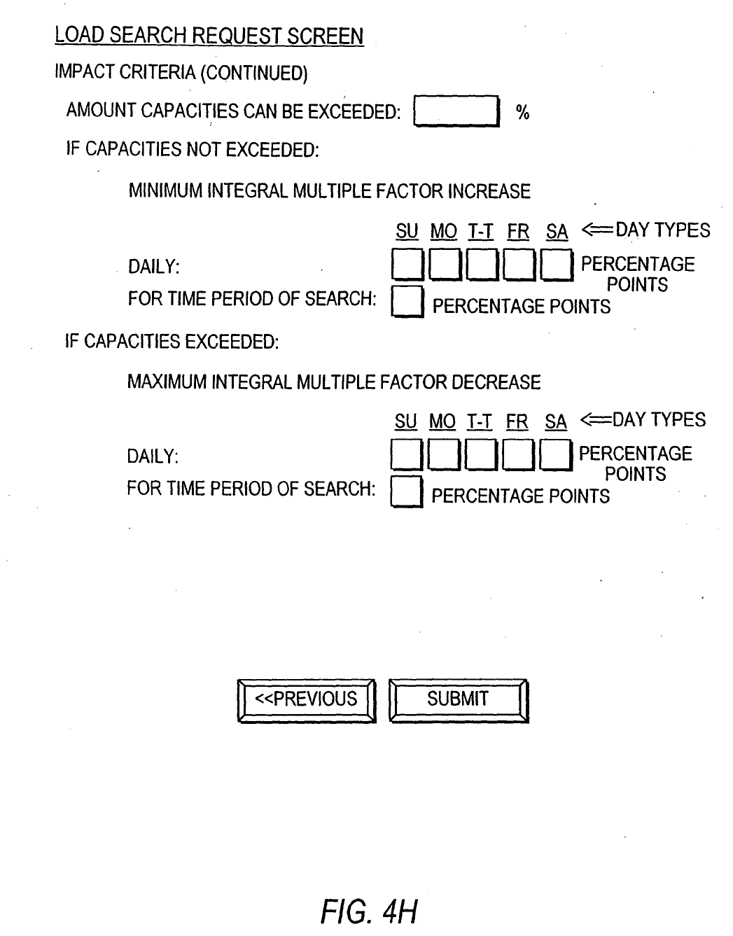

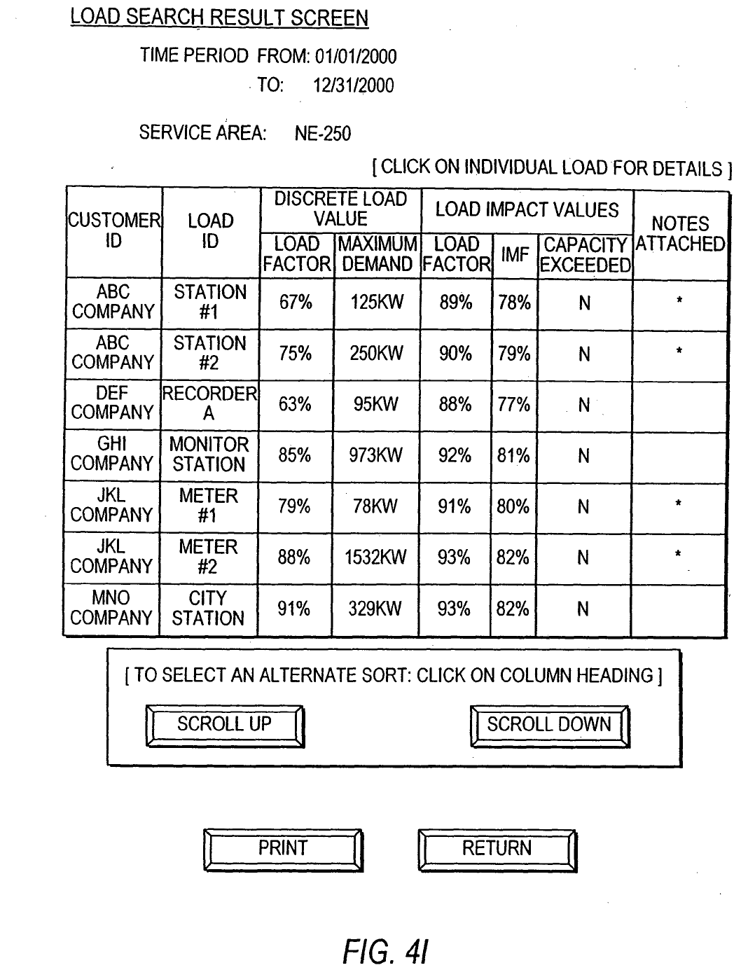

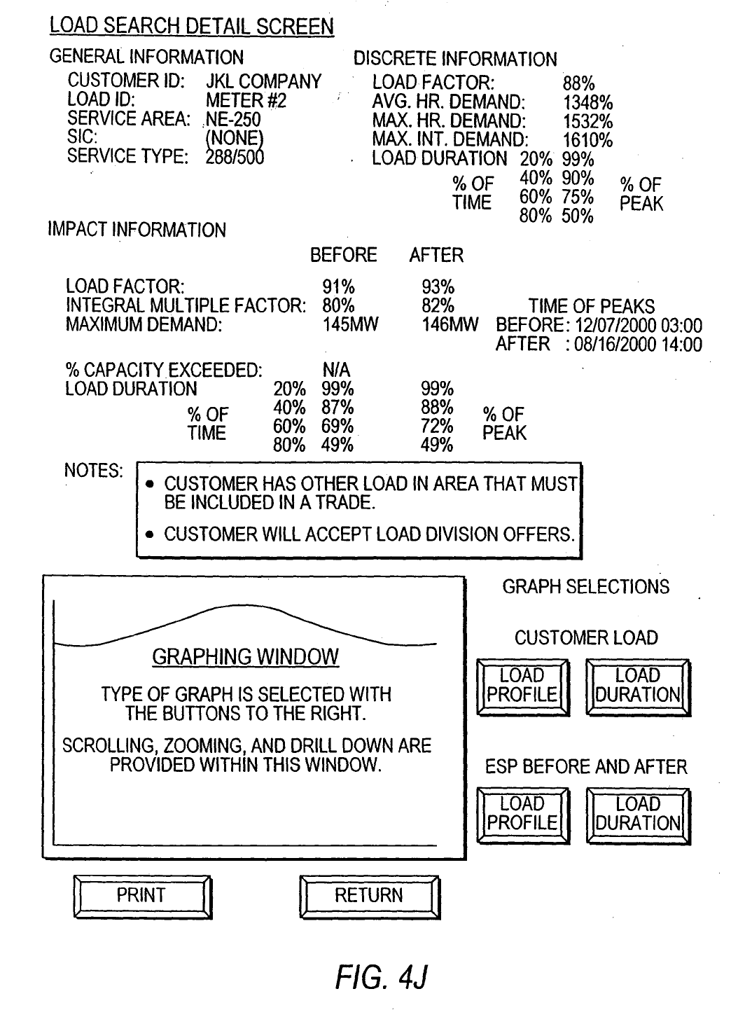

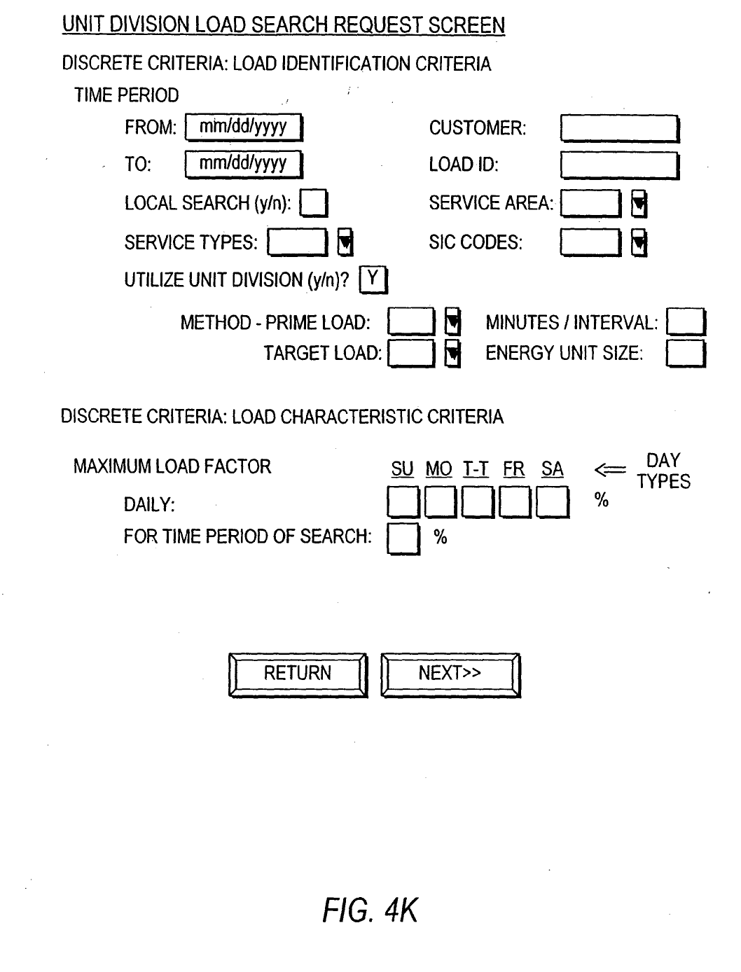

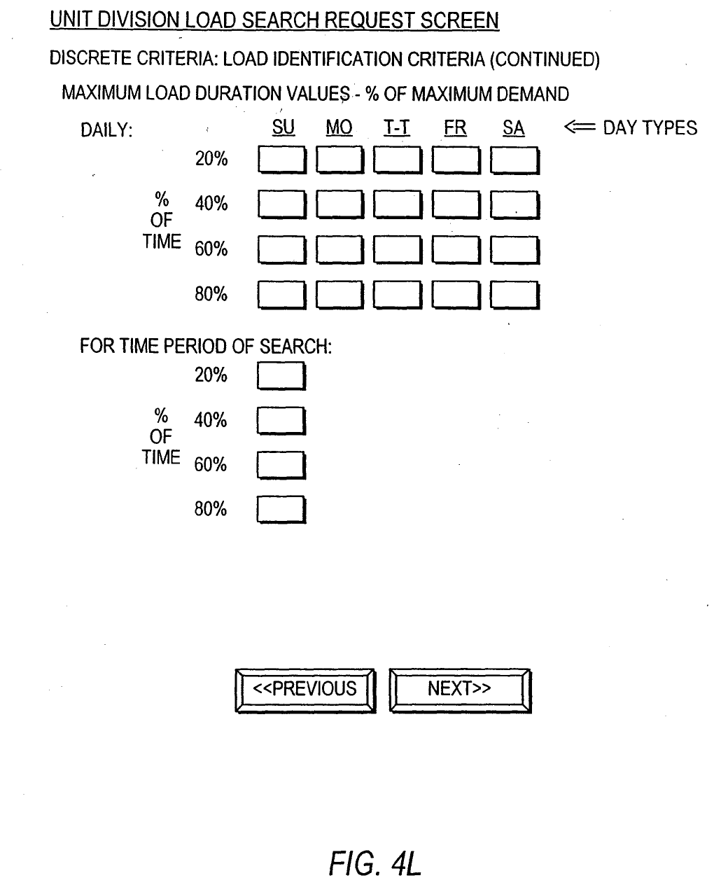

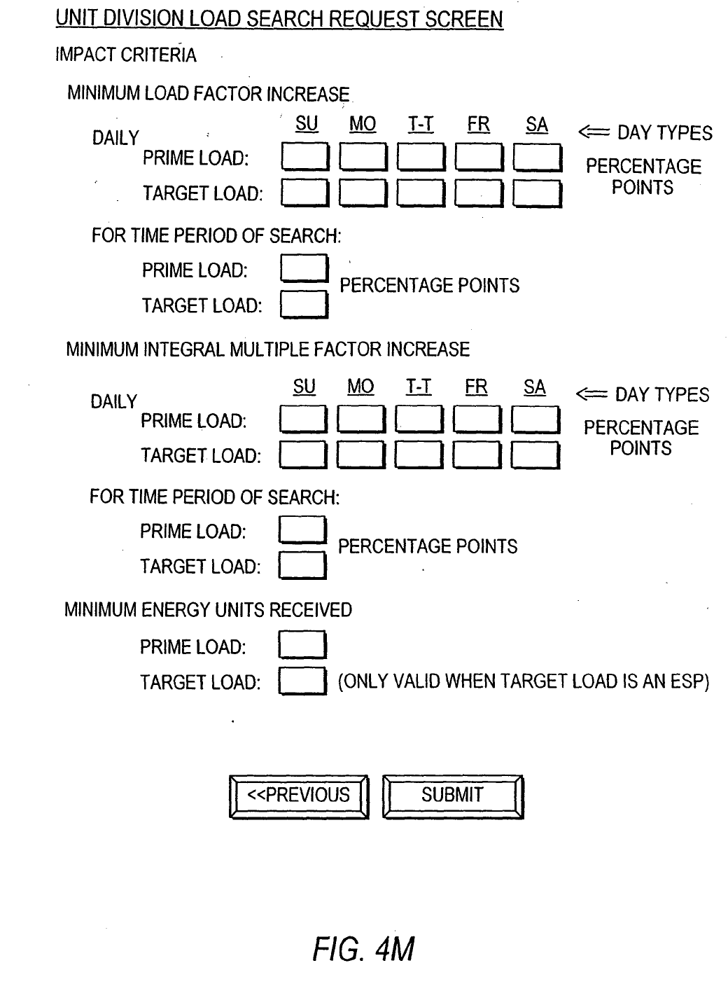

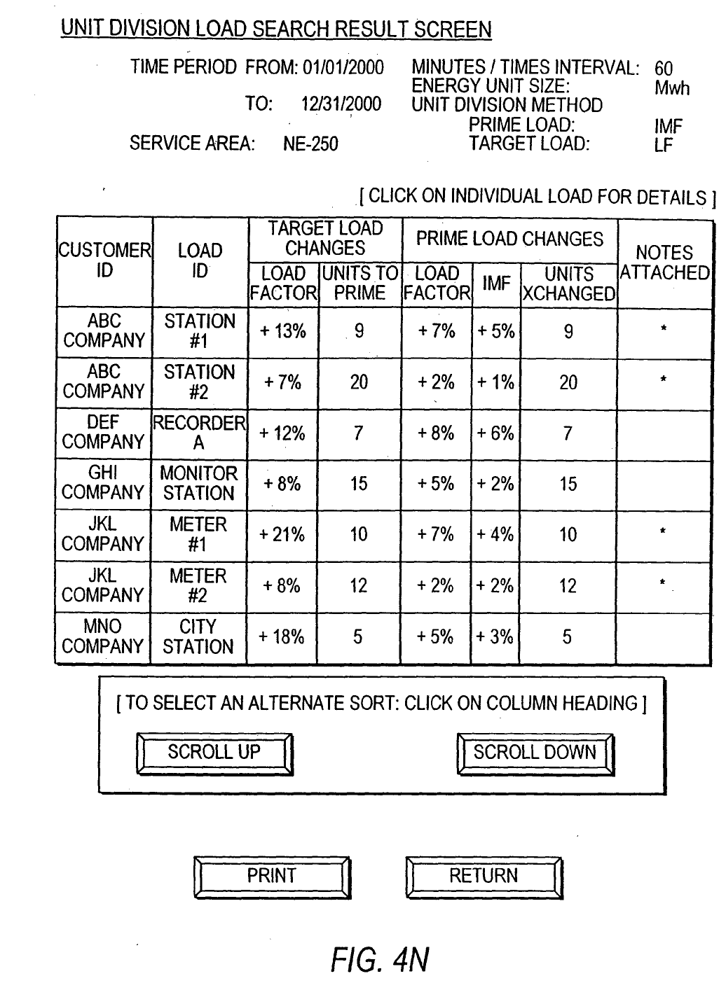

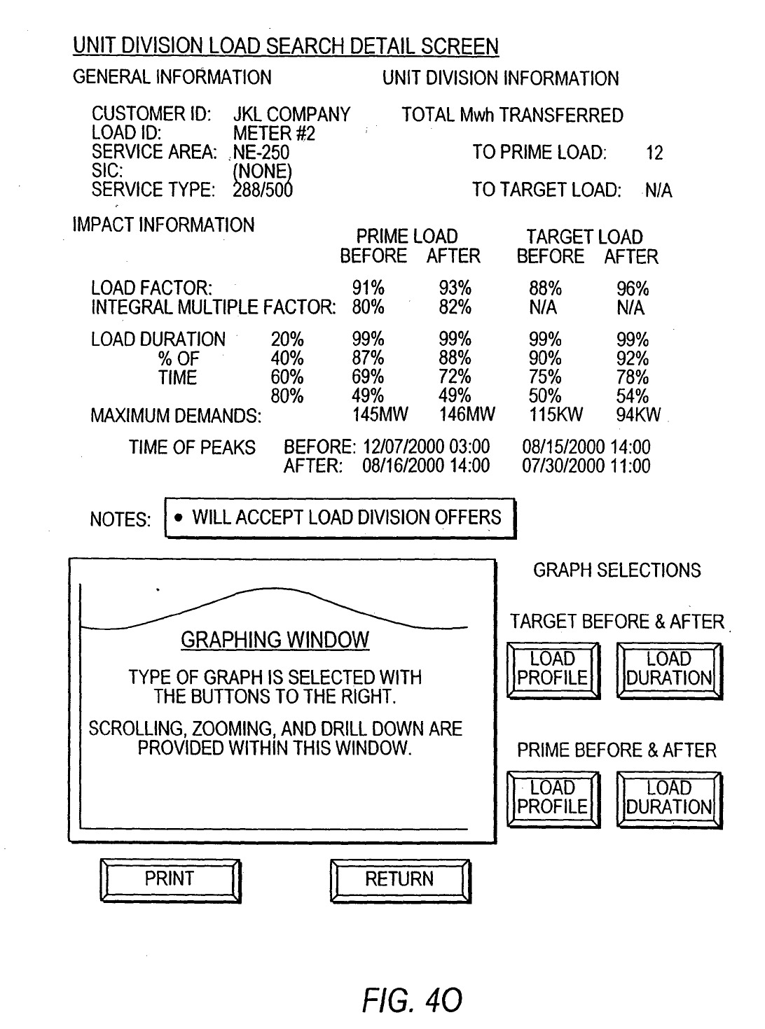

Load identification criteria and load characterization criteria are specified by the exchange user and entered on the load search request screens (FIG. 4D-4F) and (FIGS. 4K-4L).

Load Searches-Impact Criteria

Impact criteria are specified for a load search (FIGS. 4F-4H, 4M) and are used to evaluate the resulting load after a particular load has been combined with another load.

FIG. 4I illustrates a typical load search result screen indicating the results of searches of five customers with seven different loads with reports on the discrete load values and load impact values for each of the seven loads. FIG. 4J is a more detailed analysis of one of the customer loads displayed in FIG. 4I providing the relevant discrete and impact information.

Returning to FIG. 3, which illustrates the exchange node architecture, retail engines 38 include a load search engine 42 that permits an exchange user to search loads using criteria specified in the load search request screens (FIGS. 4D-4H) or man-machine graphical user interface 32 as it is called in FIG. 3. Retail engines 38 further includes a trading engine 44, whose function is described below, and a price search engine 46, which allows, in a manner described in greater detail below, the exchange users to analyze retail trades. Similarly, the optimization engines 40 include a load search engine 48, which allows ESPs to search ESP loads using criteria specified in load search screens (FIGS. 4K-4M), a trading engine 50, and a price search engine 52, which allows ESPs to analyze optimization trades. In each local facility 20, the exchange node is connected via a bus 54, a data base interface 56, and a second data bus to the exchange database 58.

As illustrated in FIG. 3, the exchange database 26 may include three distinct databases, a load database 60, which stores and contains such data as user account information, user load information including user interval load data, long position information, and interval capacity information, a user database 62, which stores data concerning the exchange users' commitments and instructions, and a trading database 64, which stores trading history tables and lists. The databases 60, 62 and 64 are all part of the exchange database resident on a database server 65.

As noted, the retail load search engine 42 is used to search for, identify, and analyze customer loads that meet a particular ESP's specified search criteria, whereas the optimization load search engine 48 is used to search for, identify and analyze ESP loads to determine how segments of those loads might be shifted between ESPs to increase an appropriate indicator of efficiency in energy usage by the ESPs. In order to determine which of the load search engines, that is the retail or optimization load search engines, is to be operative in response to a load search command, the process illustrated in FIGS. 4A-4C is carried out by appropriate software resident in the exchange nodes. As shown in FIG. 4A, the load search procedure is initiated when a load search request is received at the interface at the exchange node from an exchange user such as an ESP, as indicated at 66. In response to that request, as indicated at 68, the system assumes an autonomous search and sets the discrete criteria and impact criteria to the default load search criteria established for that exchange user as established in the database for that particular user. As stated previously, discrete criteria include characteristics of the load(s) being searched such as load shape, peak load, etc., and the impact criteria which weigh the effect on the overall ESP load when the searched load(s) are combined with the ESP's existing load, thereby, for example, to prevent the ESP from taking on a load that exceeds its capacity by not more than a specified percentage of capacity.

Then, as indicated at 70, the discrete and impact criteria involved in the load search being considered may be modified by obtaining any overriding discrete and impact criteria from the exchange user. A determination is then made, as indicated at 72, if only a local load search was requested, that is, if the search is to be made only of loads registered on the particular exchange node. If the determination of 72 is affirmative, the process goes to the decision step 78, and as indicated at 74, load search requests can be made from other exchange nodes on the exchange network. If the determination made at 72 is negative, load search requests are sent to the inter-nodal communications interface 34 for routing data to other exchange nodes on the Exchange Network are indicated at 76.

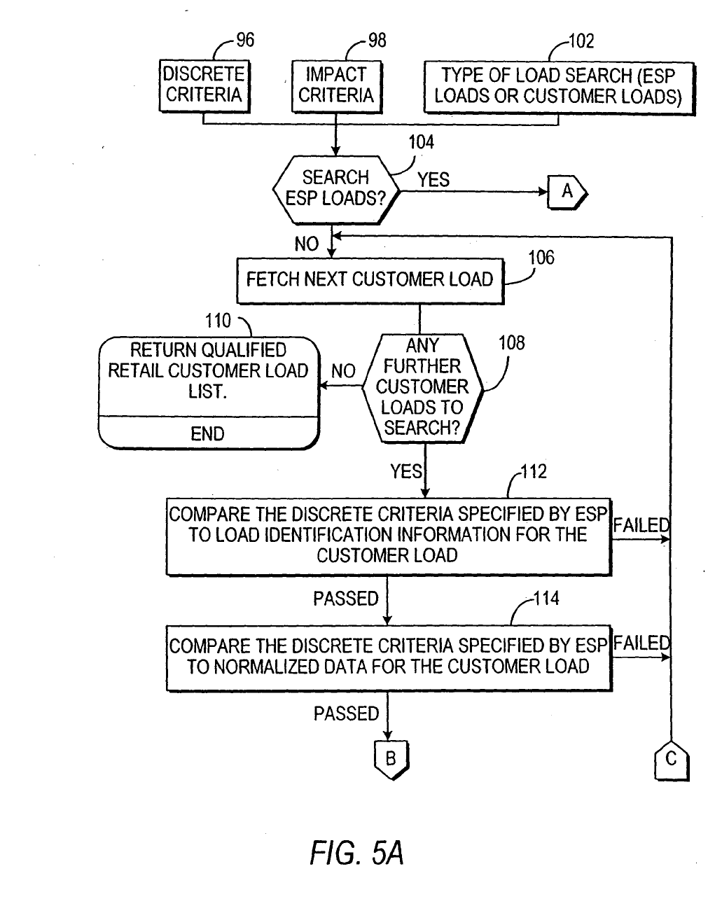

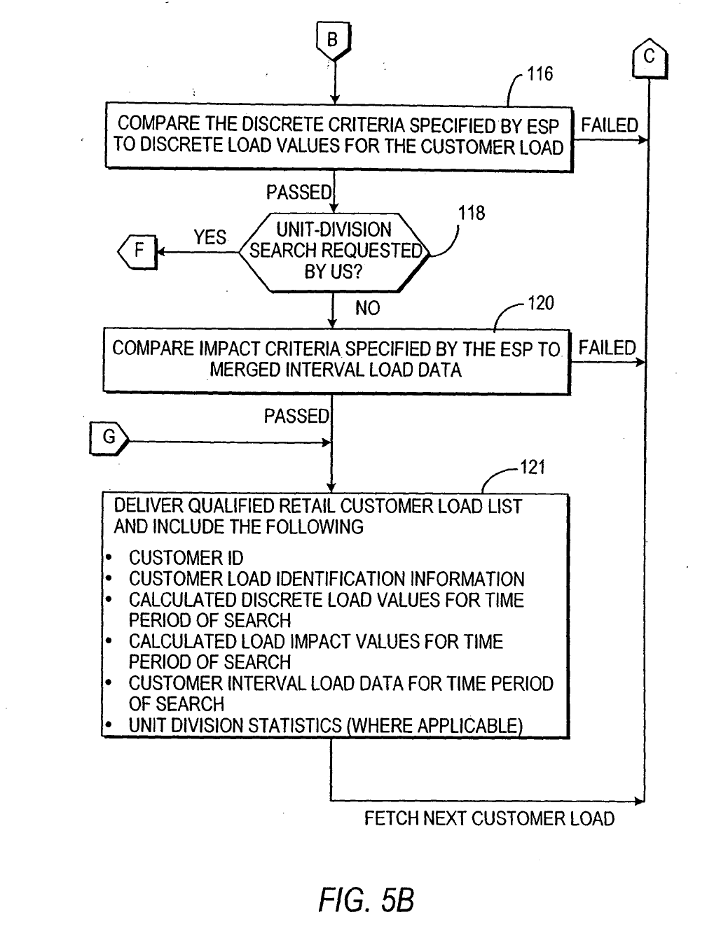

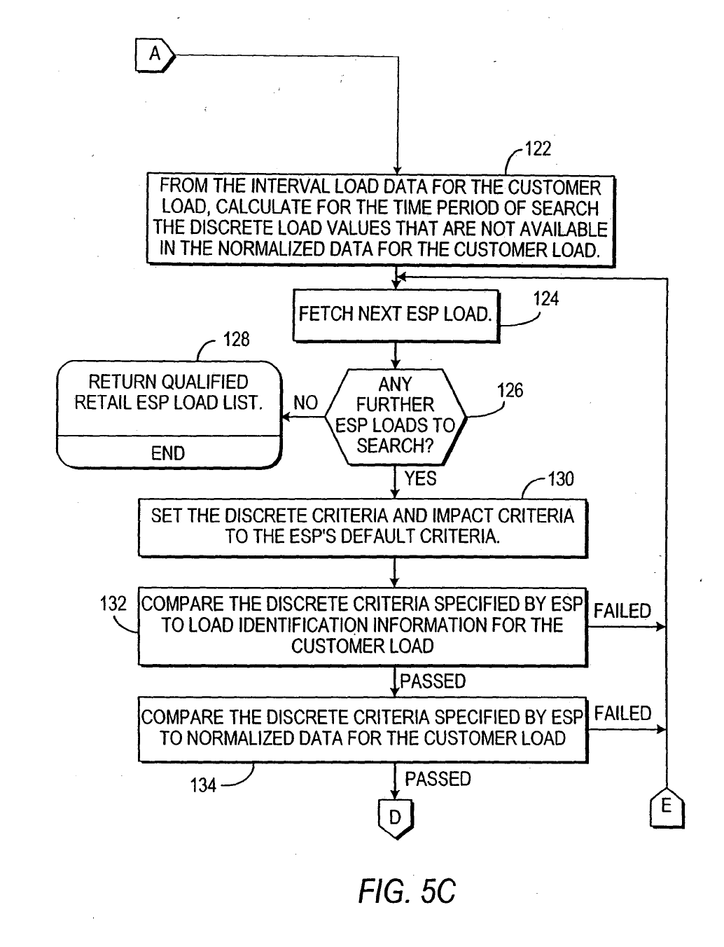

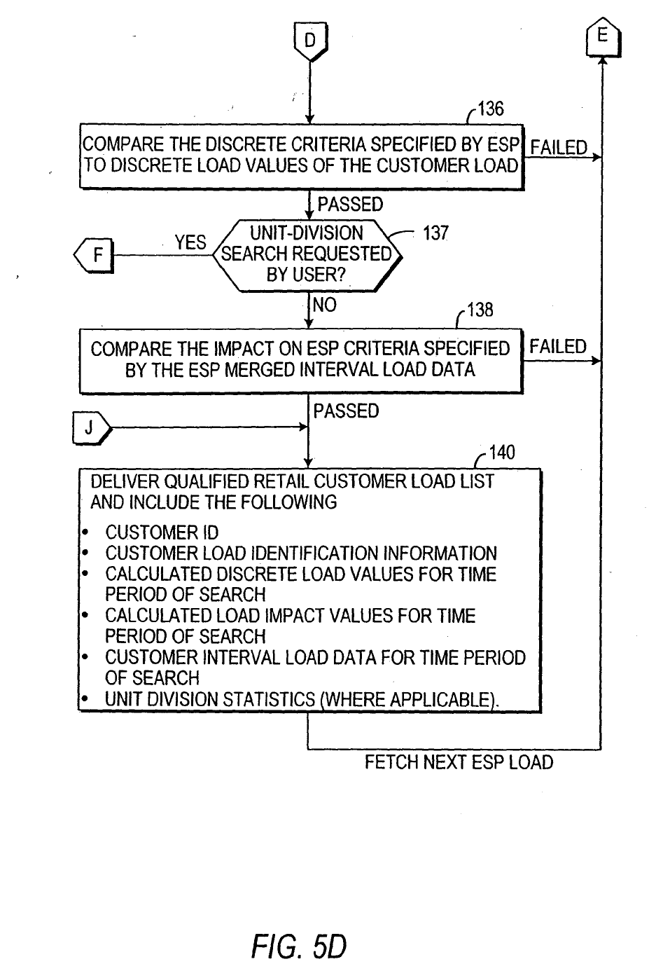

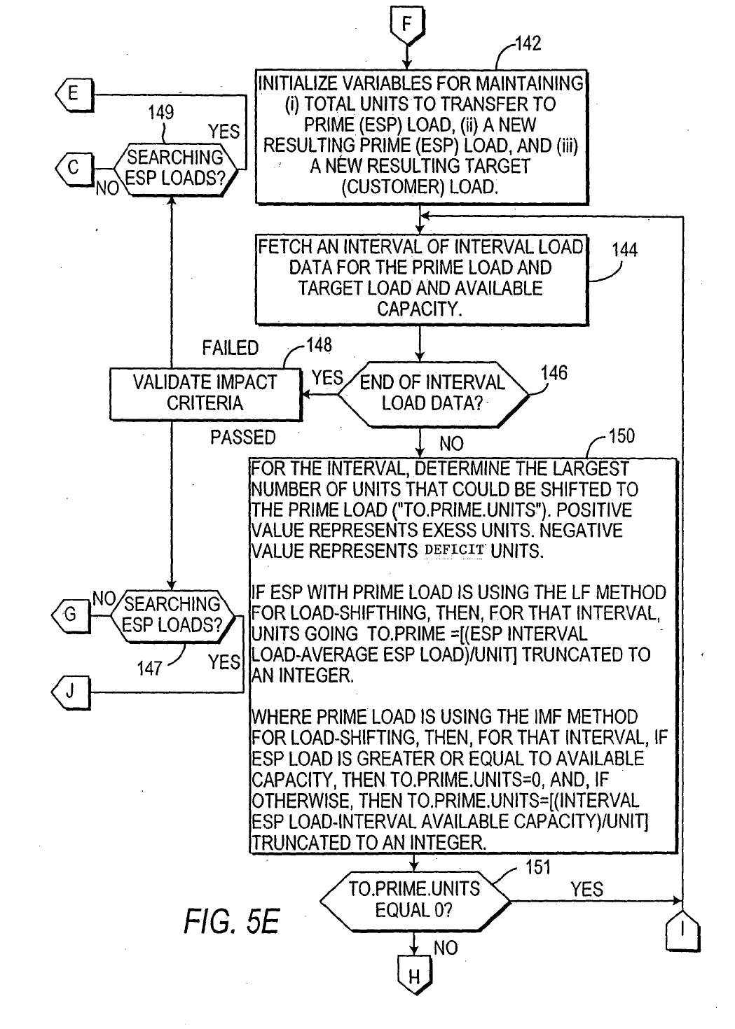

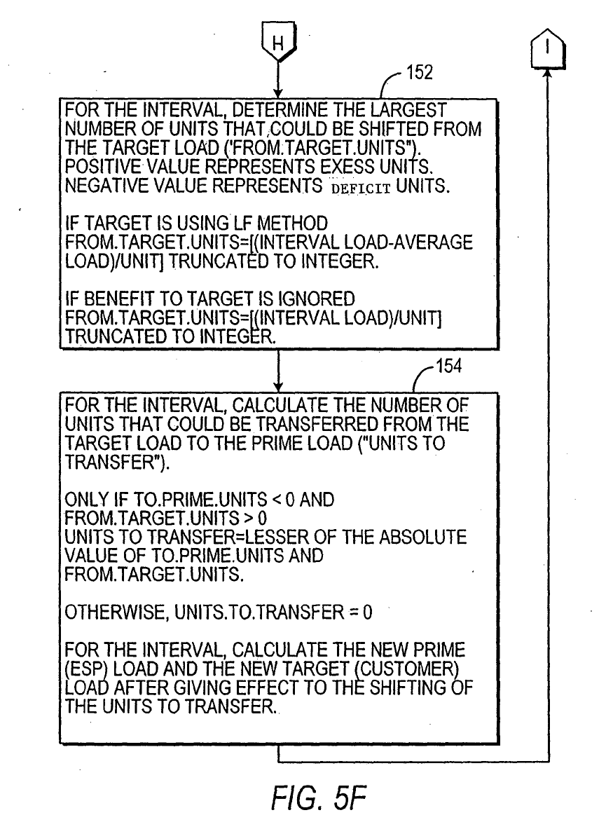

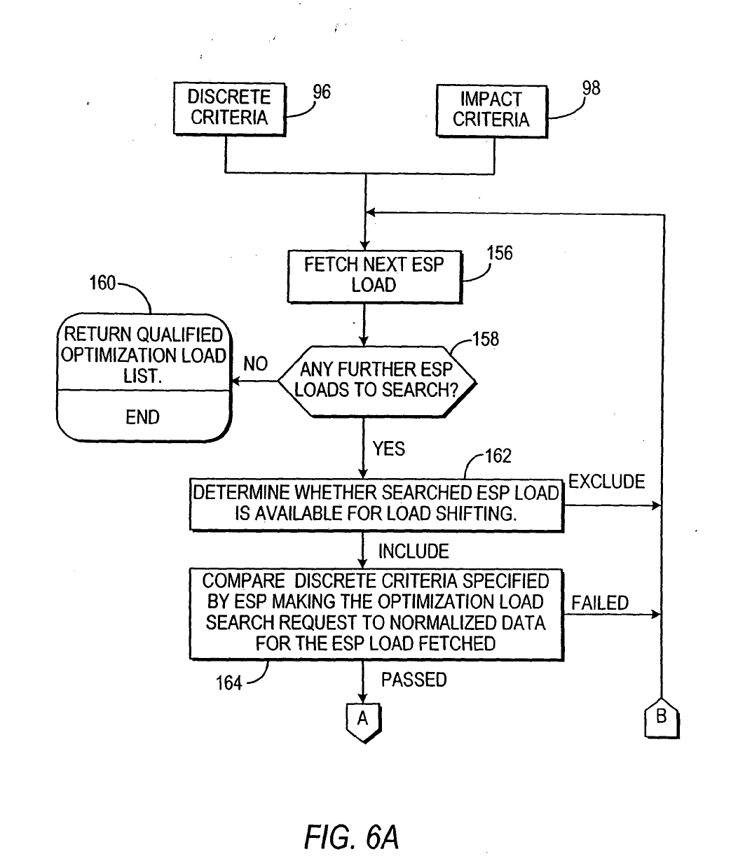

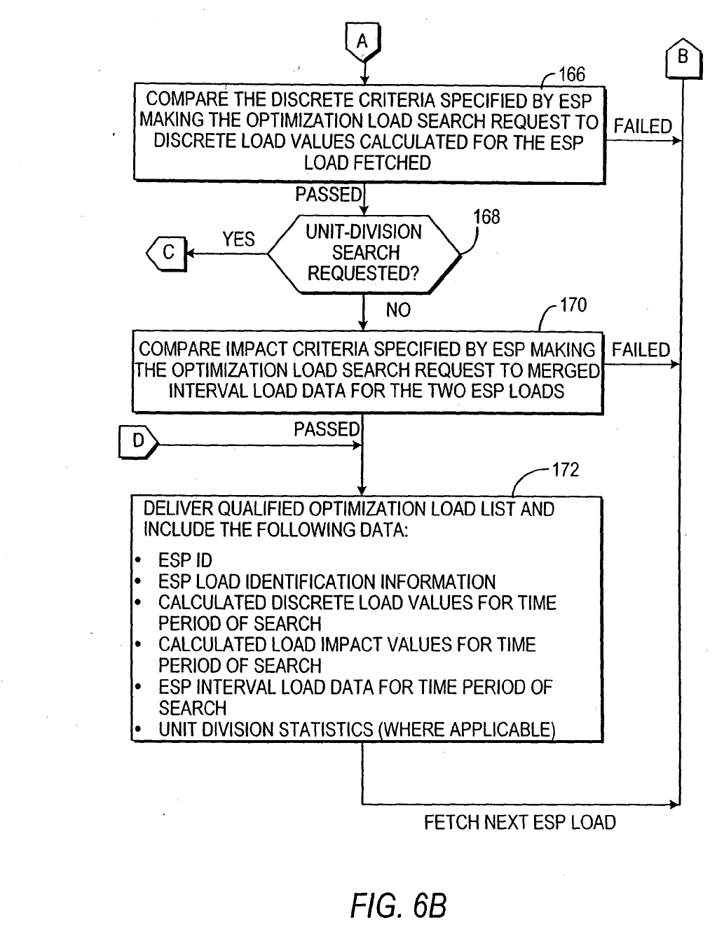

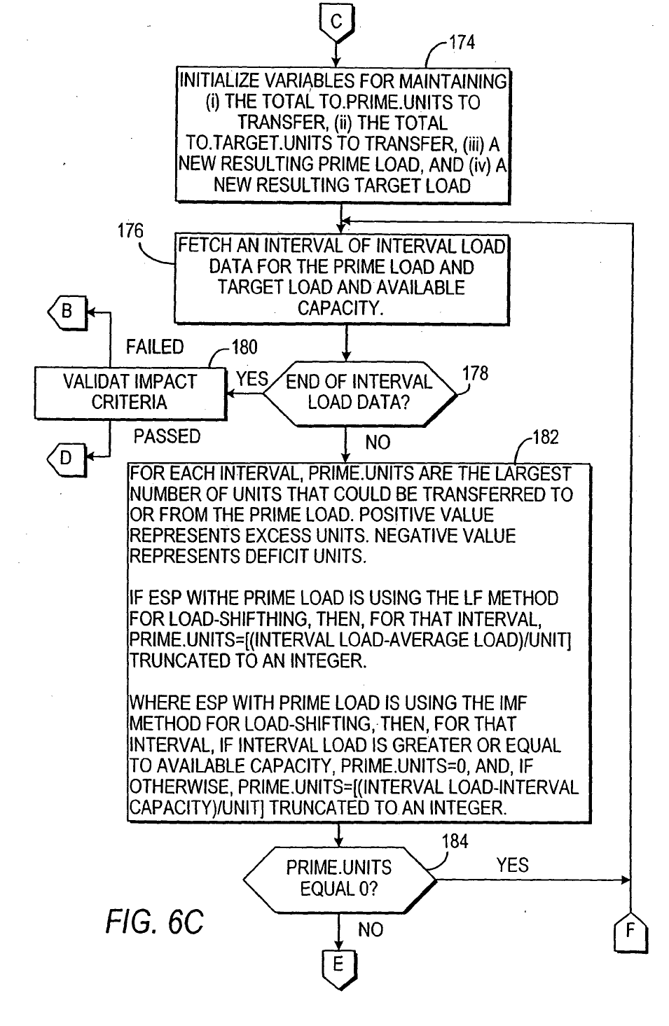

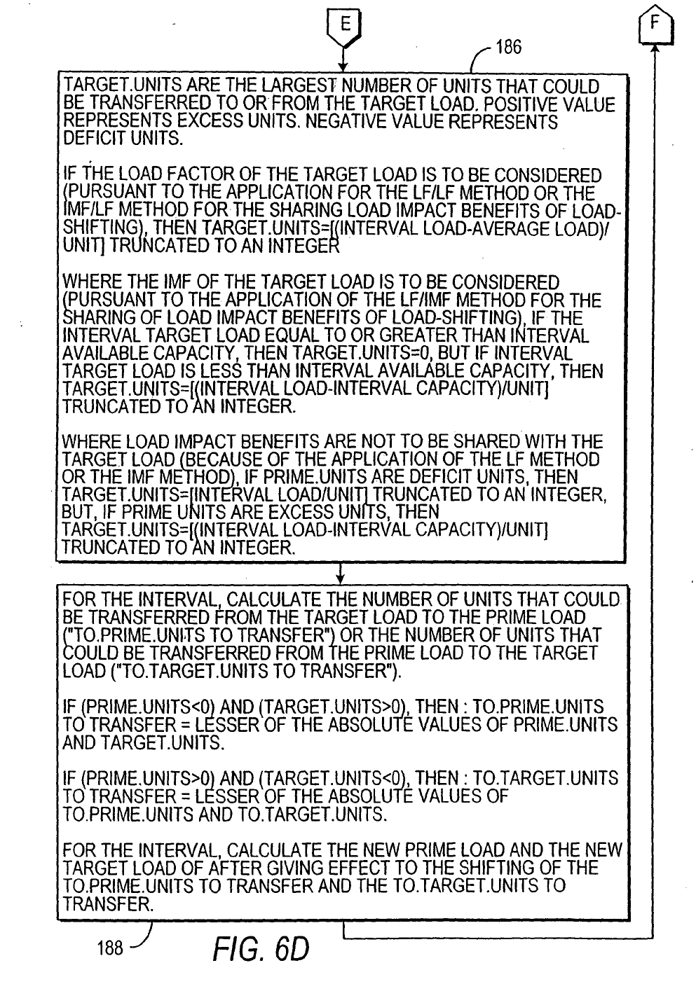

At the conclusion of either operation 74 or 76, a decision is then made at 78 to determine whether the load search request from one ESP was for load data from one or more other ESPs. If this determination results in an affirmative, as indicated at 80, an optimization load search is processed or carried out by the optimization search engine 48 (FIG. 3j. A detailed flowchart of this process is provided in FIG. 6 discussed below. If the result of the determination made at 78 is negative, then, as indicated at 82, a retail load search request is processed by the retail load search engine 42 (FIG. 3). A detailed flow chart of a retail load search is provided in FIG. 5 also discussed below.

At the conclusion of either operation 80 or 82, as the case may be, load search results from other exchange nodes are received from other exchange nodes on the exchange network by the internodal communications interface 34, as indicated at 84. Thereafter, as indicated at 86, the local load search results from load search engine of the local exchange node are combined with the network load search results from load search engines of other exchange nodes on the exchange network. Thereafter, as shown in FIG. 4C, a determination is made at 88 if the load search request originated from another exchange node 24 on the exchange network. If the finding is affirmative, the load search results are directed to the original requesting exchange node by the internodal communications interface 34, as indicated at 90, and the process is ended, as indicated at 94. If the determination made at 88 is negative, the load search results are routed to the interface 32 for display to the exchange user (FIGS. 4I-4J and FIGS. 4N-4O), as indicated at 192, and the process comes to an end, as indicated at 94.

A tabular display of information concerning loads found during the load search is provided to the exchange user as shown in FIG. 4I and FIG. 4N, which includes discrete and impact results. The exchange user may request more information on any of the entries in the table by pointing and clicking on the item of interest to obtain a complete summary of the information on a particular customer load along with graphing capabilities as shown in FIG. 4J and FIG. 4O.

A retail load search requested by an ESP invokes the retail load search engine 42, the operation of which is illustrated in FIG. 5. As shown in FIG. 5A, at the initiation of the search, the discrete criteria are entered at the user interface, as indicated at 96, the impact criteria are input, as indicated at 98, and the type of loads to be searched, e.g., the loads of ESPs or customer loads, is entered at the user interface, as indicated at 102. A decision is then made, as indicated at step 104, to determine whether a customer wishes to search ESP loads. If the decision at step 104 is negative, meaning that only customer loads are to be searched, data concerning the next customer's load are acquired or fetched as indicated at 106.

A decision is then made at the 108 to determine whether any further loads are available to to be searched. If there are no further loads to search, the list of qualified loads is returned and the process would end, as indicated at step 110. If another load is found a comparison is made, as indicated at 112, between the discrete criteria specified by the user to the customer load identification information, such as the load factor or demand of the customer. If the comparison fails, that is, if the searched customer load does not satisfy the discrete criteria, the process returns to step 106 to fetch the next customer load. If, on the other hand, the searched customer load passes or satisfies the comparison at 112, the discrete criteria specified by the user are compared to the normalized data for the searched customer load, as indicated at 114.

Stated differently, at step 114, the normalized customer load data for the time period of the search is compared to the specified load characteristic criteria. If the comparison at 114 fails to satisfy the discrete criteria, the process returns to step 106 to fetch another customer load. If the comparison at 114 passes, the discrete criteria specified by the searching ESP are compared to the discrete load values for the searched customer load, as indicated at step 116. If the comparison fails, the process returns to step 106. If the comparison at 116 passes, the process will proceed to 118.

As indicated at 118, a determination is made whether a search on unit-divided loads as opposed to a search of whole loads is to be made. If the decision made is affirmative, the process shifts to the unit division load search described below with reference to FIGS. 5E and 5F. If the decision made at step 118 is negative, an impact criteria comparison is made at step 120 of the impact criteria specified by the ESP with the merged interval load data. In this step, the interval load data selected in the previous portion of the retail load search is combined with the preexisting interval load data of the ESP load to determine whether the combined or merged loads satisfy the impact criteria.

If the merged loads do not meet the impact criteria, the comparison is deemed to have filed, and the process is returned to step 106 to acquire another customer load for evaluation, after which the process of steps 108 to 120 is repeated. If the impacted criteria comparison at 120 are satisfied by the merged loads, the customer load is deemed to pass the impact criteria assessment at step 120, and the thus-qualified customer load is added to the qualified retail customer load list as indicated at 121. The information returned for the newly-added qualified retail customer load may include, for example, the customer ID, the customer load identification information, the calculated discrete load values for the time period of the search, the calculated load impact values for the time period of search, the customer interval load data for the time period of the search, and, where applicable in the case of a unit division search, the unit division statistics.

As noted above, if the decision made at step 104 is positive, that is, that ESP loads are to be searched, the process then goes directly to step 122 at which the discrete load values that are not available in the normalized data for the customer load are calculated, for the time period of the search, from the interval load data for the searching customer. The next ESP load is then fetched, as indicated at 124, after which a decision is made, as indicated at 126, whether there are any further ESP loads to be searched. If the decision made at step 126 is affirmative, the discrete and impact criteria are set to the ESP's default search criteria, as indicated at 130, and then, as indicated at 132, the discrete load identification criteria specified for the newly searched ESP are compared to the lead identification information for the customer load. If this comparison is unsuccessful in obtaining a suitable match between the customer and the ESP, the process returns to step 124 and a new ESP load is fetched. If the comparison made at step 132 is positive, the normalized data for the customer load for the time period of the search is compared to the discrete load criteria specified by the ESP, as indicated at 134. As in step 132, if the comparison fails, the process is returned to step 124 to fetch a new ESP load.

If the comparison made at step 134 is successful, the process, as indicated at step 136 (FIG. 5D), then compares the discrete load criteria specified by the ESP to the calculated discrete load values of the customer load for the time period of search. If this comparison fails, the process returns to step 124 to fetch a new ESP load. If the comparison at step 136 is successful, the decision is then made at step 137 to determine whether or not a unit division search has been requested by the user. For an affirmative determination at step 137, the process proceeds to step 142 (FIG. 5E), which is discussed below. For a negative determination at step 137, the interval load data for the customer load is combined with the interval load data of the ESP load and the thus merged interval load data is used to calculate the load impact values for comparison with the ESP impact criteria, as indicated at 138. If this comparison indicates that the impact criteria on the ESP are not satisfied, the process returns to step 124 to fetch a new ESP load. If the ESP impact criteria are satisfied, the ESP load is added to the qualified ESP load lists, as indicated at 140. The list information includes, for example, information about the qualified ESP, ESP load identification information, calculated discrete load values for the time period of the search, calculated load impact values for the time period of the search, ESP interval load data for the time period of the search, and, where applicable, the unit load division statistics. Following step 140, the process returns to step 124 to fetch a new ESP load and the process is repeated for each newly fetched ESP load until all the available ESP loads have been searched. When no more ESP loads are available, the qualified ESP load list is returned as indicated in step 128 and the process ends.

If the decision made at step 118 (FIG. 5B) is to search for unit-divided loads, in which the prime, and e.g., ESP, the exchange user making the search, searches the targets, e.g., selected customers, the exchange users being searched, for a selected portion or unit of their loads in an attempt to combine a selected target's load with that of the prime so that the combined load of the prime has an improved indicator of efficiency in energy usage, the process proceeds directly to step 142 (FIG. 5E). Thus, for a retail load search, the ESP is considered to be the prime load and the customer is the target load, whereas in an optimization load search, the prime and target loads are both ESP loads.

If a unit-divided load search is made as part of a retail load search, the search process is that illustrated in the flow chart of FIG. 5E and FIG. 5F. As indicated at step 142 (FIG. 5E), the variables for maintaining (i) the total units of target load to be transferred to the prime (ESP) load, (ii) a new resulting prime (ESP) load, and (iii) a new resulting target (consumer) load are initialized. Thereafter, as indicated at 144, an interval of interval load data is fetched for the prime load and target load and available capacity. A determination is then made at step 146 as to whether there is an end of interval load data. For an affirmative decision, the impact criteria for the prime and target loads are evaluated as indicated at 148. In this operation, the load impact values for the resulting prime load and target load are calculated and compared to the specified impact criteria. If the total units of target load to be transferred are zero, or if the impact criteria are not met by the transfer, the validation of criteria at step 148 fails and the process proceeds to step 149. If the test at 148 passes, the process continues to step 147.

A determination is made, at step 147, whether ESP loads are being searched. For a negative determination, the process proceeds to step 121 (FIG. 5B). If the determination at step 147 is positive, the process proceeds to step 140 (FIG. 5D).

If the validation criteria, at the step 148, are not satisfied, a decision is made at step 149 whether ESP loads are being searched. For a negative decision, the process proceeds to step 106 to fetch a new customer load. For a positive result at step 149, the process proceeds to step 124 to fetch the next ESP load.

If the determination at step 146 is negative, a determination is made, as indicated at step 150, of the largest number of units that the ESP could shift for the interval (“To Prime Units”). If the ESP as the prime load is using the LF method for load-shifting, then, for that interval the units available for the ESP to shift, To.Prime.Units, is equal to [(ESP interval load—average ESP load)/unit] truncated to an integer. If the prime load is using the IMF method for load-shifting, then, for that interval, if the ESP load is greater or equal to the available capacity, then To.Prime.Units is equal to zero, and if otherwise, then To.Prime.Units=[(interval ESP load—interval available capacity)/unit] truncated to an integer.

If To.Prime.Units equals zero, as determined at decision step 151, the process returns to step 144. If To.Prime.Units does not equal zero, that is, if units are available for shifting, then, as indicated at 152 (FIG. 5F), a determination is made of the largest number of target units that are available for shifting (“From, Target.Units”). If the target is using the load factor (LF) method, From. Target. Units=[(interval load—average load)/unit] truncated to an integer. If the benefit to the target load is ignored, From.Target.Units=[target interval load/unit] truncated to an integer. Then, as indicated at step 154, for the interval, if the value of To.Prime is negative (prime needs load) and if the value of From.Target is positive (target has load available for transfer), then the number of units that could be transferred from the target load to the prime load is the lesser of the absolute value of To.Prime.Units and From.Target.Units. Otherwise, the units to transfer equals zero. For the interval, the new prime (ESP) load and the new target (customer) load are calculated after giving effect to the shifting of the units to transfer at step 154. Upon the completion of step 154, the process returns to step 144 (FIG. 5E) to fetch the next interval of load data.

As noted above, an optimization load search is made only between one ESP and one or more other ESPs to search for possible load transfers between them that would enable each of the ESPs to achieve more uniform loads and improved load factors over time. The process carried out in an optimization load search is illustrated in the process flow chart of FIG. 6. As can be seen in FIG. 6A, the process begins with the inputs by one ESP of its discrete load criteria, at step 96 and of its impact load criteria, at step 98. Thereafter, at step 156 the next ESP load is fetched and a decision is then made at step 158 to determine whether any farther ESP loads were available to be searched. If not, the list of qualified loads is returned and the process comes to an end, as indicated at step 160. If another ESP load is found, a determination is made, as indicated at step 162 whether the searched ESP load is available for load shifting. That is, the searched ESP load is excluded if it has indicated that its load is not available for load-shifting or if the ESP load belongs to the ESP requesting the search.

If the searched ESP is thus excluded, the process returns to step 156 to fetch a new ESP load. If the searched ESP load is determined to be available for load-shifting, a comparison is made, as indicated at step 164, between the discrete load criteria specified at 96 by the ESP requesting the optimization load search to the normalized data for the ESP load being searched. If the comparison fails, the process returns to step 156 to fetch the next ESP load. If the comparison between the data succeeds, a comparison is then made, as indicated at step 166 (FIG. 6B), between the discrete criteria specified by the ESP making the optimization search request to the discrete load values calculated for the ESP load fetched for the time period of the search. To this end, the discrete load values for the time period of the search are calculated and compared to the load characteristic criteria. If the comparison fails, the process returns to step 156. Otherwise, control passes to step 168.

A determination is made, as indicated at step 168, if a unit-division search has been requested. If such a search is not requested, the process then proceeds to step 170 at which a comparison is made between the impact criteria specified at 98 by the ESP making the optimization load search request to the merged or combined interval load data for the two ESP loads. To this end, the interval load data for the two ESP loads are combined and the merged interval load data is used to calculate the load impact values required for comparison to the specified impact criteria. If the comparison fails to satisfy the specified impact criteria, the process returns to step 156 to fetch a new ESP load. If the merged load data satisfies the specified impact criteria, the searched ESP load is included in the qualified optimization load list as indicated at 172. The information included in the list for that ESP includes ESP information, ESP load identification information, calculated discrete load values for the time period of the search, calculated load impact values for the time period of the search, ESP interval data for the time period of the search, and, if applicable in the event of a unit-division search, the unit division statistics.

As in a retail load search, as described above, the optimization load search engine has the capability of making a unit division or partial load search in addition to a search of whole in other ESPs in the same network. As illustrated in FIGS. 6C and 6D, a unit-division optimization load search is in many ways similar to the previously described unit division retail load search. Thus, once a decision is made to make a unit-division search as part of an optimization load search at decision step 168 (FIG. 6B), the variables for maintaining (i) the total of load units to be transferred to the prime ESP, (ii) the total of load units to be transferred to the target ESP, (iii) a new resulting prime ESP load, and (iv) a new resulting target ESP load are all initialized, as indicated at step 174. Then, as indicated at step 176, an interval of interval load data for the prime load and target load and available capacity is fetched after which, as indicated at decision step 178, a determination is made whether all the interval data for the time period of the search has been retrieved.

For an affirmative outcome at step 178, the impact criteria are validated, as indicated at 180. In this step the load impact values are calculated for the resulting new prime ESP load and target ESP load for comparison to the specified impact criteria. For this comparison to pass, the total load units transferred to both the prime and target ESPs must also not be zero. If the impact criteria are met, the qualified transferred unit load data is added to the qualified load list at step 172. If the resulting new loads do not meet the specified impact criteria, the process returns to step 156 to fetch a new ESP load to be evaluated.

If a negative decision is made at step 178, the unit division load search process continues to step 182 at which the quantity designated as Prime.Units is computed for this interval of data. As used herein, that quantity represents the largest number of units of load that could be transferred to or from the prime ESP load. A positive value of this quantity represents an excess of load units, whereas a negative value represents a deficit of units, in performing the computation of step 182, if an ESP with a prime load is using the load factor (LF) method for load shifting, then, for that interval, Prime.Units=[(interval load−average load) unit) truncated to an integer. If on the other hand, the prime ESP is using the IMF method for load shifting, then, for that interval, if the interval load is greater or equal to interval capacity, Prime.Units=0, and otherwise, Prime.Units=(interval load—interval capacity)/unit) truncated to an integer. Upon the completion of the computation made at step 182, a determination is made at step 184 if Prime.Units, as calculated in step 182, is equal to zero. If it is, the process returns to step 176 and the next interval of load data is fetched for analysis. If the computed value of Prime.Units does not equal zero, the optimization unit-division load search process continues at step 186 (FIG. 6D) to compute Target.Units, which is herein defined as the largest number of units of load that could be transferred to or from the target (ESP) load. A positive value of this quantity represents an excess of units and a negative value represents a deficit of units.

As described in FIG. 6D, if the load factor of the target ESP load is to be considered, pursuant to the application of the LF/LF method or the IMF/LF method for sharing the load impact benefits of load shifting, then Target.Units=[(interval load−average load)/unit truncated to an integer. When the IMF of the target ESP load is to be considered, pursuant to the application of the LF/IMF method for sharing the load impact benefit of load shifting, if the interval target load is equal to or greater than the interval available capacity, then Target. Units=0), but if the interval target load is less than the interval available capacity, then Target.Units=[(interval load—interval capacity)/unit] truncated to an integer. Finally, when the load impact benefits of the load shifting are not to be shared with the target ESP load, because of the application of the LF method or the IMF method, if the previously calculated Prime.Units are deficit units, then Target.Units=[interval load/unit] truncated to an integer, but if the previously calculated Prime.Units are excess units, then Target. Units=[(interval load—interval capacity)/unit] truncated to an integer.

At the completion of the computation of Target.Units at step 186, the process continues with computation step 188 at which a computation is made of the number of load units that could be transferred, for the interval, from the target ESP load to the prime ESP load or the number of units that could be transferred from the prime ESP load to the target ESP load. As described at step 188, if Prime.Units, as computed in step 182, is less than 0 and Target.Units, as computed in step 186, is greater than 0, then the quantity of units to transfer to the Prime load (To.Prime.Units) is equal to the lesser of the absolute values of Prime.Units and Target.Units. If Prime. Units is greater than 0 and Target-Units is less than 0, then the quantity of units to be transferred to the target load (To.Target.Unit) is also equal to the lesser of the absolute values of Prime.Units and Target.Units. Step 188 concludes with the computation, for the interval, of the new resulting prime ESP load and the new resulting target ESP load based on the load units transferred between the prime and target ESP loads. At the conclusion of step 188, the process is returned to step 176 and the next interval of load data is fetched and the process following step 176 is repeated.

Price Search Systems

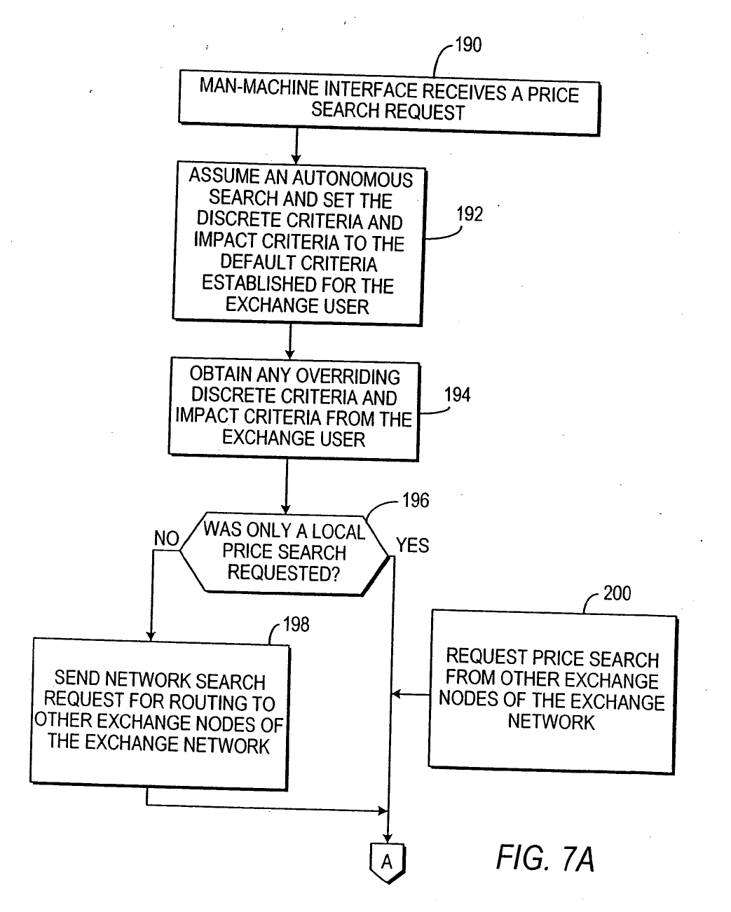

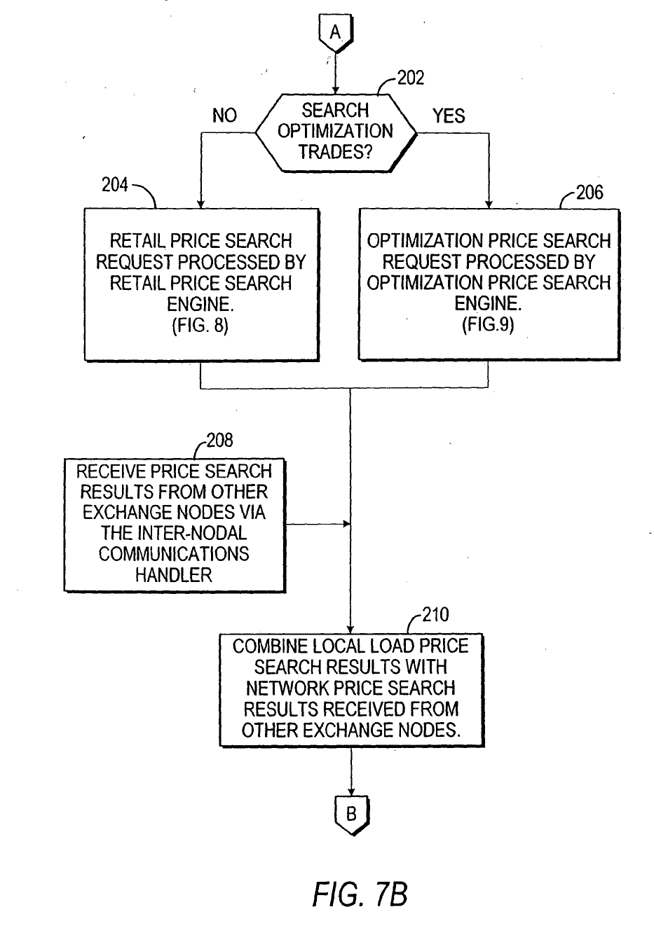

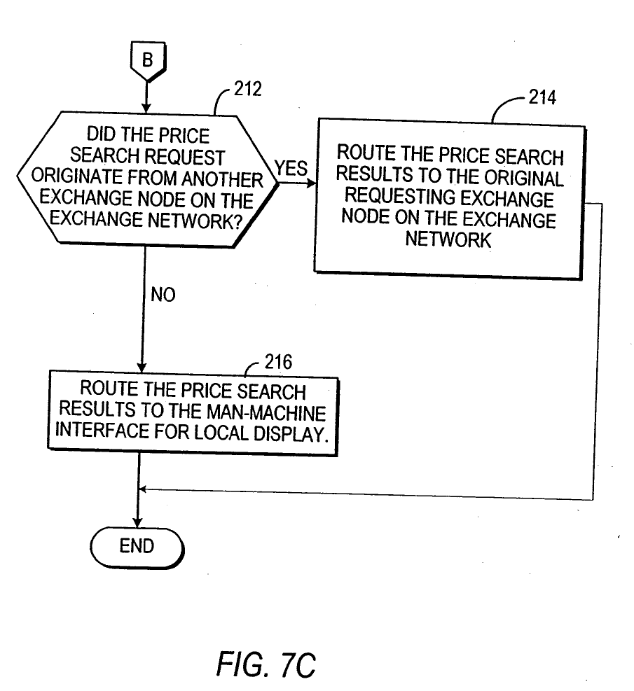

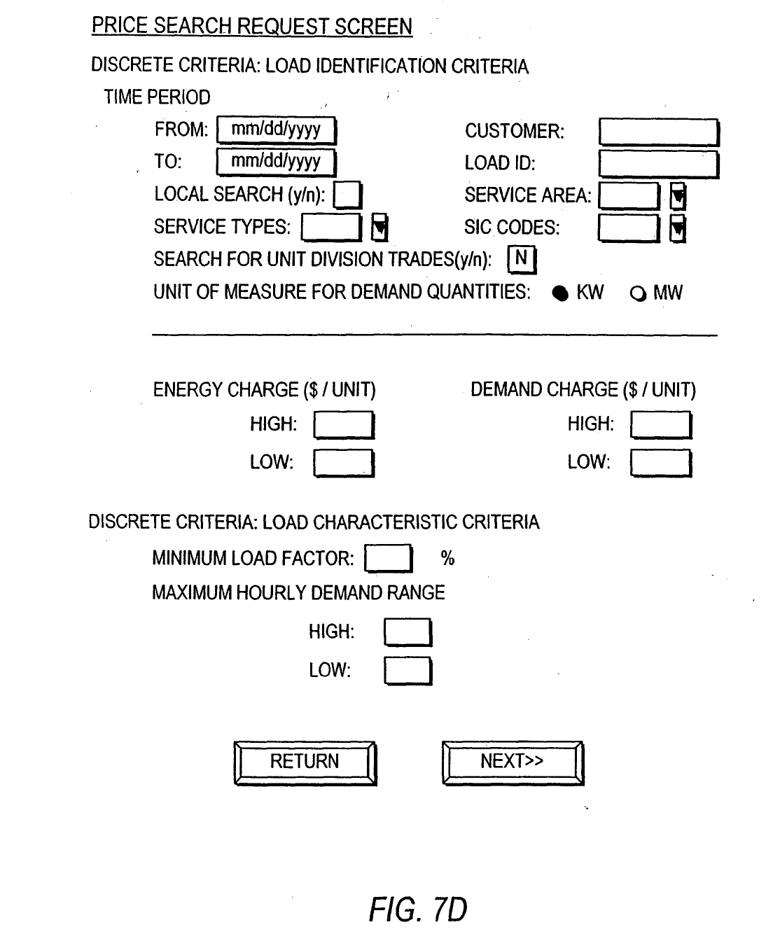

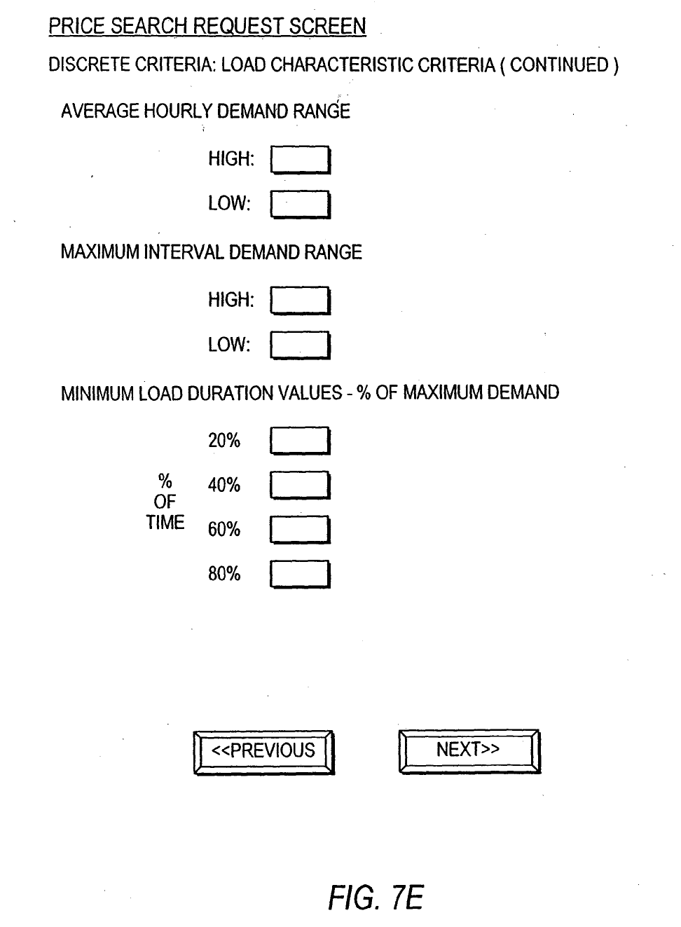

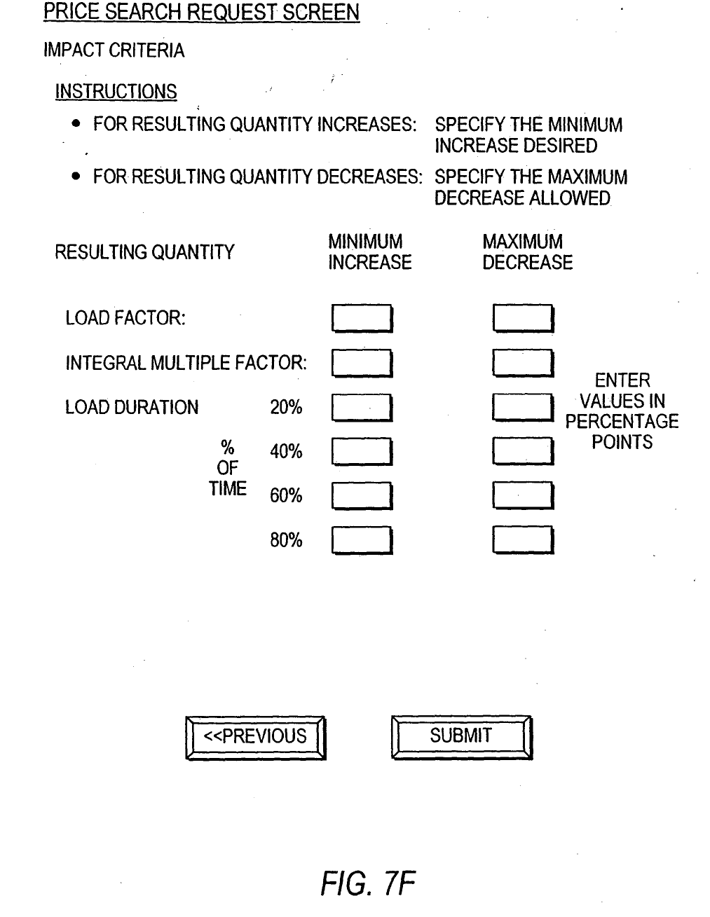

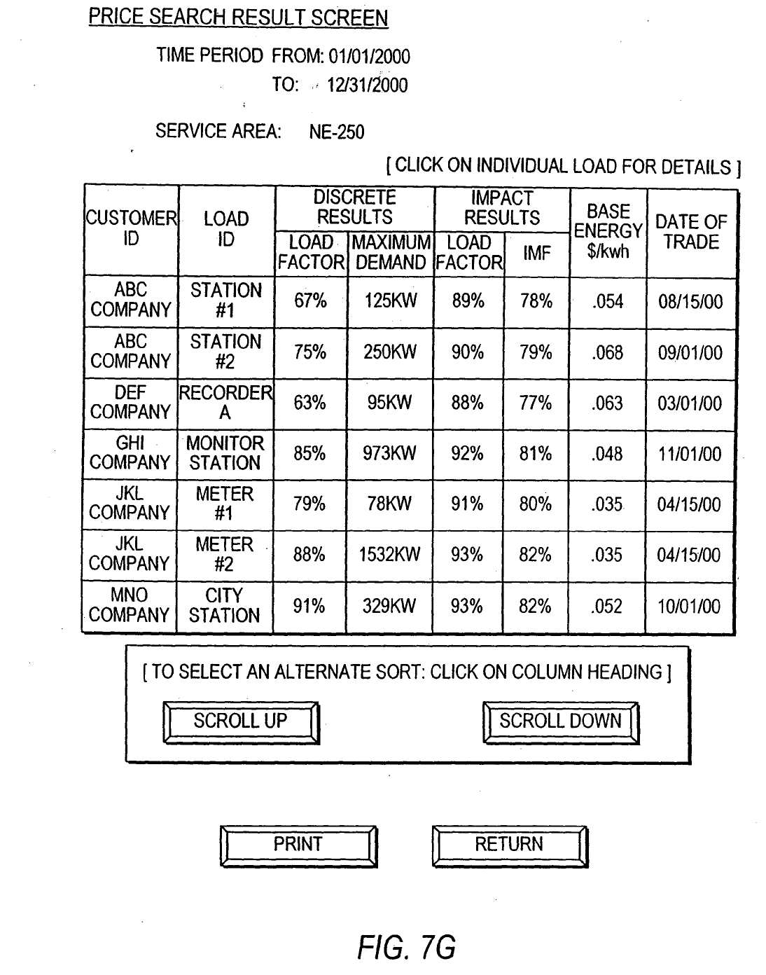

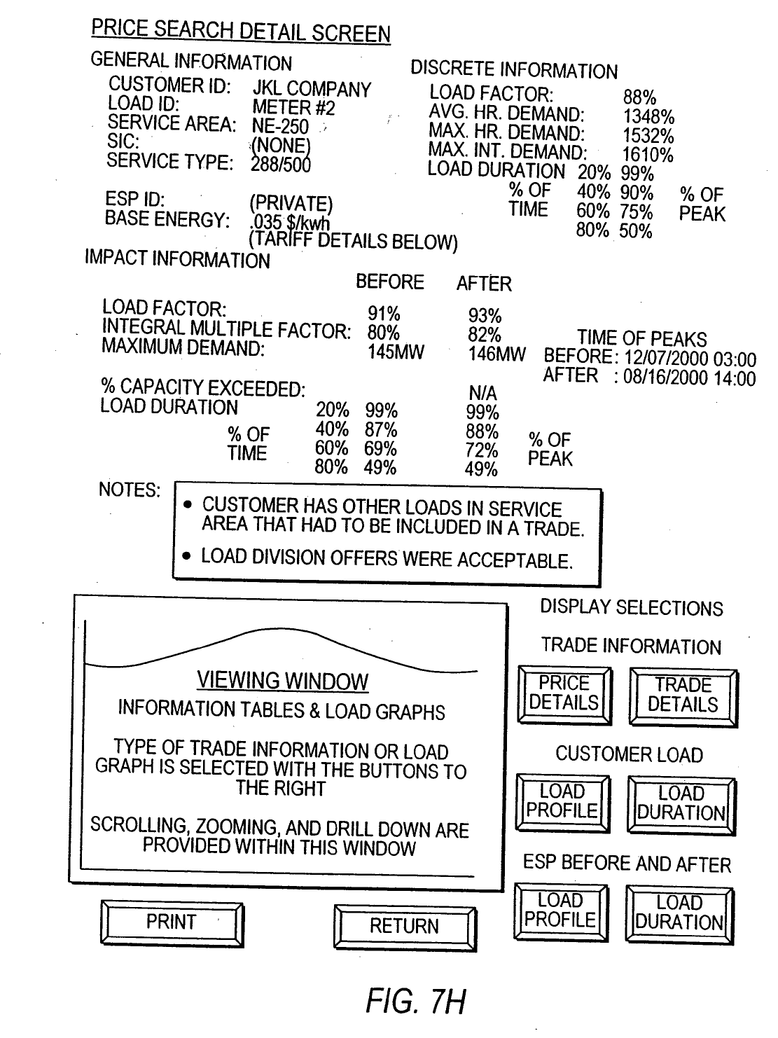

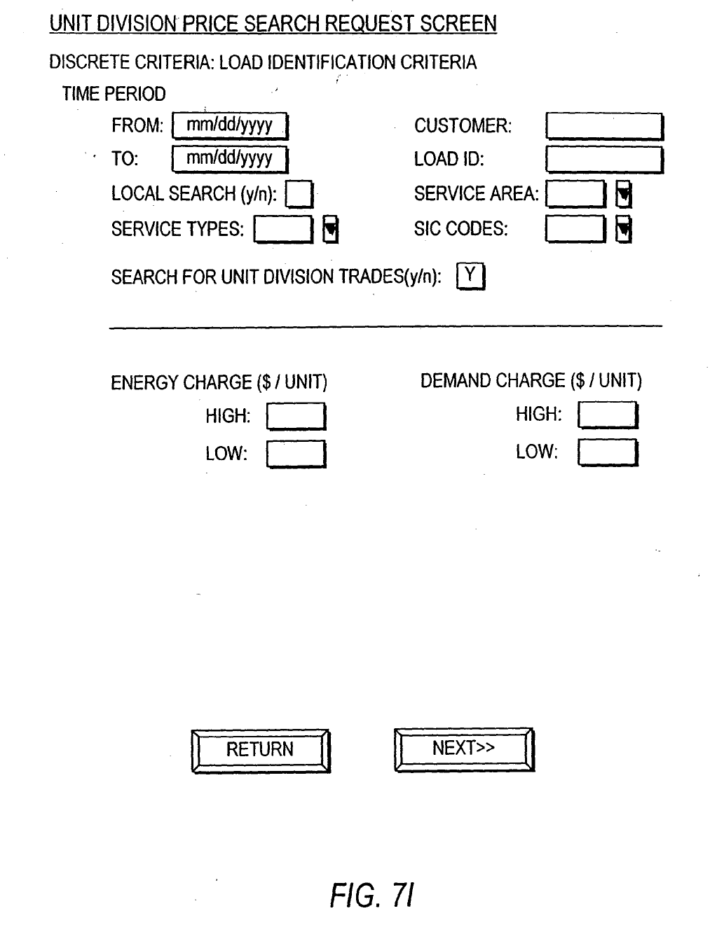

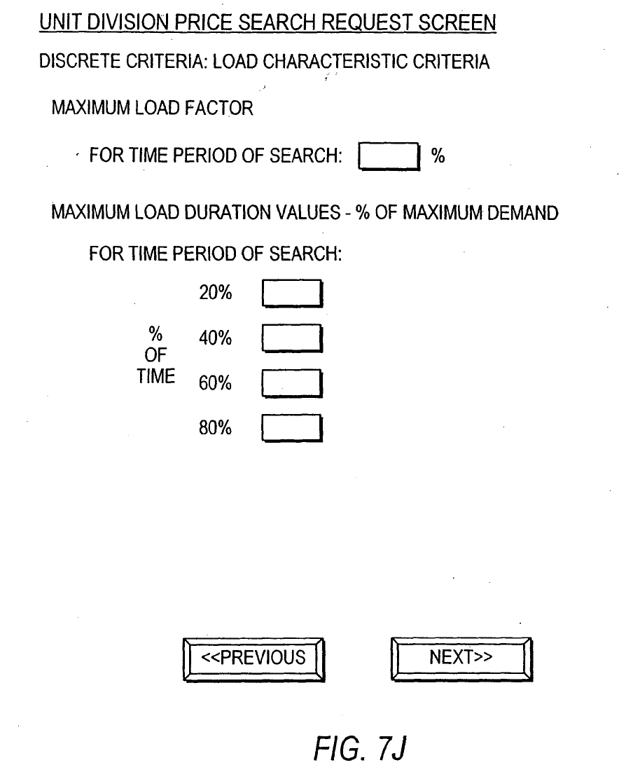

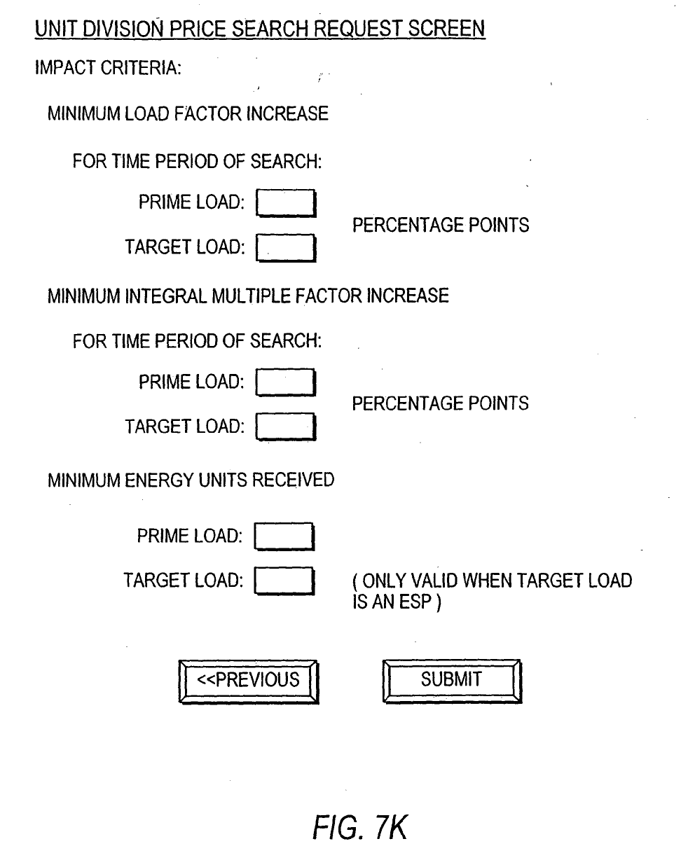

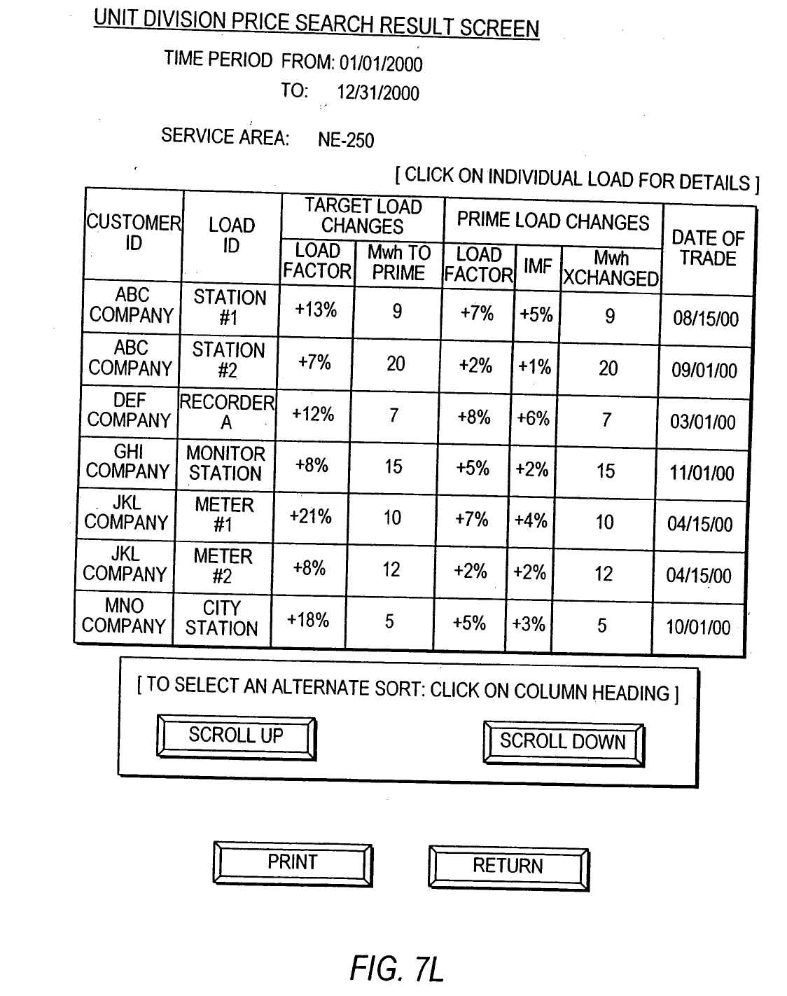

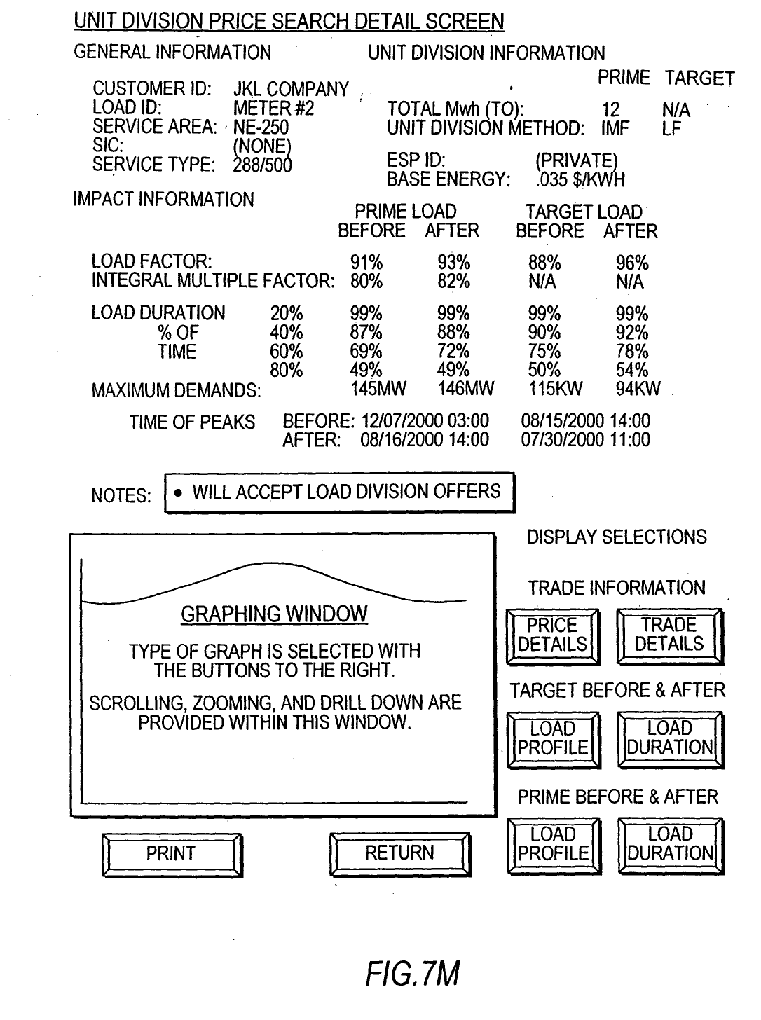

The price search system, which includes the retail price search engine 46 and the request for a price search made at a data entry screen shown in FIGS. 7D-7F and FIGS. 7I-7K that is presented to the exchange user who is making the price search, as indicated at 190 in FIG. 7A. As indicated at step 192, an autonomous search is assumed and discrete and impact criteria are set to the default criteria established for the exchange user. Then, as indicated at 194, any overriding discrete criteria and impact criteria are obtained from the exchange user. The determination is then made at step 196 whether only a local price search was requested. For a negative determination, the network price search request is sent to the internodal communications interface 34 for routing to other exchange nodes on the network, as indicated at 198. If the determination at 196 is positive the process continues to step 202 (FIG. 7B). Requests for a price search are received from other exchange nodes via the internodal communications interface, as indicated at 200.

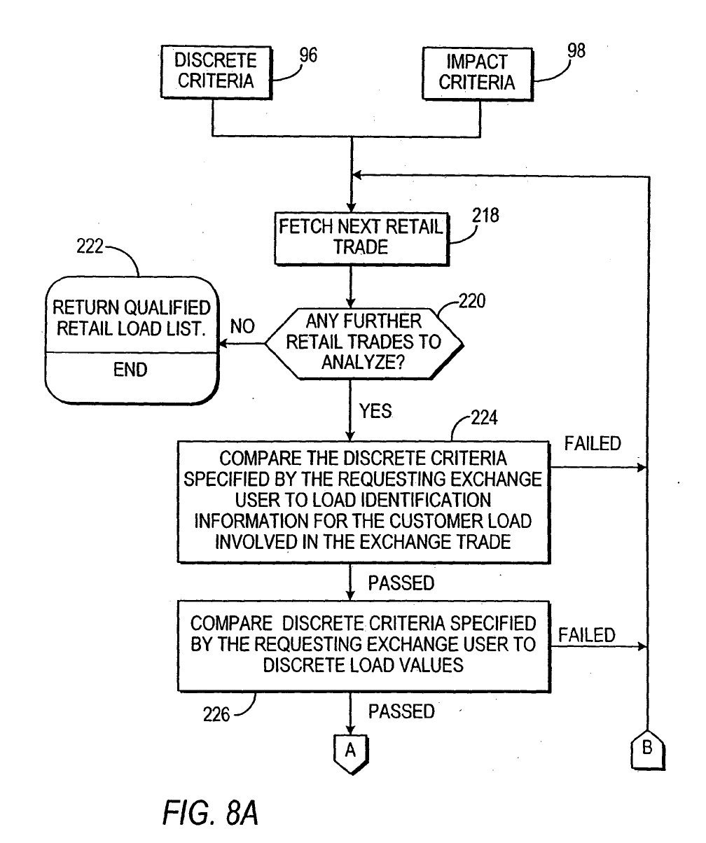

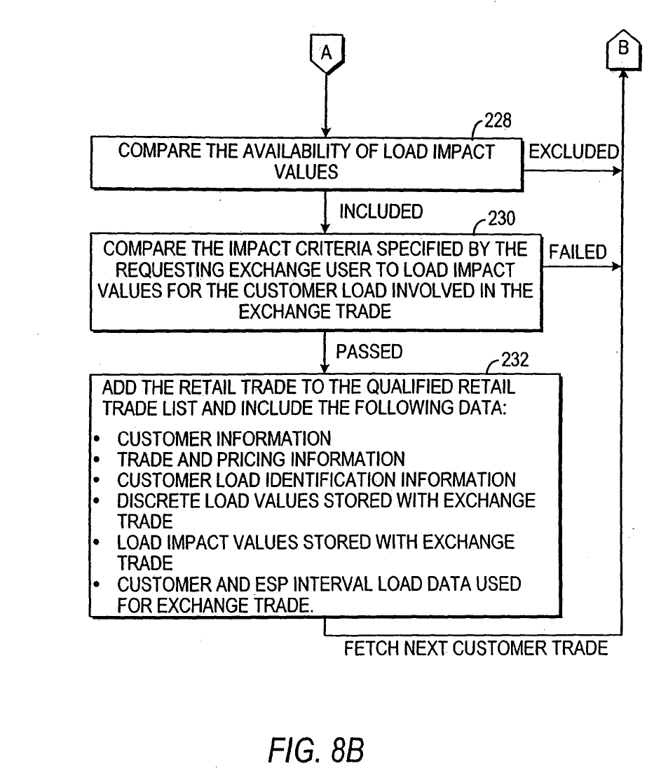

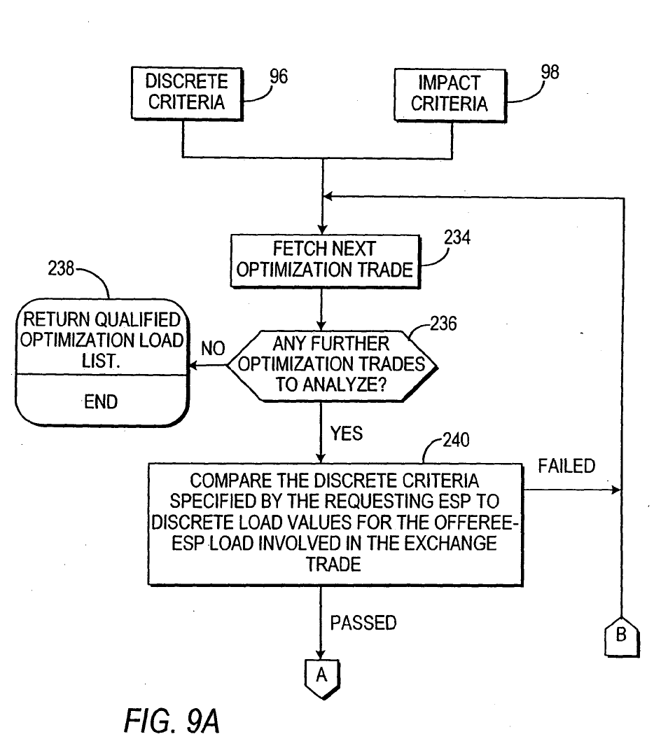

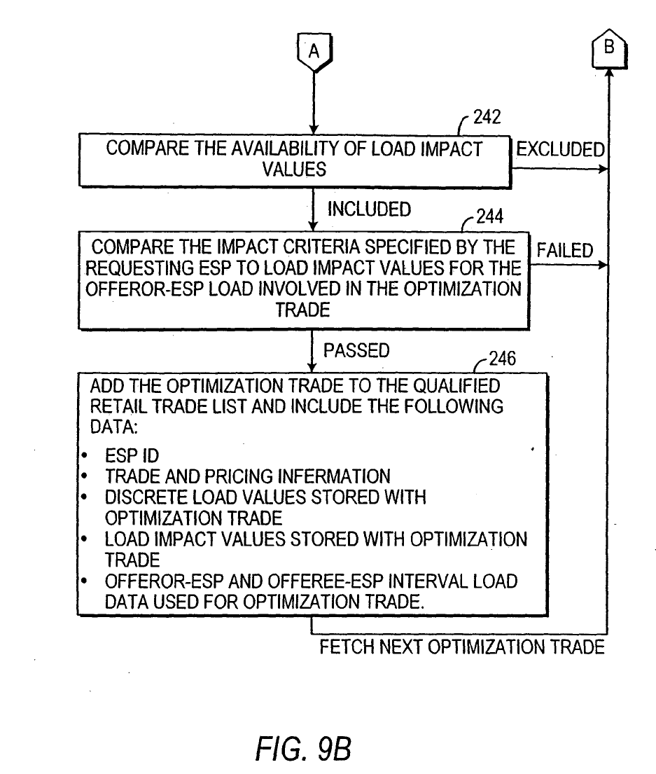

At step 202 a decision is made whether optimization trades, i.e., trades between ESP's, are to be searched. For a negative decision, the retail price search request is processed by the retail price search engine 46, as indicated at step 204. A detailed flowchart of this operation is provided in FIG. 8. For a positive determination at step 202, an optimization price search request is processed by the optimization search engine 52, as indicated at step 206. A detailed flowchart of this process is provided in FIG. 9.

When a retail or optimization price search request included a network search, results are received from other exchange nodes via the internodal communications handler, as indicated at step 208, the results of the local load price search results are combined with the network price search results received from the other exchange nodes, as indicated at step 210. Thereafter, a determination is made to learn if the price search request had originated from another exchange node on the exchange network, as indicated at 212 (FIG. 7C). If the answer is yes, the price search results are routed to the original requesting exchange node on the network via the internodal communications handler, as indicated at 214, and the price search concludes. If the decision made at step 212 is negative, the price search results are routed to the interface display (FIGS. 7G-7H and FIGS. 7L-7M), as indicated at 216, and the price search process concludes. At conclusion, the price search system then waits for the next price search request.

A tabular display of information concerning exchange trades found during the price search is provided to the exchange user as shown in FIG. 7G and FIG. 7L, which includes discrete and impact results for a number of customers in the exchange network along with base energy costs in terms of the base energy cost per kilowatt-hour and the date of the trade at that cost. The exchange user may request more information on any of the entries in the table by pointing and clicking on the item of interest to obtain a complete summary of the information on a particular customer load along with graphing capabilities as shown in FIG. 7H and FIG. 7M.

If a retail price search request is made, the retail price search engine is invoked. The operation of the retail price search engine 46, as illustrated in FIG. 8, begins with the input of discrete criteria at 96 and of impact criteria at 98. In a retail price search, the input retail price criteria are compared to those of other trades. To this end, data regarding the next retail trade are fetched, as indicated at 218, after which a determination is made at step 220 to see if any retail trades were available are to be analyzed. For a negative decision, the process comes to an end and returns to the qualified retail trade list as indicated at 222. Following a positive decision at step 220, the load identification criteria for the customer load involved in the exchange trade is compared to the input load discrete criteria, excluding trades that occurred outside of the search period, as indicated at 224. In this step, information regarding a prior retail trade is retrieved from the trade history tables stored in the exchange database and a comparison is made of the load identification information for the customer load involved in the retail trade.

If the comparison at 224 fails, that is, if the load information does not meet the discrete criteria, the process returns to step 218 to fetch data regarding a new retail trade. If the comparison at 224 passes, the load characteristic information stored in the trade history tables is compared to the applicable load characteristic criteria specified by the requesting exchange user, as indicated at 226. If that comparison fails, the process returns to step 218 to fetch the next retail trade. If, on the other hand, the comparison at step 226 passes, the process continues to step 228 (FIG. 8B) to determine the availability of specified load impact values to be compared. In this step, if the requesting exchange user requires that load impact values be considered, and if the ESP has indicated in its database that load impact values are not to be disclosed, then the retail trade under consideration is excluded from the retail price search. If the retail trade is excluded on these grounds, the process returns to step 218 to fetch the next retail trade. If the retail trade is included following the comparison at step 228, the impact criteria specified by the requesting exchange user are compared to the load impact values for the ESP load involved in the exchange trade, as indicated at 230.

If this comparison fails, the process returns to step 218 to fetch the next retail trade to be considered. If it passes, the retail trade being considered is added to the qualified trade list, as indicated at 232, and the process returns to step 218 to fetch the next retail trade. Information concerning the thus qualified retail trade includes the customer's ID information, trade and pricing information, customer load identification information, discrete load values stored with the exchange trade, load impact values stored with the exchange trade, and customer and ESP interval load data used for the exchange trade. The retail search engine then fetches the next retail trade. The process of fetching retail trades and performing comparisons continues until there are no more retail trades to analyze. The retail price search engine then returns the qualified retail trade list and exits.

An optimization price search is requested when one ESP is interested in learning what the prices were for other ESP to ESP trades. When that occurs, the optimization price search engine is invoked. As illustrated in FIG. 9A, that procedure is initiated by the input of discrete load criteria 96 and impact load criteria 98 which was provided by the ESP making the optimization price search request. Thereafter, at step 234, an optimization trade is fetched for analysis, and then at 236, a decision is made if any optimization trades are available to be analyzed. For a negative determination, the list of qualified optimization trades is returned and the procedure ends as indicated at 238. If the determination at step 236 is positive, the discrete criteria specified by the requesting ESP are compared to the discrete load values for the offeree ESP load involved in the exchange trade, as indicated at 240. That is, at this step in the optimization price search, the applicable load characteristic criteria are compared to the load characteristic values calculated from the interval load data for the offeree-ESP load stored in the trade history tables.

In the event the comparison at step 240 fails, the process returns to step 234 and the next optimization trade is fetched for analysis. If the comparison at step indicates a satisfactory match between the requesting and offeree ESPs load characteristics, the process proceeds to step 242 (FIG. 9B) at which a comparison is made to determine the availability of load impact values. In this step, if the requesting ESP requires that load impact values be considered, and if the offeror-ESP involved in the optimization trade under consideration has indicated in the applicable exchange database that load impact values are not to be disclosed, then the optimization trade is to be excluded from the optimization price search. If this is the case, the optimization trade under consideration is excluded and the process returns to step 234 and the next optimization trade is fetched for analysis. If the optimization trade is determined at step 242 to be available, the process continues to step 244 at which the impact criteria specified by the requesting ESP are compared to the load impact values for the offeror-ESP involved in the optimization trade as calculated from the interval load data of the impact load or segment stored in the trade history tables.

If the comparison fails, the process returns to step 234 and a new optimization trade is fetched. If the comparison at step 244 passes, the optimization trade under consideration is found to meet the requesting ESP's discrete and impact load criteria; and it is added to the list of qualified optimization trades at step 246. The data added to the trade list include the ESP identification, trade and pricing information, discrete load values stored with the optimization trade, load impact values stored with the optimization trade, and the offeror-ESP and offeree ESP interval load data used for the optimization trade. The process then returns to step 234 and the next optimization trade is fetched for analysis.

Trading Systems

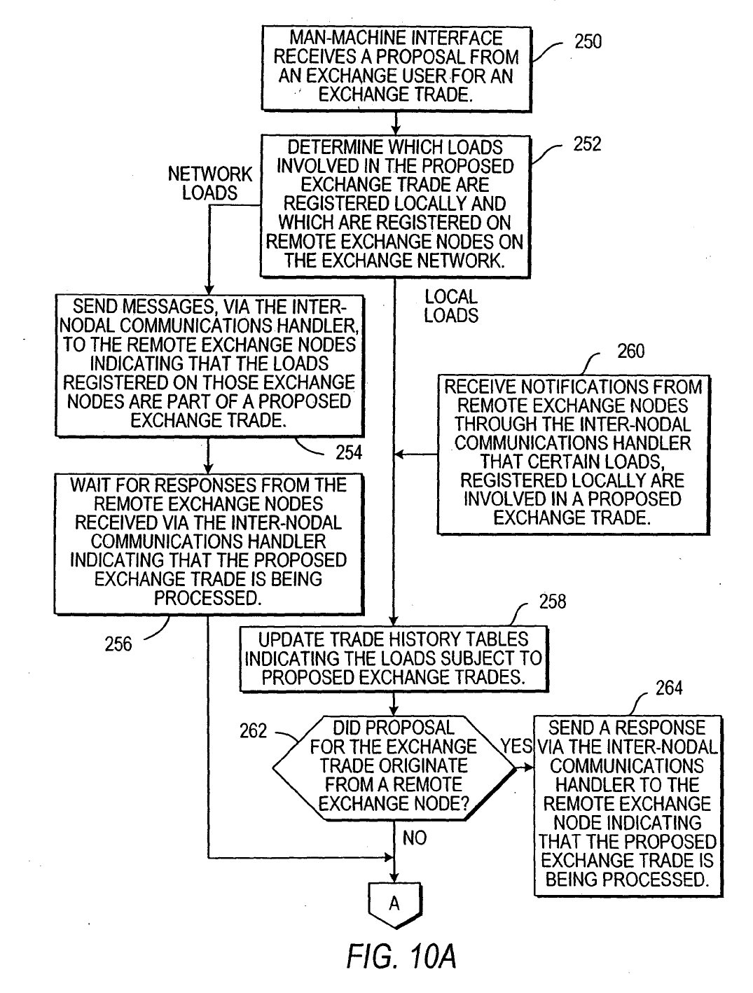

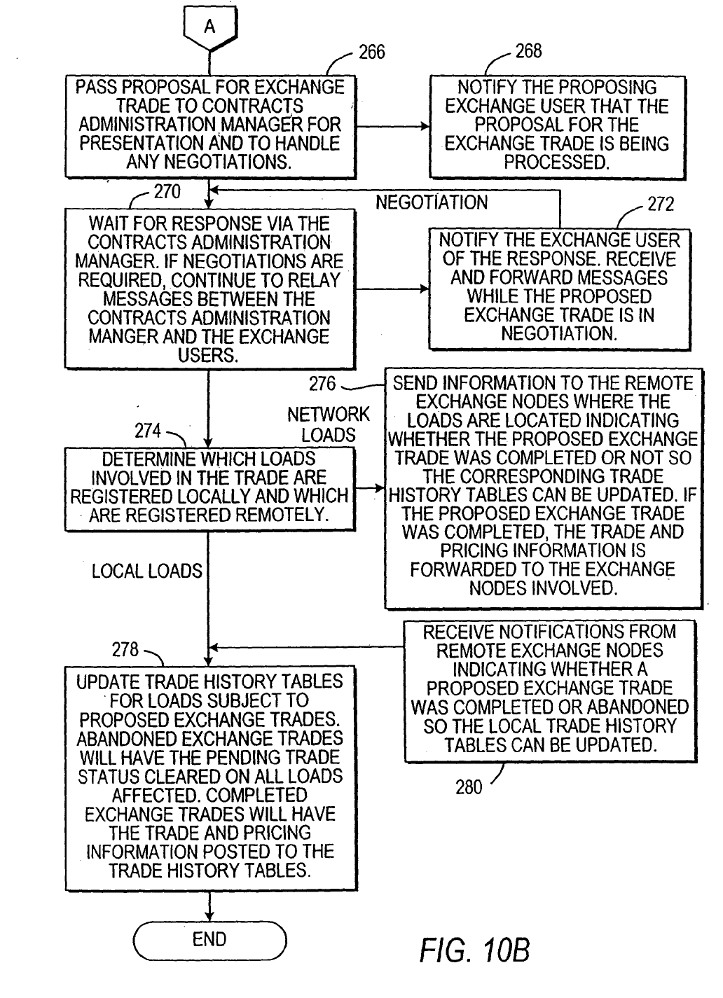

The exchange nodes each include retail and optimization trading engines 44,50, which are used in the exchange network of the invention to process transactions made between exchange users based on the load and price search operations previously described. The operation of the trading system is shown in the process flowchart in FIGS. 10A and 10B. As therein shown, an exchange trade is proposed at any exchange node in the network by an exchange user at the display screen-interface as at step 250.

Each exchange node trading system includes a contracts administration manager, which is a programmed application, which in a hierarchical network is also included in the RPX, RNX and NatX. The contracts administration manager, through the use of standard contract forms, assists in concluding contracts for the sale of electric power between customers and ESPs through an exchange node or over the exchange network. The contracts administration manager of the exchange node that receives a proposed exchange trade handles the notification to the customer of the proposed exchange trade as well as the details of any resulting negotiations. When and if the proposed trade is finalized, the exchange node(s) at which load(s) is located is notified of the exchange trade and provided with trading and pricing information for the trade. That information is then stored in trade tables in the database of the exchange node at which the load is registered.

After an exchange trade is proposed at 250, a determination is made at step 252 of which loads involved in the trade are local loads, that is, loads that are registered in the local exchange node, and which loads are registered on remote exchange nodes on the exchange network (network loads). For network loads located on other exchange nodes, those exchange nodes are notified via the internodal communications handler 34 that the loads registered on those exchange nodes are part of a proposed trade as indicated at step 254. This notification allows each exchange node to log the fact that an exchange trade is proposed for a load registered on that exchange node and to respond with a message acknowledging that the notification of the proposed trade has been received and is being processed as indicated at 256.

For local loads, the exchange node logs the proposed trade in the trade history tables in that exchange node's database as indicated at step 258. As indicated at 260, the local exchange node may receive a notification from another remote exchange node, through the internodal communications handler, that a trade is being proposed for one of the local loads. In this event, the proposed trade is also entered into the trade history tables at 258, and, as determined at step 262, the remote exchange node is sent an acknowledgment, through the internodal communications handler, of the receipt of the proposed trade, and an indication that the proposed trade is being processed as indicated at 264. The exchange receiving the proposed trade, local or network, then, as indicated at step 266, passes the trade request to the contracts administrations manager for presentation to the receiving exchange user. The proposing exchange user is then notified that the proposed trade is being processed as indicated at 268.

Then, as indicated at step 270, the contract administrations manager waits for a response from the customer and forwards the response to the proposing exchange user. If negotiations are required between the parties, the contracts administration manager handles the negotiations process between the exchange users involved in the proposed trade as indicated at 272. Upon completion of the exchange trade negotiations, a determination is made at 274 on which loads involved in the trade are network loads that are registered remotely and which are local loads. For the network loads identified at step 274, information is sent to the other remote exchange nodes at which these loads are located to advise the remote exchange nodes whether or not the proposed trade was completed successfully, as indicated at 276, so that the corresponding trade history tables to exchange database of the exchange nodes involved in the trade can be updated.

For the local loads identified at 274, the trade history tables are updated, as indicated at 278, to reflect the status of the trade. If the trade was not successful, the pending status of that trade is removed from the trade history tables. For a completed trade, the trade history tables are updated with the trade and pricing information for the completed trade. The exchange node also, as indicated at 280, receives notification from remote exchange nodes indicating whether a proposed trade was completed or abandoned so that the local trade history tables can be updated.

The trade history tables consist of trade and pricing information as well as the relevant load characteristic information and load impact values discussed above. The trade and pricing information stored in the trade history tables includes such relevant information as the date of the trade; the time period of the search; the price and charges for the various standard energy billing quantities including, but not limited to, consumption, demand, load factor, service type and facilities; the trading terms; customer instructions; customer interval load data; ESP interval load data before and after the trade; and ESP capacity interval data.

It will be appreciated from the foregoing description that the retail electric power exchange/energy service provider load optimization exchange of the invention provides a means of connecting suppliers and users of electric power through computer communications linkages (i) to permit suppliers and users of electric power to obtain information that allows sales of electric power to be more efficiently and rationally made and to be made in a manner that improves the efficiency of the usage of electric power and at prices that reflect efficiencies achieved; (ii) permit customers to obtain information that enables effective aggregation of customer loads to achieve improved efficiency in the use of electric power and attract supply offers that reflect that efficiency; and (iii) enable load-shifting transactions between suppliers of electric power to be efficiently and rationally made in a manner that improves the efficiency of the usage of electric power and at prices that reflect efficiencies achieved. The invention also enables networks of such exchanges to be created to serve the needs of customers and energy service providers whose activities cover a wide geographic scope.

What is claimed is:

1. A method for evaluating a proposed transaction involving the shifting of electric power supply obligations between a first energy service provider and a second energy service provider, comprising: identifying electric power supply obligations of the first energy service provider and the second energy service provider; choosing a method for evaluating a shift of a portion of the electric power supply obligations of the first energy service provider to the second energy service provider based on an effect of the shift upon an efficiency of energy usage of at least one of the first energy service provider and the second energy service provider; and applying the selected method to an analysis of the power supply obligations of the first and second energy service providers.

2. The method of claim 1, wherein choosing the method includes evaluating a shift of a portion of the electric power supply obligations of the second energy service provider to the first energy service provider.

3. The method of claim 2, further comprising providing data relevant to identifying proposed shifting of electric power supply obligations between the first energy service provider and the second energy service provider.

4. The method of claim 3, further comprising providing data relevant to pricing the proposed transaction involving the shifting of electric power supply obligations between the first energy service provider and the second energy service provider.

5. The method of claim 1, wherein identifying the electric power supply obligations of the first and second energy service providers includes: accessing a database including data relating to the electric power supply obligations of the first and second energy service providers; selecting at least one discrete criterion; and determining whether the data in the database relating to the electric power supply obligations of the first and second power supply obligations satisfy the at least one discrete criterion.

6. The method of claim 5 wherein the data are normalized.

7. The method according to claim 1, wherein the method for evaluating the shift of electric power supply obligations includes one of an LF/LF method, an IMF/LF method, an LF/IMF method, an LF method and an IMF method.

8. A method for evaluating historical transactions involving a shift of electric power supply obligations between a first energy service provider and a second energy service provider, comprising: identifying historical electric power supply obligations of the first energy service provider and the second energy service provider; choosing a method for evaluating a historical shift of a portion of the historical electric power supply obligations of the first energy service provider to the second energy service provider based on an effect upon an efficiency of energy usage of at least one of the first energy service provider and the second energy service provider; and applying the selected method to the historical shift of the portion of the historical electric power supply obligations of the first and second energy service provider between them.

9. The method of claim 8, wherein choosing the method includes evaluating a shift of a portion of the historical electric power supply obligations of the second energy service provider to the first energy service provider.

10. The method of claim 8, wherein identifying the historical transaction includes accessing a first database including data relating to historical transactions involving the first and second energy service providers; selecting at least one discrete criterion; and identifying whether the data in the first database relating to the historical transactions satisfy the at least one discrete criterion.

11. The method of claim 10, wherein the data in the first database are normalized.

12. The method of claim 10, wherein the at least one discrete criterion includes one of an ESP ID, an ESP load ID, a generation service area, and ESP load characteristic information.

13. The method of claim 12, wherein the method for evaluating the shift of electric power supply obligations of the first and second energy service providers includes one of an LF/LF method, an IMF/LF method, an LF/IMF method, an LF method and an IMF method.

14. A system for evaluating a proposed transaction involving a shift of electric power supply obligations between a first energy service provider and a second energy service provider, comprising: a processor; and a memory coupled to the processor, the memory storing a computer program to be executed by the processor, the executed computer program identifying electric power supply obligations of the first energy service provider and the second energy service provider, choosing a method for evaluating a shift of a portion of the electric power supply obligations of the first energy service provider to the second energy service provider based on an effect of the shift upon an efficiency of energy usage of at least one of the first energy service provider and the second energy service provider, and applying the selected method to the power supply obligations of the first and second energy service providers.

15. The system of claim 15, wherein choosing the method includes evaluating a shift of a portion of the electric power supply obligations of the second energy service provider to the first energy service provider.

16. The system of claim 14, wherein the executed computer program provides data relevant to identifying proposed shifting of electric power supply obligations between the first energy service provider and the second energy service provider.

17. The method of claim 16, wherein the executed computer program provider data relevant to pricing a proposed transaction involving the shifting of electric power supply obligations between the first energy service provider and the second energy service provider.

18. The system of claim 14, wherein the method for evaluating the shifting of electric power supply obligations includes one of an LF/LF method, an IMF/LF method, an LF/IMF method, an LF method and an IMF method.

19. A retail electric power exchange, comprising: an electric power exchange node; and at least one exchange database coupled to the exchange node, wherein the exchange node includes an optimization load search engine capable of identifying electric power supply obligations of a first energy service provider and a second energy service provider, choosing a method for evaluating a shift of a portion of the electric power supply obligations of the first energy service provider to the second energy service provider based on an effect of the shift upon an efficiency of energy usage of at least one of the first energy service provider and the second energy service provider, and applying the selected method to the power supply obligations of the first and second energy service providers.

20. The retail power exchange of claim 19, wherein choosing the method includes evaluating a shift of a portion of the electric power supply obligations of the second energy service provider to the first energy service provider.

21. The retail electric power exchange of claim 19, wherein the method for evaluating the shift of electric power supply obligations includes one of an LF/LF method, an IMF/LF method, an LF/IMF method, an LF method and an IMF method.

22. The retail electric power exchange of claim 19, wherein identifying the electric power supply obligations of the first and second energy service providers includes: accessing the exchange database including data relating to the electric power supply obligations of the first and second energy service providers; selecting at least one discrete criterion; and determining whether the data in the exchange database relating to the electric power supply obligations of the first and second power supply obligations satisfy the at least one discrete criterion.

23. The retail electric power exchange of claim 19, wherein the exchange node includes an optimization trading engine capable of arranging the proposed transaction involving the shifting of electric power supply obligations between the first and second energy service providers.

24. The retail electric power exchange of claim 19, wherein the exchange node includes an optimization price search engine capable of: identifying historical electric power supply obligations of the first energy service provider and the second energy service provider; choosing a method for evaluating a shift of a portion of the historical electric power supply obligations of the first energy service provider to the second energy service provider based on an effect of the shift upon an efficiency of energy usage of one or both of the first energy service provider and the second energy service provider; applying the selected method to the historical electric power supply obligations of the first and second energy service provider; providing data relevant to the pricing of the historical transaction; and providing data relevant to pricing a proposed electric power shifting transaction between a first energy service provider and a second energy service provider.

25. The retail electric power exchange of claim 24, wherein choosing the method includes evaluating a shift of a portion of the electric power supply obligations of the second energy service provider to the first energy service provider.

26. A network of electric power exchange, comprising: a first electric power exchange; and a second electric power exchange coupled to the first electric power exchange; wherein a request made at the first electric power exchange to evaluate a proposed transaction involving the shifting of electric power supply obligations between a first energy service provider and a second energy service provider is carried out by either of the first electric power exchange and the second electric power exchange based on an effect of the shift upon an efficiency of energy usage of at least one of the first energy service provider and the second energy service provider.
